(19) United States
(12) Patent Application Publication
(10) Pub. No.: US 2026/0112347 A1
(43) Pub. Date: Apr. 23, 2026

(54) Method for rapid transposition of electronic musical keyboards

(71) Applicant: David John Reynolds, Galway (IE)

(72) Inventor: David John Reynolds, Galway (IE)

(21) Appl. No.: 19/349,102

(22) Filed: Oct. 3, 2025

Related U.S. Application Data
(60) Provisional application No. 63/709,477, filed on Oct. 20, 2024.
(60) Provisional application No. 63/709,488, filed on Oct. 20, 2024.

(51) Int. Cl. G10H 1/20; G10H 1/34

(52) U.S. Cl. CPC G10H 1/20; G10H 1/34; G10H 2220/221; G10H 2240/311

(57) ABSTRACT

Claviation is a rapid and intuitive method for transposing an electronic musical keyboard in real time—fast enough to support key changes during play using the keys themselves. The player enters transposition mode via a pedal or button and presses two keys in sequence to define the transposition interval. These two presses are muted to avoid disrupting the music. This three-step action is as efficient as a musical triplet, easily fitting within a beat and becoming faster with practice. Crucially, claviation requires no calculation, naming, or conceptualizing of intervals. It enables the player to keep scales primarily on the white keys, even through key changes, eliminating the need to learn key signatures and multiple fingerings. A piece learned in one key is effectively learned in all. Claviation accelerates learning, enhances improvisation, and preserves spatial patterns across key changes, making the keyboard easier to learn, understand, and compose music on.

### CROSS-REFERENCE TO RELATED APPLICATIONS

This application claims the benefit of U.S. Provisional Patent Application No. 63/709,477, filed Oct. 20, 2024, and U.S. Provisional Patent Application No. 63/709,488, filed Oct. 20, 2024, under 35 U.S.C. § 119(e), the disclosures of which are incorporated by reference herein in their entirety.

### STATEMENT REGARDING FEDERALLY SPONSORED RESEARCH OR DEVELOPMENT

Not applicable.

### BACKGROUND OF THE INVENTION

### Field of the Invention

The invention relates to electronic musical instruments, and more particularly to user interfaces for transposition in keyboards and similar devices.

### Description of Related Art

Electronic keyboards commonly provide transposition functions that allow a performer to shift the pitch of a musical piece without adopting new fingerings. Existing implementations typically rely on increment-decrement buttons, systems with hardware selectors such as sliders or rotary selectors, or systems in which a dedicated switch combined with a single muted keypress on the keybed itself defines the transposition. These approaches, however, are not suitable for rapid changes of key during live performance.

### SUMMARY OF THE INVENTION

The present invention provides a novel transposition interface that enables a performer to shift key instantly during play by means of a dedicated switch control combined with two muted keypresses on the keybed itself. Unlike the single-switch plus single muted-keypress methods of the prior art, this approach employs two muted keypresses to specify the transposition, enabling real-time modulation without interrupting performance and offering significant usability advantages over earlier systems.

### BRIEF DESCRIPTION OF THE DRAWINGS

FIG. 1 shows an example of a regularized co-ordinate system applied to physical keys. The example is chosen to correspond to MIDI.

FIG. 2 shows how a C Major scale is played on a keyboard, illustrated with solfège syllables as note names.

FIG. 3 shows how a D Major scale is played on a keyboard, illustrated with solfège syllables as note names, and illustrates a key signature of D Major.

FIG. 4 illustrates using the keyboard as a control surface to smart-tune to a chosen key, in this case E♭ Major.

FIG. 5 illustrates using the keyboard as a control surface to smart-tune to a chosen key, in this case E♭ Minor.

FIG. 6 illustrates a “kal score,” a score without key signature which the invention enables.

FIG. 7 shows the notes on a keyboard when the keyboard is not transposed.

FIG. 8 shows how the notes on a claviating keyboard are named, regardless of transpose setting.

FIG. 9 shows the notes corresponding to keys when the transpose setting is zero, using the con qualifier to remove ambiguity (e.g., the physical C produces concert pitch C, denoted con C).

FIG. 10 shows “kal signatures,” which replace key signatures in the system of the invention, comprising four subdiagrams for C Major, A Minor, D Dorian, and G Mixo.

FIG. 11 shows the key signatures that correspond to clear keys of four selected musical modes.

FIG. 12 shows the Second Model Piece in both traditional notation with key signatures and in kal score form.

FIG. 13 illustrates how a claviating keyboard can appear when “recolored” for blues.

FIG. 14 shows a “rootless” kal score version of the Second Model Piece, demonstrating that rootless kal scores can represent music unambiguously without specifying a key.

FIG. 15 is a graphical representation of the kal notes—an abstract note system intended for use with a claviating keyboard. For clarity and to avoid repetition, the term kal shown at the center applies to all note names in the figure, in accordance with the convention defined in Appendix Error! Reference source not found.

FIG. 16 is a graphical representation of the same notes but arranged in a way in which diatonic structure is emphasized.

FIG. 17 is a distinct graphical representation showing the abstract relationship between kal notes and scale degrees for a diatonic musical mode.

FIG. 18 shows how scale degrees map to kal notes on the claviating keyboard when the mode is Major.

FIG. 19 shows how scale degrees map to kal notes on the claviating keyboard when the mode is Minor.

FIG. 20 illustrates an example mapping of syllabified kal note names to the instrument's keys, shown as a Major scale run.

FIG. 21 shows the same mapping represented as a Minor scale run.

FIG. 22 illustrates how the chord kal F occupies a stable position on the kal staff, enabling familiarity and visual recognition.

FIG. 23 shows the minimal tetrad chord shape, which is the form taken by the kal CMaj7 chord (the “C psan” chord, or Cp).

FIG. 24 shows the minimal tetrad chord shape as taken by the kal Dm7 chord (the “D psan” chord, or Dp).

FIG. 25 shows hybrid kal signatures in the mechanical key signature of D Major; the upper signature is for E Major, and the lower for C # Major.

FIG. 26 shows the “mechanical key signature” of D Major, indicating that it is identical to the key signature of D Major, though it is not specific to D Major key.

FIG. 27 shows the Wicki-Hayden layout for three octaves in a favored boardshape.

### DETAILED DESCRIPTION OF THE INVENTION

### Part 0: Specification Structure and Style Practices

### 0.1 why the Specification is Structured as it is

The specification is structured in a particular way to make it more readable. At its technological core, claviation is a transposition interface for electronic keyboards requiring only a single additional on/off hardware switch. At this level the invention is very simple and presents no difficulty for enablement to a Person of Ordinary Skill in the Art (a “POSITA”), such as a designer of electronic musical instruments or digital performance systems. A POSITA in this domain needs to understand sound, its production, and fundamentals about pitch, but not music per se. They can understand the interface's use, but cannot necessarily evaluate its usability.

The merits of the invention, however, hinge on the usability properties of that interface for musicians. Full verification of those merits does require some understanding of music and music theory. Establishing usability rigorously also demands a detailed exposition in the fields of music, music theory, and pedagogy. Music is technical in nature but lacks the uniformity and precision of terminology typically found in technological disciplines. As a result, numerous definitions are necessary for clarity and rigor. Furthermore, some concepts essential for theoretically grounding the merits of the invention—such as diatonic transparency (to be defined later) —do not yet exist as named constructs in the field.

To balance clarity with completeness, the specification is organized into three parts: the “main body”, the Appendix, and the claims. The main body uses numeric headings (e.g. 2.5.1) and presents the invention concisely, while the Appendix uses alphabetic headings (e.g. C.2) and contains extended material such as demonstrations of usability. This separation keeps the main body free of unnecessary music-theoretical overhead, yet allows rigorous and modular evaluation by directing detailed elaboration into the Appendix. Consequently, a rigorous while modular evaluation is supported:
A reviewer skilled in the art (a POSITA) but not in music can fully assess the invention's novelty, structure, and implementation. An examiner can assess the merits of the invention subject only to whether the usability claims and other advantages of the invention are substantiated in the Appendix.
A reviewer with musical expertise but not necessarily engineering background can independently evaluate whether the musical and pedagogical assertions in the main body are properly substantiated in the Appendix.

The main body is thus designed to require as little understanding of music or practical keyboard playing as is possible, while still giving a coherent narrative of the invention and explaining the need it addresses. Some reference to music and playing technique is unavoidable in the main body, but the goal is to minimize it while preserving accessibility and clarity.

Apart from the abstract and this present part, Part 0, at the beginning, the specification is structured as follows:

### Part 1—Core Exposition

Presents a unified and coherent narrative of the invention. This part explains the core innovation—claviation—in its full context, covering its mechanism, use, and practical impact. It guides the reader through the problem space, highlights the novelty of the solution, and explains why the techniques disclosed here achieve results not realized by earlier approaches. It provides a higher-level understanding of the merits of the invention, but not a musically detailed one. Forward references are made to specific sections in the Appendix for detailed elaboration.

### Part 2—Definitions for Claims

Bridges the explanatory material of Part 1 to the formal claims by precisely defining the terms used therein. Only the definitions in this section are needed for the claims.

### Part 3—Embodiments

Discussion of four core embodiment types accompanies these definitions to clarify their application. Only the definitions in Part 2 are needed for this section and the claims.

### Appendix

Divided into Parts A, B and C, the Appendix establishes the usability of the transposition interface and substantiates assertions made in the main body. It provides rigorous justification for the broader usability, educational value, and musical significance of claviation, drawing on music theory, music cognition, and pedagogy—areas extending beyond what is required for enablement under patent law.

### Claims

### 0.2 Encapsulation of Definitions

To avoid confusion in a specification that mixes technical and musical vocabulary, definitions are carefully encapsulated and structured.

This specification distinguishes between two classes of definitions:
Claim-critical definitions—These are the relatively few terms required for enablement and for interpreting the claims. They are isolated in Part 2. Part 3 then provides a complete enablement that depends only on the definitions of Part 2. Taken together with the claims, Parts 2 and 3 form a self-contained capsule of definitions, enablement, and claims.
Auxiliary definitions—These are not required for enablement or claims, but are important for explaining the broader merits of the invention, such as its usability, educational value, and musical significance. They appear in Part 1 where necessary for clarity, and are collected more systematically in the Appendix.

This structure preserves clarity for claim interpretation while still permitting rigorous exploration of the invention's wider merits.

### 0.3 Conventions for Definitions

To ensure consistency and readability when skimming or studying the text, defined terms follow strict formatting conventions.
Formatting: All defined terms are set in bold italics and enclosed in quotation marks (e.g., “Multikey Overhead”).
Span of definition: Where the act of definition requires several sentences, the term may appear more than once in definition form. In rare cases (e.g., “claviation”), the span may extend further for clarity. Once a definition is complete, subsequent uses of the term appear in plain text.
Deferred definition: Where a term is anticipated but not yet defined, it may appear in plain text with a note such as “to be defined later”. The absence of bold italics signals that the definition is being reserved.
Repeated definition: Occasionally a term is first defined in the main body and later defined more rigorously in the Appendix. Early usage is consistent with the later definition; the Appendix simply provides a fuller statement.

### 0.4 Forward References and Order of Reading

Forward references from the main body may point to specific sections of the Appendix for substantiation. These sections can sometimes be read on their own, but many rely on definitions and concepts introduced earlier in the Appendix. Readers are therefore free to dip into individual parts for reference, but for full comprehension a previous sequential reading of the Appendix provides the only reliable approach. The Appendix is in itself structured to be read as an in-depth and technical narrative of the invention.

### 0.5 Tailored Style Practices and Conventions

Three stylistic conventions have been adopted to improve the accessibility of the specification. These are introduced under the following headings:
Concept Markers
Groundwork Sections
Musical mode names, note names and capitalization

### (Concept Markers)

This specification uses low-level header-like entities referred to as “concept markers,” with heading text enclosed in parentheses. An example is immediately above this paragraph. Concept markers are non-hierarchical: they function as flags of emphasis placed just before a key idea. Unlike structural headers, they do not segment the document or imply scope over subsequent content. Their purpose is to provide focus at the point of introduction while preserving continuity and orientation in a narrative that does not fit easily into a rigid hierarchy of headings.

### (Groundwork Sections)

Some supporting material is essential for understanding, but placing it inline can disrupt the narrative flow. To resolve this, such material is placed in a “groundwork section”—a typographically distinct area used to provide background without diverting attention from the main thread.

Groundwork sections are:
Headed with the word Groundwork in italics, often followed by a dash and a brief label indicating the topic.
Indented.
Marked with a vertical gray bar on the left-hand side.

The following is an example of the beginning of a groundwork section:
Groundwork—the meaning of “muted”
In the art, an element normally intended to produce sound is described as “muted” if it is temporarily configured not to produce sound.

### (Musical Mode Names, Note Names and Capitalization)

This specification adopts explicit conventions for capitalization and notation in order to maximize accessibility while maintaining rigor.

The words Major and Minor are capitalized when used as the names of musical modes. This avoids ambiguity, since the same words in lowercase are also used in conventional music theory in senses that do not denote mode names. When they are used in this latter way—for example, in the phrase ‘the chord of C major’—they are written without capitals.

The following are names of keys, with capitalization according to common-use convention:
C major, E minor, F Dorian, D Lydian

Here is the same list but capitalized in the convention used in this specification:
C Major, E Minor, F Dorian, D Lydian

In the body text of this specification, following common practice, note names appear in italics, while chord names are shown in regular type. For clarity and visual balance, these conventions are not necessarily followed in diagrams.

Finally, the common names of modes are used exclusively, rather than their academic counterparts:
“Major” rather than Ionian
“Minor” rather than Aeolian
“Mixo” rather than Mixolydian

### 0.6 Accommodation of Distinct Regional Conventions for Note Names

There are three prevailing conventions for naming musical notes worldwide, largely corresponding to geographical regions:
1. “ABC Region”. Notes are named alphabetically in the range A-G. This convention covers all of the world outside the two regions described below.
2. “Do-Re-Mi Region.” Solfège syllables (Do-Re-Mi, capitalized) are used in place of alphabetic names. In this system, Do-Re-Mi corresponds to C-D-E. These regions are reliably those in which a Romance language is the dominant language.
3. Greece. Greece maintains its own, more ancient naming system.

This specification is written to be immediately accessible to readers from both the ABC Region and the Do-Re-Mi Region. Alphabetic names (A-G) are used as the default names for notes. Readers in the Do-Re-Mi Region can translate these instantly into the Do-Re-Mi system, since they already encounter alphabetic names in chord symbols. For example, the major chord with root on Do is written C major, and the major chord with root on Sol is written G major, giving immediate recognition that the notes C and G correspond to Do and Sol, respectively, because those same letters already appear in the chord symbols familiar within their own system.

Where solfège syllables appear in lowercase (e.g., do, re, mi), they are syllables in the system called “movable-do solfège with la-based minor”, which is a distinct system from the uppercase “fixed-Do” solfège used in the Do-Re-Mi Regions. This case convention is adopted to prevent misreading and to ensure clarity across regions. Readers are advised that the word do in this specification may therefore signify the solfège syllable rather than the English verb “do.”

### Part 1: Core Exposition

### 1.1 The Claviation Breakthrough

Groundbreaking inventions are sometimes met with initial disbelief. When an improvement is both dramatically better and yet remarkably simple and inexpensive—so much so that it should long have existed already—it is a sign that an inventor has fruitfully made a fundamentally new approach, proving inventive step. This invention fundamentally transforms the learnability of electronic musical keyboards by eliminating the need for internalizing key signatures and the mastery of the many key-dependent scales, enabling keyboardists to reach any level of proficiency without them, and reducing the time and effort required for mastery by hundreds or even thousands of hours, while also reinforcing a better musical understanding of what is being played.

This invention doesn't just make electronic keyboards easier to play—it builds a pathway into a new musical mindset, allowing players to approach music with greater clarity, fluency, and confidence from the very beginning.

This breakthrough is made possible by a novel transposition functionality which we call “claviation”. Remarkably, claviation requires fewer controls than the standard transposition interface currently found on virtually all electronic musical keyboards intended for general play by adults. Claviation could have been implemented from the very beginning of electronic musical keyboard development more than 70 years ago—and for more than 40 years (since they have been manufactured in the microprocessor-firmware paradigm) very cheaply—and in its simplest and least expensive form, it would have been slightly cheaper to manufacture than the now-standard transposition interface, which requires two buttons. Claviation requires only a single control: a button or alternatively a pedal, both serving as the “claviation trigger,” or simply “the trigger”, which triggers entry into the special claviation transposition mode.

With claviation, players can seamlessly transpose in real time while performing, eliminating the burden of key signatures and ensuring that scales remain centered on the white keys across all keys, key changes, modes, and styles—always as if the piece were written in its simplest key. Black keys are still used, but only as accidentals—namely, departures from the key signature requiring explicit notation—rather than as a routine consequence of the key signature itself. This drastically reduces their frequency and greatly simplifies playing.

### Groundwork

An accidental is a departure from the key signature requiring explicit notation. It is not the same thing as merely a sharp, flat or black key. There has been significant popular erosion of the meaning of this term due in no small part to popular music software not using it correctly. The strict, traditional usage applies throughout.

### Groundwork—Transposition Setting (TS)

What we define as the “transposition setting” of a musical keyboard, abbreviated “TS”, is a signed integer expressed in semitones. At TS=0, the keyboard produces concert pitch—that is, each physical key plays the pitch its counterpart would on a standard acoustic piano. At any non-zero TS, every key's output is shifted by the specified number of semitones: upward for positive values, downward for negative ones. Thus, TS defines a uniform pitch offset applied across the entire keyboard. To “transpose” the keyboard is to change TS. When TS is zero, the instrument is said to be not transposed. A “transposition change” is a change to the transposition setting.

### Groundwork—Defining Addition of Integer to a Pitch

The specific units or baseline of pitch are not essential to this specification and we can leave them unspecified. All we need is to define addition of integers to a pitch:
Pitches form a set supporting addition of integer semitone intervals, that is, pitch+n is another pitch which is always defined for integer n, and is the first pitch shifted by n semitones, positive towards higher pitch.
A convenient way to realize such a system of pitch representation is provided by the MIDI note numbering scheme, where each pitch is assigned an integer and semitone transposition corresponds to addition of integers. However, the present specification does not require pitches themselves to be integers, nor is it confined to MIDI; it requires only that addition of integer intervals is well-defined.

This effect of eliminating key signatures is achieved by rapid and intuitive transposition of the instrument—during play if needed. Transposition, when performed to make a piece easier to play while preserving the intended pitches, is called “smart-tuning” herein (see groundwork further defining smart-tuning to follow immediately).

### (Smart-Tuning)

### Groundwork—Defining “Smart-Tuning”

There is a common practice among keyboard players for which there is no single specific term in common use, but for which we define the term “smart-tuning”. Smart-tuning an instrument to a piece, in its broadest sense, refers to transposing an instrument in any way that makes it easier to play a given piece. On a keyboard instrument, “easier” usually means playing with fewer sharps or flats. For the purposes of this specification, we generally confine ourselves to smart-tuning not in this broadest sense but in a narrower sense—namely, the case where transposition is applied so that the performer plays as if in a key with no sharps or flats in its key signature—as if in the easiest key signature, not just an easier one.
Throughout this specification, what is traditionally described as “no key signature” will instead be referred to as the “empty key signature.” In this framing, every part on a musical staff is regarded as having a key signature, which may in some cases be empty. While not traditional, this convention is common in modern software interfaces because of its rationality and practical usefulness—analogous to the usefulness of treating zero as a number.
Smart-tuning an instrument therefore refers to transposing it such that a musical passage (or part) is performed as if in a key with an empty key signature, while ensuring that the resulting output remains in the intended concert pitch of the composition. When we say that an instrument is smart-tuned to a part, we mean that it has been transposed to allow the performer to play the part as if it were in key with the empty key signature, while the audience hears it in the correct key.
We define the term “as if in” as follows: To perform as if in a given key means to use the same physical keys, fingerings, and gestures that would be used to play in that key on an instrument which is not transposed. If a player were filmed performing with sufficient visual detail but no audio, a knowledgeable observer—assuming no transposition had been applied—would infer from the player's movements alone that the piece was being performed in the given key.
While the term smart-tuning is coined in this specification, the concept is already familiar to most intermediate-level players of electronic keyboards. The common transpose function on such instruments exists primarily to allow smart-tuning: enabling players to perform in easier keys while producing the desired concert pitches.
For example, a player who wishes to perform a piece written in E♭ Major—a key with three flats—can smart-tune to instead play as if in C Major, the simplest Major key with an empty key signature. C Major will therefore be referred to as the “home musical key of Major”. This is done by setting the transpose value TS=+3 semitones, so that pressing C produces the E♭ three semitones above it.
Equivalently, TS=−9 semitones may be used, lowering C to the E♭ nine semitones below. TS itself is simply an integer setting, but from the perspective of smart-tuning only the result modulo 12 matters, since there are 12 semitones in the octave. In this sense, TS=−9 and TS=+3 are musically equivalent—though for the same music they will require playing at different physical octaves on the keyboard.

### Groundwork—Target Key and Home Musical Key

When a person is playing a piece in a smart-tuned way, two musical keys are always involved: what we define as the “target key” is the key they are actually playing in musically, it is the key that the listener hears, and it is called the target because it is the key that the player aims for: it is the key that, as we define the term, the player “smart-tunes to”. They will typically know this key by name—except possibly while changing keys in improvisation.
The “home musical key” is the easy key the player plays as if in, with no sharps and flats in the key signature. From elementary music theory, there is exactly one home musical key per mode: for Major it is C Major, for Minor it is A Minor, for Dorian it is D Dorian and so on.
Note the difference therefore between playing ‘in’ a key and playing ‘as if in’ a key: a player playing a piece in a smart-tuned manner is playing it in the target key, but as if in the home musical key—and to play this way, will first smart-tune to the target key.

The human ear perceives music fundamentally in relative terms. If a piece sounds musical in one key, it sounds musical in any key. It would even be considered absurd to present two transpositions of the same piece as different works. This reflects a key-independent human musical intuition: our perception of melody and harmony does not depend on absolute pitch.

The human voice demonstrates key-independence. A singer who learns a melody in one key can immediately sing it in another, provided it remains within their vocal range. No retraining is needed. The voice is thus a key-independent instrument: once a melody is internalized, it can be executed in any key.

Most instruments are not “key-independent,” meaning they require distinct learning for each musical key. On the piano-type keyboard, a piece learned in one key must usually be relearned in a fundamentally different way to play it in another. In effect, the keyboard behaves as 12 distinct instruments—one for each enharmonically distinct key signature (a concept clarified shortly) —with each signature imposing its own fingering patterns and hand positions.

This is not merely a minor inconvenience, it is an enormous burden. The piano is ergonomically optimized for the white keys, making C Major—the key with no sharps or flats—the easiest Major key to play. In the key signatures with more black keys, the patterns of fingering become progressively more awkward, with black keys generally disfavoring the thumb. Navigation becomes harder and flexibility of fingering more restricted.

### Groundwork—Key Signatures for Non-Musicians

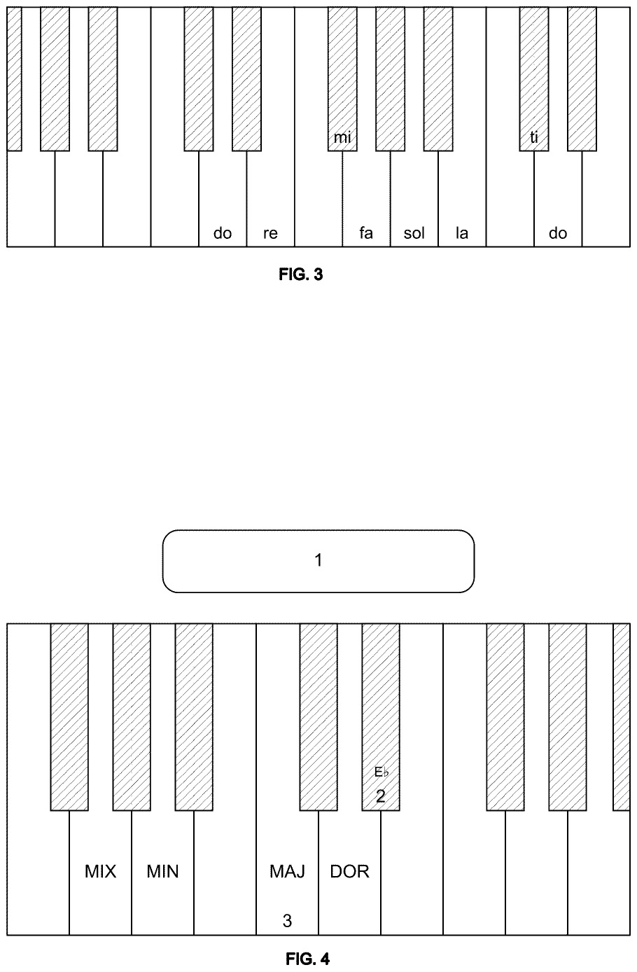

This short groundwork section will improve accessibility of the specification for those who do not understand key signatures.
The piano keyboard is designed around the white keys, which naturally form the scale of C Major: if you start on C and play seven white keys in sequence (C-D-E-F-G-A-B), you hear a familiar “do-re-mi” scale. This pattern works perfectly for C major, but for every other key the pattern no longer matches the white keys alone. Some notes must instead be played on the black keys—and the number and position of these black keys change with each key. As a result, a student must learn 12 different patterns, one for each key, almost as if learning 12 different instruments. This is the challenge that “key signatures” impose, and it is the burden that claviation is designed to overcome.
FIG. 2 shows how the major scale (‘do, re, mi . . . ’) is played on a piano keyboard in the key of C Major.
FIG. 3, for comparison, represents how it is played in the key of D Major, not just with the ‘do’ starting in a different position, but needing to advance on black keys at intervals which must be internalized.

Note that FIG. 3 is a pictorial representation of the key signature of D Major.

### (Multikey Overhead—Incidental and Total)

In this specification, “Multikey Overhead” refers broadly to the burden imposed on players of traditional piano-type keyboards by the existence of multiple key signatures. The term is used to represent cost in any relevant dimension, including time expended, loss of concentration or focus, expenditure of energy, opportunity cost, or reduction of motivation. Multikey Overhead manifests in two distinct forms: Incidental Multikey Overhead and Total Multikey Overhead.

### (Incidental Multikey Overhead)

Even players who do not aspire to full fluency across all 12 key signatures incur a burden simply by operating in a world where multiple key signatures exist. The cost arises not only when a player confronts a piece in a new key, but more generally whenever they engage with new material—whether learning a different piece, encountering a new passage, or practicing a novel pattern. In each case, the player must adjust to the key-specific demands of the material. For instance, a student who can play a piece comfortably in C Major but is asked to perform it in G Major must invest additional effort to relearn fingerings, patterns, and cognitive mappings. But even when repertoire consists of different pieces in different keys, the burden persists: each new key signature demands distinct adaptation, whether in muscle patterns, in the need to use black keys during execution, or in reading notation on the staff. This situational and pervasive cost—paid by every player regardless of long-term goals—is referred to herein as “Incidental Multikey Overhead”.

### (Total Multikey Overhead)

By contrast, “Total Multikey Overhead” refers to the complete “all-in fee” required for achieving full fluency across all 12 key signatures, and is paid only by players who reach proficiency in all of these key signatures, a state which we call “multikey fluency”. Whereas Incidental Overhead describes the recurring toll exacted whenever a player engages with new material in a world of multiple key signatures, Total Multikey Overhead is the cumulative burden of mastering them all. Paying this Overhead functions like an all-in fee: once it has been met, new pieces in any key can be learned with only minimal incidental effort, since the general schema for each key has already been internalized. By contrast, those who have not paid the full Total Multikey Overhead continue to face substantial incidental costs whenever they step outside their limited set of familiar keys. A good definition of when multikey fluency is reached is when the Incidental Multikey Overhead has become trivial in all situations. In capsule form: Incidental Multikey Overhead is the situational cost paid whenever music must be learned or executed in more than one key, while Total Multikey Overhead is the cumulative “all-in” cost of acquiring fluency across all 12 key signatures.

### (Analyzing Multikey Overhead)

Although beginners generally lack the vocabulary to describe it, the non-key-independence of the piano and its descendants—the electronic piano-style keyboard, and indeed most instruments—can come as a shock, disappointment and with an undermining of morale, enthusiasm and confidence. It is rarely articulated in these terms, but learning the piano is like learning the skills for 12 different nominal instruments. These 12 are certainly related, and a considerable fraction of the skills transfer between them, but the differences are significant and costly in both time and motivation. We say 12 because there are exactly 12 key signatures as defined here, one for each semitone in the octave.

The number 12 may appear unusual, since it is common to hear that there are 14 key signatures. The apparent inconsistency is purely semantic: in this specification, a key signature is defined by the physical keys and the actual notes they produce, not by their written notation. From this perspective, enharmonically equivalent key signatures are treated as one. For example, the key signatures of F # Major and G♭ Major are regarded here as the same, because they involve the same physical keys, sound identical, and require the same fingering.

For clarity, the term “notational key signature” will be used when referring to the entity which lives on the staff, which is the conventional use of the term ‘key signature’. By contrast, the unqualified term “key signature” in this specification means an “enharmonically distinct key signature”—an entity which lives on the physical keyboard and in tone space. Thus, when conventional usage refers to “14 key signatures,” what is actually meant is 14 notational key signatures, and that count traditionally excludes the empty key signature. By our usage, there are exactly 12 key signatures, all enharmonically distinct, one of which is empty.

This set of 12 enharmonically distinct key signatures can be conveniently numbered 0-11. Each number corresponds directly to the transposition setting (TS) value required to smart-tune to it, with key signature number 0 representing the empty key signature.

The compact table below identifies the set. Each 2-cell column corresponds to one enharmonically distinct key signature, with its TS value shown in the upper cell, and its defining Major key(s) identified by root note in the lower cell.

Exactly 3 of these key signatures correspond to more than one notational key signature in current use: at TS=1, TS=6, and TS=11. For example, the key signature at TS=6 corresponds to both F # Major and G♭ Major. The table shows such cases with two names of root notes in the lower cell, enharmonically equivalent, separated by a slash.

The notational key signatures for D # Major and A # Major have fallen into disuse; if they were still current, two additional cells would likewise contain paired note names.

Enharmonically distinct key signatures by Major key and TS value

| TS | 0 | 1 | 2 | 3 | 4 | 5 | 6 | 7 | 8 | 9 | 10 | 11 |
|---|---|---|---|---|---|---|---|---|---|---|---|---|
| Major | C | C [symbol] /D [symbol] | D | E [symbol] | E | F | F [symbol] /G [symbol] | G | A [symbol] | A | B [symbol] | B/C [symbol] |
| Keys | | | | | | | | | | | | |

The table above does not show how the key signatures are represented in notation, whether in sharps or flats, since these details are not directly relevant here. For completeness and for reference, however, they are set out in a larger table in Appendix C.5 (“The 12 enharmonically distinct key signatures”), which specifies all sharps and flats and lists the keys they represent, not only in Major but across all 7 modes.

### (Characterizing the Total Multikey Overhead)

The scale of the Total Multikey Overhead can be appreciated by examining what full multikey fluency actually entails. For each of the 12 key signatures, the player must not only learn which notes are assigned to the black keys, but also master which specific scale degrees those notes occupy. Fingering patterns typically differ for each scale and must be practiced separately for right and left hands. In some cases, distinct fingerings are traditionally used for Major and Minor, further multiplying the work. Three key signatures present an additional complication for sight-readers, since each has two enharmonically equivalent written forms that must also be internalized.

These demands go far beyond intellectual knowledge. True “internalization” requires practice until performance is fluent, automatic, and embodied—akin to the difference between knowing the grammar of a language and being able to converse in it. Achieving such fluency is vastly more time-consuming than conceptual learning, often requiring hundreds or thousands of hours of practice. In terms of motor learning theory, each key signature requires its own distinct motor schema—a neurally stored movement program for fingering and execution—which must be built separately and cannot be generalized across signatures.

A thought experiment makes the magnitude clearer: imagine 12 electronic keyboards arranged in a circle, each locked to a different key signature. If each instrument blocks music in other signatures, the player must acquire a separate skillset for each. Multiple modes—Major, Minor, and others—may share a signature, but the burden of adaptation remains tied to the signature itself. No two of these instruments even allow the same scale to be played with the same fingering on the same keys. Each requires its own motor schema.

The traditional piano, although a single device, imposes the same condition: each key signature functions like a separate instrument. Transfer of skill between them is only partial. At its worst, the situation resembles a typist forced to master both QWERTY and Dvorak keyboard layouts, with minimal carryover between the two. By this comparison, multikey fluency on piano is equivalent to learning 12 related instruments.

### (The Magnitude of the Total Multikey Overhead)

The cumulative cost of acquiring fluency in all 12 signatures—the Total Multikey Overhead—is vast. Scale practice pays off only a fraction of the debt. Being able to run a scale demonstrates intellectual knowledge of a key signature, and even fluent execution of the scale shows only the ability to reproduce notes in the specific sequence of the scale itself. Neither ensures that the key has been fully internalized across the full range of musical contexts.

The true burden lies in how unfamiliar layouts slow progress across the board, just as typists adapting to a new layout experience a prolonged drop in speed. Controlled studies of typing estimate that adapting from QWERTY to Dvorak requires 100-120 hours of practice. By contrast, the musical case is far heavier. First, there are 12 key signatures to master rather than two layouts. Second, music imposes demands beyond typing: the simultaneous coordination of multiple notes (as in chords), dynamic control of timing and articulation, and distinct fingerings not only for each signature but often also for mode and for each hand.

### (Approaches to Reducing Multikey Overhead)

While this Multikey Overhead has been culturally accepted by institutions and practitioners as inevitable, innovators have long sought ways to reduce it. Throughout the 19th century, two notable solutions were brought forward in an effort to ease the burden:
1. Isomorphic keyboards—two-dimensional keyboard layouts that preserve consistent fingering patterns across all keys.
2. Transposing pianos—instruments that the player can transpose by physically shifting the entire keybed, thereby enabling what is here called smart-tuning: playing in any key as though it were an easier one.

Isomorphic keyboards succeeded in eliminating the Overhead for those who used them, but their unconventional layouts introduced disadvantages that prevented mass-market adoption (see Appendix B.5, “Isomorphic keyboard benefits”). Claviation was originally invented to overcome some of these disadvantages, and succeeds.

Transposing pianos, by contrast, introduced smart-tuning to traditional keyboards. This did reduce Multikey Overhead, but only in part: they provided piecemeal relief of Incidental Multikey Overhead, while the Total Multikey Overhead remained untouched.

Smart-tuning itself is conceptually simple and centuries old. Horn players have long adjusted their instruments mid-piece to shift into easier keys, with composers writing rests long enough for them to do so. Mechanical transposing pianos supported smart-tuning more than 150 years ago, and electronic keyboards have offered transpose buttons for decades for the same purpose. Indeed, the primary purpose of transposition functionality on electronic keyboards is smart-tuning. (It may also be used for a different purpose—to shift the keyboard's accessible compass upward or downward, gaining notes at one end while losing them at the other—but this use is rare except on very small keyboards, and is usually confined to octave shifts.)

Smart-tuning can eliminate a key signature for a given piece and thus nibble away at Incidental Multikey Overhead. Yet it has never freed keyboard players from paying the enormous Total Multikey Overhead. The reason is critical: existing transpose systems do not support fully smart-tuned playing, that is, smart-tuning maintained throughout a piece and sustained through key changes for pieces which have them. To achieve this, the transposition setting must update in real time, without interrupting performance.

Prior art interfaces fail here. While they permit pre-performance transposition, they do not support fluent mid-performance key changes. One critical failure point is that transposition actions typically take too long and cannot, in general, be executed without disrupting the music. As explained later, a transpose during play must be able to complete within roughly one beat of the music. If it takes several beats, continuity is lost and the system becomes impractical for much of the repertoire. Pieces requiring even faster changes than one beat are vanishingly rare.

Thus, smart-tuning on electronic keyboards has remained practically confined to music without key changes. Yet key changes are central to a vast portion of the repertoire across many genres, making them the spoilers that render prior systems unfit for fully smart-tuned playing. Before this invention, a keyboard-playing musician wishing to avoid key signatures by relying on smart-tuning would have to forgo playing pieces with key changes. This is not acceptable, so in practice they are forced back into mastering all 12 key signatures and paying the heavy Total Multikey Overhead—effectively learning 12 instruments rather than one.

Not everyone gets as far as paying the Total Multikey Overhead of course, because they do not reach full fluency. But they still learn in the paradigm in which key signatures are accepted, the Total Multikey Overhead is to be paid, and key signatures are embraced.

In mechanical transposing pianos, the delay caused by transposition was inherently large: shifting the keybed physically took far too long to use mid-piece. But since the advent of electronic keyboards, transposition at the apparatus level has been essentially instantaneous—faster than human perception. For over seventy years, the bottleneck has not been processing speed but the human interface.

No input interface has allowed musicians to specify, in a performance-suitable way, the required transposition during play without interruption. That gap is what the present invention fills.

Claviation is the missing interface: a real-time transposition interface system designed specifically to meet the input demands of live musical performance. As will be shown, to support fully smart-tuned playing a system must satisfy five key requirements, set out after claviation is introduced.

(A Quick Summary of how this Invention Appears on the Landscape)

Prior-art transposition systems were designed only to nibble at the problem of multiple key signatures, providing at best a piecemeal reduction of Incidental Multikey Overhead. They never promised—nor were they ever expected—to eliminate the Total Multikey Overhead and therefore achieve true key-independence.

Indeed, the use of transposition in prior systems to smart-tune and trim away small portions of Incidental Multikey Overhead has often been regarded as a crutch or patch, even as a shirking of duty and postponement of the inevitable—and this view was not only a technical judgment but part of the musical culture itself, valid precisely because payment of the Total Multikey Overhead has always been required for proficiency.

Claviation, by contrast, introduces a real-time smart-tuning mechanism that not only addresses these incidental burdens but unexpectedly eliminates the Total Multikey Overhead in its entirety. In doing so, it transforms even the traditional piano-layout electronic keyboard into a genuinely key-independent instrument.

This result was neither foreseen nor suggested in the art. Moreover, the elimination of Total Multikey Overhead produces further unanticipated advantages, including diatonic transparency (defined later) and other systemic benefits, discussed in subsequent sections of this specification.

(Similarities with Quick-Change Capos on the Guitar)

A comparable moment in the history of musical instrument innovation occurred with the development of “quick-change” capos. Capos are mechanical devices used to transpose the guitar. Prior to the 1980s, traditional capos were slow to reposition, making them useful for smart-tuning before a piece began, but impractical for real-time transposition during performance. The arrival of quick-change capos in the 1980s changed this, enabling guitarists to transpose instantly, even mid-performance.

Claviation on the keyboard is analogous to the quick-change capo on the guitar: both enable real-time transposition where previously only pre-performance transposition was possible.

There are reasons, however, why claviation is far more transformational. The quick-change capo does provide a meaningful simplification—some keys are indeed harder than others on the guitar. But claviation instantly transforms what is like having to learn to play 12 related instruments into having to learn only the easiest of those 12. The quick-change capo does not produce a transformation that guitarists themselves would describe in terms nearly so powerful. The difference arises from the fundamentally different demands of playing the fretted instrument versus the keyed one, one of them being that the former has no real equivalent of a ‘very easy key’. As a result, the quick-change capo cuts far less deeply into the overall burden of learning the guitar than claviation does for the keyboard.

The quick-change capo also carries its own drawbacks: it shortens the strings and this alters the sound in ways the player does not always want.

### (The Prevailing Transposition Model)

Recall from the definition of transposition:
The transposition setting TS defines a uniform pitch offset applied across the entire keyboard. To transpose the keyboard is to change TS.

This is the standard way transposition is understood in both the technological art and the field of music. The most common prior-art transposition system today (named later as “Type 2 Prior Art”) reflects this directly: it uses two buttons—typically labeled “+” and “−”—to raise or lower the pitch of all notes by one semitone per press. This model aligns exactly with the definition of transposition by interval: the player selects an interval, and the entire pitch field shifts accordingly, achieved by pressing the appropriate button the required number of times.

### (Claviation's Underlying Model of Transposition is Different)

Claviation, by contrast, arises from a fundamentally different model of transposition.

### Groundwork—Drag-and-Drop and Pick-and-Drop

The well-known concept of drag-and-drop in computer interfaces is fundamentally a three-part interaction: pick, drag, and drop.
   What we define as the “pick” action occurs when the user presses the mouse button while the pointer is positioned over an object—this selects or “picks up” the object.
   What we define as the “drag” phase involves moving the mouse while holding the button down, thereby repositioning the object in real time.
   What we define as the “drop” occurs when the mouse button is released, placing the object at its new location.
At first glance, drag-and-drop may suggest moving an object wholesale from one location to a completely separate one—and often it does. But more generally, it involves selecting a specific point on the object and placing it elsewhere in space—a location that may already be occupied by another part of the object. This allows for subtle adjustments, like nudging a window a few pixels to the right. In such cases, the object moves in its entirety, but its parts shift into positions formerly occupied by other parts of itself. This behavior mirrors claviation, where the pitch field is effectively “dragged and dropped” across the keyboard—always overlapping its previous position—because the pitch field, as a virtual object, spans the entire set of keys.
Despite the common term ‘drag-and-drop’, it is the pick and the drop that define the essential structure of the interaction. The drag phase is merely an artifact of the mouse-based interface: it exists only to allow the user to specify the destination location by physically moving the pointer. During this phase, a complete, transparent or wireframe image of the object is typically shown moving as well—providing only visual guidance, not functional input. The actual operation is determined entirely by the pick and drop locations.
Viewed this way, drag-and-drop can be understood as a specific instance of something more general which we define as a “pick-and-drop interface”—an interface paradigm that applies to claviation.

### (Claviation is Pick-and-Drop for a Pitch Field)

Instead of requiring the player to specify a transposition interval, claviation operates as a form of “pick-and-drop”—not for physical objects but for virtual ones: pitch fields. The player first selects a pitch by selecting the key that currently plays it, called the “picking key”, —this is the pick phase. Then they select another key, called the “dropping key,” where they want that pitch to be playable instead—the drop phase. The system responds by transposing the entire keyboard so that the selected or “picked” pitch appears at the target key, with all other pitches shifted accordingly, preserving the integrity of the pitch field. Functionally, this is equivalent to a pick-and-drop interaction for pitch fields.

In essence:
Traditionally transposing is viewed as if the player is saying:
   “Shift the pitch of every key up or down by THIS interval.”
This corresponds to a transform ation that we call a ‘pitch lift’, where the pitch at each key location is raised or lowered independently.
Claviation works as if the player is saying:
   “Take the note currently played by THIS key, and move the pitch field to make the note occur at THAT key instead.”
This corresponds to a “field slide”, where the entire pitch field (a term to be formalized shortly) is shifted sideways across the keyboard. Claviation is a field slide with a pick and drop mechanism used to define the desired slide magnitude and direction.

The words THIS and THAT above indicate what the player is physically identifying with their actions—typically by pressing keys or engaging controls.

In both systems, the outcome is a transposed keyboard—but the way the input is expressed, and the way the player conceptualizes the action, are entirely different.

The functional equivalence between the two transposition systems—pitch lift and field slide—relies entirely on a fundamental property of the keyboard: the underlying pitch field is linear.

While the piano keyboard appears visually irregular—because of the varying sizes and staggered arrangement of its keys—the mechanism it controls is fundamentally regular. Beneath that irregular surface, each key actuates a hammer that strikes a set of parallel strings spaced evenly apart, much like those of a guitar or a harp.

Historically, this underlying geometric regularity was exploited in mechanical transposing pianos, which shifted the entire keybed sideways to slide the keybed across the uniform array of strings—physically implementing transposition. To formalize this regularity, we introduce a “regularized keyboard coordinate system,” in which each physical key is assigned a discrete, uniformly increasing position x along a horizontal axis that increases from left to right.

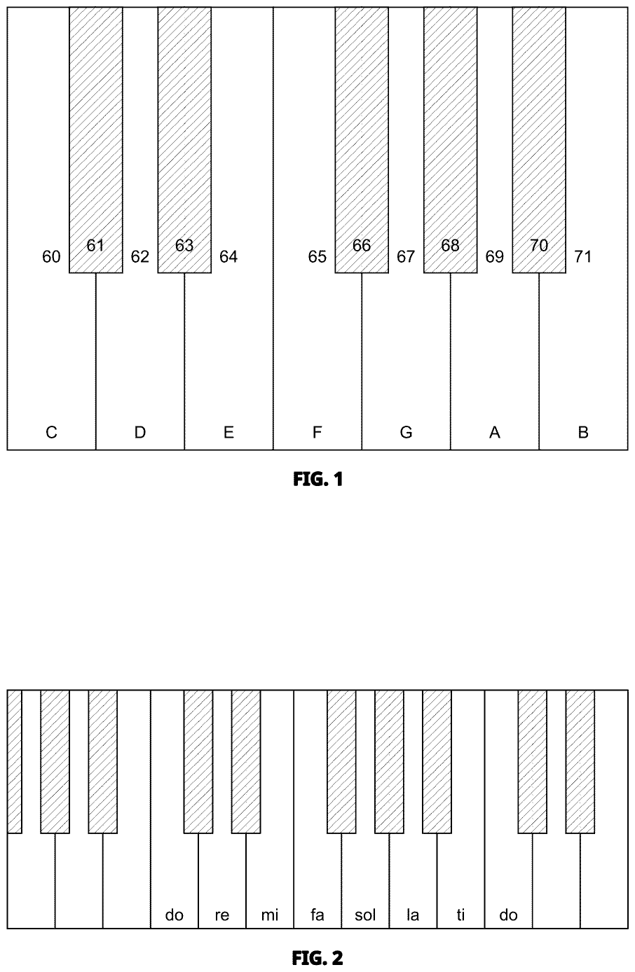

This regularity is illustrated in FIG. 1, where each key is labeled with its regularized x-coordinate. The octave in this figure is number 4, so the C key shown is middle C (C4). These labels are helpfully positioned near the front edge of the black keys, where the visual spacing makes them closest to uniform.

The choice of origin for this coordinate system is arbitrary, but MIDI provides a convenient standard: in this figure, coordinate x=60 corresponds to the key that produces pitch C4 (MIDI note 60) when the keyboard is not transposed. The system then extends indefinitely to keys left and right of the portion shown. We define a function x( ) that takes a physical key as input and returns its regularized coordinate. For example, in the illustrated system, x (physical C4)=60, and x (physical F4)=65.

Each unit step in x corresponds to an increase of one semitone in pitch. The pitch at position x is described by a function p(x), where pitch is measured in semitone units relative to some arbitrary reference.

### Groundwork—the Pitch Field, Transposition Setting and Pitch Lift

The pitch field at zero transposition setting is given by a function which we denote as p⁰(x). The definition of the transposition setting, TS, is that the pitch of all keys is TS semitones offset from what it is at zero transposition setting. Using our definition of adding an integer to a pitch, we can write this as:

$$p ( x ) = {p}^{0} ( x ) + TS . \qquad Equation 1$$

### Groundwork—Current and Upcoming

Transposition changes, for smart-tuning or in general, will be described from the perspective immediately prior to the change. Accordingly, the term “current” refers to the state that exists before the transposition act—for example, current key denotes the key being departed from, or ‘the current value of TS’, denotes the value of TS before the transposition change. Conversely, the term “upcoming” designates the state after the transposition change act. The superscript ‘^{c}’ is for ‘current’, and therefore TS^{c} is the current value of transposition setting. The superscript ‘^{u}’ is for ‘upcoming’, and TS^{u} is the upcoming value of TS. The difference between the two is ΔTS, so, for transposition change in general in any keyboard which supports it:

$${TS}^{u} = {TS}^{c} + Δ TS . \qquad Equation 2$$

Equation 2 can be regarded as expressing nothing more than ‘the meaning of ΔTS’—the increment to TS across the current (before) state and the upcoming (after) state of a keyboard at a transposition change.
To distinguish the pitch field before and after a transposition change, we introduce the following pitch fields:
   p^{c}(x) —what we define as the current pitch field, representing the pitch at position x just before the transposition change.
   p^{u}(x) —what we define as the upcoming pitch field, representing the pitch at position x just after the transposition change.
These notations allow us to precisely describe the effect of a transposition operation, either as a traditional pitch lift or as a field slide (to be defined shortly).

A transpose operation—a transpose level change—performed from the traditional perspective—what we define as a “pitch lift”—is formally expressed as:

p^{u}(x)=p^{c}(x)+ΔTS

Here, ΔTS is the change in the transposition setting, expressed in semitones—the input to the desired transposition change. That is, every key at position x after transposition now produces a pitch ΔTS semitones higher (or lower, if ΔTS is negative) than it did just before the transposition.

In contrast, claviation is best modelled as what we define as a “field slide”—a horizontal displacement of the pitch field over the keyboard:

p^{u}(x)=p^{c}(x+Δx)

Where

Δx=x(picking key)−x(dropping key)

The above transformation moves the pitch field Δx to the left. In this formulation, the pitch field is “slid” across the keyboard so that the pitch now produced at key position x is the same pitch previously produced at position x+Δx. In other words, the pitch field has shifted horizontally over the keyboard—a transformation we call a field slide.

The displacement Δx is measured in semitone-sized key units and corresponds to the spatial shift of the pitch field. It's value is chosen so that the pitch produced by the picking key before the transpose is the same as that produced by the dropping key afterward. A claviation can therefore be understood as a pick-and-drop operation applied to the pitch field itself: the note is picked from the picking key and dropped onto the dropping key, and the field slides to match.

For a given field slide, is there always an equivalent pitch lift? The answer is yes, provided that the pitch field is linear in x, and if it is, the equivalence is given by:

$$Δ TS = Δ x$$

And in our regularized co-ordinate system and in standard equal-tempered tuning the pitch field is indeed linear in x.

The pitch field can be visualized in the x-y plane, with pitch on the y-axis and the regularized key coordinate on the x-axis. Although the field is defined only at integral values of x, it is instructive to imagine it as a continuous curve, with the integral values of the domain being the ones of interest. Under this visualization, the requirement of linearity becomes clear: a linear pitch field corresponds to a straight line. Shifting this line horizontally (a field slide) produces the same effect as shifting it vertically (a pitch lift). This equivalence holds only for straight lines; for non-linear curves, horizontal and vertical shifts are not equivalent, so a transformation of the pitch field defined by a field slide would not have an equal one defined by a pitch lift.

### (The Claviation Process Defined)

The claviation interface is technologically simple. Hardware-wise, it requires only the aforementioned claviation trigger (a button or pedal) to activate what we call “claviation transposition mode”, or just “transposition mode”, which is active only for the two keypresses which follow and then ends automatically. While the mode is active, keys are muted and the keyboard itself then serves as the input interface, allowing the player to define the desired transposition using just two key presses.

The trigger for claviation should be ergonomically large and accessible during play. More than one trigger can be supported, in which case all triggers behave identically. In an ideal embodiment there is at least one button but also a pedal jack for players who prefer to use the pedal to claviate. Experienced players in key-change-rich genres like jazz might be drawn towards the pedal.

### Definition of the Claviation Process

1. The starting transposition setting is TS^{c}. The player presses the claviation trigger to enter transposition mode.
2. In transposition mode, the first keypress by the player on the keyboard defines what we term the picking key, which currently would play the note to be moved (if pressed in normal play).
3. The second keypress defines what we term the dropping key, the new location for that note.
4. During the transposition mode, both the picking and dropping keys are muted, ensuring that pressing them does not interfere with the music.
5. Once the dropping key is pressed, transposition mode is over and the new transposition takes effect, defined in that:
   The dropping key now plays the note that the picking key played just prior to this transposition act.
   Note: To initiate a subsequent transpose operation, the claviation trigger must first be released and then pressed again
6. Playing proceeds as normal in the newly transposed state, TS^{u}.

Recall that transposition on a keyboard is normally defined by Equations 1 and 2:

$$p ( x ) = {p}^{0} ( x ) + TS \qquad Equation 1$$

$${TS}^{u} = {TS}^{c} + Δ TS \qquad Equation 2$$

Recall, p(x) is the pitch produced at key position x; p⁰ (x) is the baseline pitch field at zero transpose; TS is the transposition setting; and ΔTS is the change in that setting that the transpose act is enforcing. The superscripts “^{c}” and “^{u}” denote the current and upcoming states, respectively.

In the conventional transposition framework, the transposition functionality of an instrument is an interface through which the player's choice of actions force their chosen value of ΔTS to fit into Equation 2, thereby determining the new transpose state. Because of equivalence of pitch lift and field slide due to linearity, claviation fits directly into this paradigm, with ΔTS equivalently defined by the following equation:

$$Δ TS = Δ x = x ( picking key ) - x ( dropping key ) \qquad Equation 3$$

Notice that the integration of the method into the firmware is shallow and naturally encapsulated. Although its capabilities are considerable, and although it is conceptually based on a field-slide model rather than a pitch-lift model, because of linearity its implementation within the firmware is no more complex than a standard transpose-change interface.

The above description provides sufficient detail for those skilled in the art to implement claviation, demonstrating its remarkable technical simplicity. Once a readable trigger mechanism is available in hardware, the remaining functionality can be realized entirely within the firmware of an electronic keyboard, at very low development cost. As discussed later, if not implemented at the keyboard level, claviation-based transposition can be applied further downstream in the signal path—such as in a MIDI module or software—prior to audio output.

Step 5 above could alternatively be expressed in field-slide terms as: “A field slide of the pitch field is executed, bringing the note that was previously played by the picking key to the dropping key.”

What we define as to “claviate” is to perform a claviation. The verb claviate is derived from the Latin root clavis, meaning “key” or “nail.” This root survives in the names of keyboard instruments such as clavichord and clavinet in English as well as in terms for keyboard instruments in many other European languages—for example, in Klavier, the German word for piano.

While entering claviation mode mutes the two key presses that follow it, it is important to note that this does not impose a silence or musical rest. Notes sustained by either held keys or the sustain pedal remain unaffected—consistent with how transposition works in general on electronic keyboards. Thus, no gap in sound output is imposed by claviation.

(Claviation Succeeds where Prior Art Fails)

For a transposition functionality to support fully smart-tuned playing, it must satisfy five requirements, defined as follows. The technique disclosed here is designed to meet these requirements, whereas earlier approaches generally do not.

### 1. “Transposition Generality”

The system must allow transposition by any integer number of semitones within at least a modulo-12 range (one full octave). Acceptable ranges include −6 to +5, −5 to +6, or 0 to 11. Without this generality, certain transpose states—and therefore entire musical keys—are unreachable, breaking the promise of full smart-tuning.

### 2. “Musical Generality”

The system must meet these five requirements across core musical use cases:
   Function correctly for at least Major and Minor modes (ideally all seven modes).
   Support both initial smart-tuning and dynamic key changes during play. Partial coverage may offer limited usefulness, but full satisfaction requires handling all such conditions.

### 3. “Efficiency”

The operation must be fast enough for real-time execution during performance. Recall that as a practical cutoff, the action must be completable within approximately one beat of the music; operations requiring multiple beats are too slow to support fully smart-tuned playing.

### 4. “Relativity”

The system must apply transpositions cumulatively, with each new action building on the current transpose state: therefore, rather than setting TS directly as a function of the user's interaction, it sets ΔTS to that function.

### 5. “General Usability”

Beyond the above near-binary criteria, the action must be learnable, memorable, and executable as part of a musician's natural workflow. It should integrate smoothly with learning, performance, pedagogy, conceptualization, and communication.

The necessity of all of the above criteria except Relativity is intuitively clear and needs no further justification. The reason for the Relativity requirement is addressed in Appendix A.7 (“Why transpose for a kal key change must be relative”), which also demonstrates that claviation satisfies this requirement.

### (How Prior Art Fails)

A review of some of the prior art and the ways in which they failed to meet all of these requirements is given in Appendix C.1 (“Types of prior art and their limitations”).

### (Efficiency of Claviation)

Recall that a transposition action that occupies no more than one beat is generally short enough not to disrupt musical continuity during key changes. The musical reasons why one beat is sufficient are explained in Appendix C.2 (“The transposition window”).

Claviation easily fits into a single beat. To someone unfamiliar with keyboard playing, the idea of pressing three separate controls in sequence within a single beat to achieve one result might seem awkward, or rushed. For keyboard players, however, the action is easy to carry out and easy to treat as a unit. The sequence—trigger, picking key, dropping key—is directly analogous to playing a musical triplet, a basic and familiar rhythmic figure. This coordinated three-part gesture, here called the “claviation triple” (trigger, pick, drop), quickly becomes fluid and intuitive. (The word triple is used here rather than triplet because triplet might mislead people that triplet rhythm is required.) Even beginners can learn to fit it readily into a single beat, and much of their early repertoire would not demand such rapid execution in any case. Thus, although claviation literally involves three control presses, it preserves for keyboard players the quality described by the idiom ‘at the touch of a button’: it feels like one simple, immediate gesture.

### (General Usability of Claviation)

### Groundwork—Transpose Reset

A ‘transpose reset’ or just ‘reset’ for short, refers to a keyboard-supported action executed by the player that sets TS=0, that is, sets the instrument into its zero transpose state, where the mapping from physical keys to pitches matches that of a concert-tuned acoustic keyboard.

An easy, efficient, and ergonomic transpose reset is an important adjunct to claviation, enabling smart-tuning at the start of play. A simple implementation—described in Appendix A.3.1 (“Ergonomic transpose reset as a key adjunct to claviation”) —uses a long press of the claviation trigger. This implementation requires no additional hardware, and the brief time taken for the long press is not problematic at the beginning of a performance. Appendix C.3 (“Some enhancements”) discusses a further enhancement that removes most of even this extra delay, again without requiring additional hardware.

### (The “Multibutton Solution” is Illustrative)

A sufficiently fast, general, and relative transpose interface can meet requirements 1-4, but to function as a true real-time smart-tuning interface it must also satisfy requirement 5: General Usability. Meeting this requirement is what distinguishes a merely fast and general transpose interface from one that is genuinely usable by players in performance as a real-time smart-tuning interface.

To illustrate the point, consider a deliberately contrived interface we shall call the “Multibutton Solution”. This design provides rapid and general transposition functionality but fails the test of General Usability, and therefore cannot serve as a real-time smart-tuning interface. It consists of 22 buttons labeled −11 through +11, each applying a transposition in semitones (ΔTS) equal to the number on its label, and one more button for executing a transpose reset. This interface clearly allows the player to instantly force any ΔTS of choice within the needed range.

Suppose the player wishes to smart-tune the instrument for three following sample set of cases:
1. E♭ Major
2. E♭ Minor
3. E♭ Dorian

In each case, the player begins by pressing the reset button, which sets TS=0. From this baseline, specifying a ΔTS directly sets the new TS.

It can be shown that the required values are: TS=3 (or −8) for E♭ Major, TS=6 (or −6) for E♭ Minor, and TS=1 (or −11) for E♭ Dorian. Thus, for example, to reach E♭ Minor the player must press “+6” or “−6” after reset.

The difficulty is obvious to players: how is the player to know which number to press? The system requires input as a semitone count—a value not naturally known even to experienced musicians. This alone makes the interface fail General Usability.

It does, however, satisfy Efficiency: if the player knows the correct number, a single button press suffices, easily within a beat. But musicians do not think in semitone counts. Even theoretically trained players think in intervals (“a perfect fifth,” “a minor third”) or in harmonic functions, not offsets in semitones. On a conventional keyboard, intervals are perceived through shapes and hand positions, not through mental arithmetic. Forcing players to translate intuitive musical concepts into numbers imposes a cognitive burden that disrupts fluency and prevents spontaneity.

The difficulty arises immediately at the start of play, where the input to the calculation is the named key the performer wishes to smart-tune to. Since there are a limited number of keys, a player could in principle memorize the TS values for each. But further problems occur during key changes in performance, which require additional calculations. Key changes are not all simply modulations of the tonic a prescribed number of semitones, and can take several forms: a tonic change with mode unchanged, a parallel change (mode change with tonic unchanged), or a combined change (both tonic and mode shift). In each case, the player would need to either remember a separate number for these cases, or to calculate the required TS for the new key, subtract the current TS and use ΔTS as the difference.

This is not how performers think or wish to play. The system therefore fails General Usability: an interface that requires numerical calculation rather than mapping directly onto musical concepts cannot support fluent, spontaneous performance in a way acceptable to musicians.

This illustrates the critical point: General Usability is not an optional advantage but a key formal requirement. A transpose mechanism that is fast and general but cognitively burdensome collapses in practice. The Multibutton Solution demonstrates this distinction clearly—it offers instant, general transposition, yet fails as a real-time smart-tuning interface because it is not sufficiently usable.

Claviation, by contrast, satisfies General Usability—and does so exceptionally well. It accommodates real-time interaction for all key-change types, supports natural musical thinking, and harmonizes with staff representation, learning, teaching, and communication. Because demonstrating these qualities requires detailed exposition and some musical expertise to evaluate, that material is deferred to:

### Appendix, Part A: General Usability of Claviation

As demonstrated in Appendix Part A, with the addition of a single hardware element—a trigger such as a button or pedal jack—claviation transforms the keybed itself into a highly intuitive control surface for real-time, general smart-tuning. It becomes not merely a rapid and general transposition interface but the higher-level smart-tuning interface that the musician actually needs. Unlike contrived solutions such as the Multibutton Solution interface, claviation does not force players to calculate numeric offsets; it aligns with how musicians already think—through intervals, shapes, and already-embodied motor schemas. This is the essence of General Usability, and it is what turns a mere transposition interface into a true smart-tuning interface.

In the context of electronic instruments, a control surface refers to a defined region of the instrument furnished with physical interface elements designed for active manipulation during performance. Effective control surfaces are ergonomic, responsive, and conceptually aligned with the musical task they control.

Claviation achieves this in an ideal way: at zero additional cost and consuming no extra space, it creates an enormous highly-usable control surface, since it transforms the very playing surface of the keyboard itself into that control surface. The result is arguably the best possible control surface for real-time smart-tuning—one that feels native to the performer and is mastered through playing, not through memorization of numbers.

Appendix Part A demonstrates that smart-tuning by claviation to the above sample set of three starting keys is easy and intuitive—and that the same ease extends across all seven modes, not just Major, Minor, and Dorian. Mid-performance key changes are executed with equal facility, removing the traditional need for theoretical preparation before such playing. Moreover, Appendix Part A shows that the remaining requirements are likewise met—not through itemized proof, but through the demonstrated generality of claviation itself: the ability to smart-tune to any key, in any mode, and to execute key changes in real time.

In short, claviation makes smart-tuning feel like playing rather than calculating. It is learned as playing is learned—non-numerically, through pattern and muscle memory—and its gestures can be represented directly in staff notation, dovetailing naturally with traditional musical communication and pedagogy.

### (The ‘Claviating Keyboard’)

A keyboard equipped with claviating functionality will be referred to as a “claviating keyboard”, while one that lacks this functionality will be referred to as a “traditional keyboard”.

Throughout this specification, the term claviating keyboard will be used in a way that carries the implied assumption that it is used in a manner that fully leverages the benefits of claviation as described herein. Accordingly, phrases such as “the claviating keyboard eliminates . . . ”, “the claviating keyboard naturally reinforces . . . ”, “the claviating keyboard is always kept smart-tuned”, or “on the claviating keyboard” are to be interpreted with the implicit qualifier: “when it is used as prescribed as the normal way to play a claviating keyboard in this specification.”

It is important to note that this implied qualifier is made present purely for the sake of efficient exposition, and in practice, claviation remains an optional functionality: a physical example of a claviating keyboard does not impose claviation on players, who are free to play it as a traditional keyboard if they desire.

### (On the Claviating Keyboard, the Keyboard is Kept Smart-Tuned)

The claviating keyboard is played in a way that maintains smart-tuning continuously, through the real-time use of claviation.

This has implications for making playing easier to do and learn—and this is obvious because it eliminates the Total Multikey Overhead—but it is a little less obvious how powerfully positive the implications are for making music easier to understand, and especially, to improvise.

### (Not Confined to Piano-Style Keyboard Layout or 12 EDO)

Although this specification treats piano-type keyboards as the default and illustrated case, the invention is not limited to them. It also applies to isomorphic keyboards and to instruments not typically classified as keyboards, such as digital accordions.

Similarly, while 12-tone equal temperament (12 Equal Divisions of the Octave, or 12 EDO) is assumed by default—reflecting its role as the historical standard tuning system in Western music—the invention is not confined to that system.

### 1.2 Advantages and Benefits of Claviation

The three parts of the appendix are:

### Appendix, Part A: General Usability of Claviation

This section rigorously establishes that claviation satisfies the General Usability requirement for fully smart-tuned playing. In doing so, it naturally reveals many advantages—such as its representability on a musical staff notation which has no key signatures. However, the primary focus of Part A is demonstrating General Usability, and it is not organized as a demonstration of advantages or benefits.

### Appendix, Part B: Advantages and Benefits of Claviation

This section provides an in-depth and systematic account of claviation's merits.

### Appendix, Part C: Supplementary Technical Material

Collects material that is valuable for reference but best kept outside the flow of the main body.

The present section of the main specification (namely, Section 1.2) serves as a distilled summary of claviation's advantages and benefits, and in that, as a summary of Appendix, Part B, and makes frequent reference to the latter for full substantiation and elaboration.

While claviation offers substantial advantages to all learners, it delivers additional and especially powerful benefits to what we call adaptive players—those who perform with some degree of flexibility, including but not limited to improvisation.

### Groundwork

We distinguish between two fundamental approaches to keyboard performance—two types of players—though many musicians blend both:
“Fully scripted playing” refers to performing exactly as taught, typically by reading from a written musical score. This is the primary method emphasized in most piano instruction today. While there is room for interpretation and expression, it occurs strictly within the framework of the written script.
“Adaptive playing”, by contrast, involves performance that is not fully prescribed. The most extreme form is improvisation, but adaptive playing also includes flexible realization of partially specified music—such as embellishing, reharmonizing, or shaping accompaniment in response to the moment.
These two approaches are not mutually exclusive. For example, a cocktail pianist might play a scripted melody while improvising the accompaniment.
Adaptive players typically rely less on traditional staff notation. Many work from lead sheets, where the melody is notated but harmony appears only as chord symbols-leaving the arrangement to the performer.
An adaptive player is therefore engaged, in a real sense, in real-time “authorship” of music. By contrast, a scripted player is engaged in real-time execution of a fully pre-authored score, whether read directly or recalled from memory—though authorship and creativity are still certainly impossible but outside the script, such as in interpretation.
Two fundamental elements of authorship are conception and production: the performer must first conceive of musical material, then produce it—whether in real-time improvisation at the instrument or, in composition, through notation on a score.
Some genres are never taught or played in a fully scripted manner. A clear example is jazz keyboard. In the current age, it is effectively impossible to learn jazz keyboard using fully scripted methods, as complete notated scripts that capture all aspects of authentic jazz performance simply do not exist.
Clearly, those who intend to compose can gain tremendous benefit from adaptive playing, because it develops an understanding of music from an authorship level.

We present the main advantages under two headings:
Executional enablement
Perceptual-creative enablement

### (Executional Enablement)

Claviation eliminates the Total Multikey Overhead. It does impose the learning burden of learning claviation itself but this is negligible in comparison. If a player only needs to learn one effective instrument—rather than 12 distinct key-signature-bound variants of the same instrument—in a given amount of time, they will inevitably progress more rapidly in their ability to execute repertoire. We refer to this acceleration as “executional enablement.”

This advantage is directly analogous to the advantages that the Dvorak adds over the QWERTY layout in typing. Typing ability is generally measured by speed and accuracy. The Dvorak layout is considered superior because typists can reach higher typing speeds in less time, making it considerably more executionally enabling than the QWERTY layout. Claviation offers the same kind of benefit in music: it lets players develop practical fluency more quickly and with less effort. In a shorter amount of time, they can develop a more complete reportoire.

### (Perceptual-Creative Enablement)

Unlike typing, musical performance for adaptive players requires not only mechanical fluency but also comprehension of abstract tonal structure—the relationships between notes, chords, and tonal centers. In terms of the conception-production dual of authorship, this is the conception element.

The claviating keyboard facilitates the conception element by presenting musical relationships in a physically consistent and key-independent form. This consistency enhances the player's ability to perceive and conceive tonal structures, thereby strengthening their capacity to improvise, analyse, and compose fluidly across key signatures.

This capability—enhancing a player's perception of musical relationships—will be referred to as “perceptual-creative enablement”. A fuller theoretical treatment is deferred to Appendix Part B; here the principle is introduced in outline.

### (Analogy: From Executional to Perceptual-Creative Enablement)

To distinguish perceptual-creative enablement from executional enablement, it helps to shift analogies. Executional enablement was earlier compared to learning one instrument versus 12 related ones.

For perceptual-creative enablement, imagine a pilot faced with 12 different airplanes whose controls are not rationally related: in one, pulling a lever raises altitude; in another, the same lever lowers it; in a third, a knob relieves pressure, while in another it increases it. Clearly the burden of mastering a single coherent aircraft is far less than mastering 12 inconsistently designed ones. Fully scripted players are analogous to pilots on fixed routes, who will therefore need a specific series of actions on the controls. Adaptive players, however, resemble pilots free to explore “musical space,” choosing routes of their own invention. For such exploratory flying, learning one coherent system rather than 12 inconsistent ones is profoundly enabling.

But even this analogy does not give claviation—and its perceptual-creative enablement—full credit. Real-world pilots already understand the three dimensions of physical space before they enter a cockpit. Music learners do not begin with an equivalent intuitive grasp of tonal dimensions. Musical space is multidimensional, with axes that are initially nameless and even conceptually hidden. A better analogy is a pilot flying in an unfamiliar multidimensional space, where some controls move the craft into directions they cannot yet recognize or name.
Example: the blue note. In blues music, the blue note is expressive and central, but its pitch is relative: in different keys, different tones fulfil the role.
On a traditional keyboard, the blue note may fall on any physical key depending on context, forcing the learner to rediscover its location each time. By contrast, on a claviating keyboard—because it is generally smart-tuned—the blue note always maps to the same physical key (E♭), regardless of musical key or whether the piece is in Major or Minor blues. This stability makes the E♭ key an immediate cognitive anchor: learners can recognize, explore, and incorporate the blue note across all keys without repeated retraining.

In cognitive science terms, the “blueness” of the note is a concept, and the physical key serves as its anchor. Spoken language relies on the same principle: words anchor abstract concepts through consistent use. Unlike the traditional keyboard—on which no physical key has an exclusive role—the claviating keyboard assigns unique, unchanging musical roles to physical keys, turning them into anchors for abstract notes, which, by definition, do not become disrupted with transposition of the piece as a whole. Thus, E♭ naturally anchors the blue note, and similarly, for example, C anchors the tonic of Major.
The value of such anchoring is well recognized in music pedagogy as a way to improve musical understanding: for example, the Kodaly Method uses hand signs, syllables, and sometimes colors to become anchors and reinforce the roles of abstract notes. The claviating keyboard achieves the same automatically, by making the physical keys themselves anchors for what are in fact the same abstract notes that the Kodaly Method reinforces. These notes are herein called the “kal notes”. This property, here called “diatonic transparency”, is grounded theoretically in Appendix B.2 (“Theoretical grounding of diatonic transparency”) which also explains the relationship of kal notes to scale degrees and their role in traditional theory.

The anchoring property extends from notes to chords. On the claviating keyboard, the “physical C Major chord” (the physical keys played for the C major chord at TS=0) consistently anchors the tonic chord of any Major scale. No other physical chord can do so. This provides anchoring not just for individual notes but for harmonic structures, further supporting conception.

With claviation, the “airplane” in the analogy is in multidimensional space and becomes one whose controls consistently move the craft along stable, named dimensions of musical experience. What was previously hidden and unstable becomes visible and reliable, making these dimensions conceptually available to the learner—and thereby enabling the adaptive player to engage more fully in the conception-production dual of authorship.

### (Claviating Keyboard's Treatment of any Given Musical Pattern)

In short:
There is an underlying musical pattern that corresponds to a given musical concept (the blue note as an example).
The traditional keyboard disrupts that pattern physically when musical keys vary, making recognition and formation of the related concept difficult.
The claviating keyboard preserves and physically reveals it.
Which makes it easier and more automatic to (i) conceive it and (ii) reproduce it on demand—which is required for authorship, which happens in adaptive playing.

The following table crystallizes the effect:

| | | | Result on |
|---|---|---|---|
| | Traditional | Claviating | claviating |
| Musical reality | keyboard | keyboard | keyboard |
| A musical pattern | Disrupted | Preserved and | Concept is easier |
| corresponds to a | physically across | revealed | to conceive and |
| concept (e.g. the | different keys; | consistently | reproduce on |
| blue note) | recognition is | | demand |
| | impeded | | |

### (Favorable Feedback Loop for Adaptive Players on Claviating Keyboard)

This lack of disruption sets up a favorable feedback loop for the adaptive player:
Single physical keys become cognitive anchors (in the Cognitive Science sense) for a key-independent musical reality.
This reinforces recognition of that reality.
The same key then becomes a reliable control to reproduce it, unlocking experimentation.

| Benefit on claviating keyboard | Effect of benefit |
|---|---|
| Single physical keys serve as | Reinforces recognition of that |
| cognitive anchors (in the Cognitive | reality |
| Science sense) for a key-independent | |
| musical reality | |
| Recognized anchors become reliable | Unlocks experimentation and |
| controls to reproduce the reality | improvisation |

### (Distinguishing Executional and Perceptual-Creative Enablement)

Executional and perceptual-creative enablement are complementary dimensions of the claviating keyboard's advantages.

Executional enablement addresses the sheer mechanics of playing. On a traditional keyboard, the student must master 12 distinct fingering systems—one for each enharmonically distinct key signature. This is like having to learn 12 different instruments. The additional effort required is the Total Multikey Overhead. By collapsing these 12 systems into one, claviation removes that overhead and accelerates practical fluency.

Perceptual-creative enablement addresses the problem of learning musical meaning, and being able to author music based on it. Adaptive players—those who improvise or compose—must not only execute notes but also recognize stable musical roles: tonic, dominant, blue note, and so forth—and learn to reproduce them. On a traditional keyboard, each role migrates to a different physical key whenever the musical key changes. This constant remapping is like having to learn 12 different languages with no cues to keep them apart. We call this problem “pattern interference”—the disruption of patterns, which prevents musical roles and structures from being perceived as parts of one consistent “language of music.”

The contrast can be summarized as follows:

| Problem/burden on | Formal name | Advantage on claviating |
|---|---|---|
| traditional keyboard | of burden/ | keyboard (by removing |
| (analogy) | problem | the burden/problem) |
| Like learning 12 different | Multikey | Executional enablement - |
| instruments or machines | Overhead | faster fluency with one |
| | | system |
| Like learning 12 different | Pattern | Perceptual-creative |
| languages with no cues to | interference | enablement - stable |
| differentiate them | | anchors, consistent |
| | | “language” |

Unlike multilingual children, who are evolutionarily equipped with deep neural mechanisms for distinguishing the languages they are learning—picking up cues of register, rhythm, and context and keeping them cleanly separated—keyboard learners have no such advantage. The key signatures provide no comparably neurally fundamental cues. Each shift of key signature remaps roles to new physical locations without signaling in an effective way to the brain that a distinct “system” is in play. As a result, major pattern interference is inevitable: musical roles blur, patterns lose stability, and learning about musical structure is slowed.

The claviating keyboard eliminates this burden by fixing roles to stable physical anchors. Tonic, dominant, blue note, and other roles always map to the same keys in a given mode. Learners can therefore treat music as one coherent language rather than 12 inconsistent dialects, gaining both fluency and conceptual clarity.

(the Kal Staff—for any Piece but with No Key Signature)

Appendix Part A introduces what is called the “kal staff”—a modest yet powerful enhancement to standard musical staff notation. Designed for the claviating keyboard, it eliminates key signatures, replacing them with “claviation marks”, annotations indicating exactly what claviation to perform to smart-tune, whether at the beginning of the piece or at a key change during play. There is no new skill to be learned except how to read the claviation mark and experienced sight-readers can learn this within minutes. The rest of the content of the score is just the piece as if transposed to the easiest key, in standard notation. A “kal score” is a kal staff with musical content.

Because much written music today is accessed in digital form, a software utility can convert it into kal score form instantly—removing key signatures and making vast libraries accessible overnight. In effect, much of the world's digital sheet-music archives can be rendered into kal score form almost overnight—and in a way accessible to the end-user. Further details of the process of conversion are set out in Appendix A.9 (“Conversion of scores automatically in software”).

### (Further Benefits for Adaptive Players, Especially Jazz)

While eliminating multikey overhead is already transformative for fully scripted players—providing great executional enablement—the additional advantages of perceptual-creative enablement for adaptive and improvisational playing, especially in genres such as jazz, are so substantial that they merit further illustration. A dedicated discussion is provided in Appendix B.3 (“A further look at advantages for jazz players”).

### (Reducing Multikey Overhead for Adaptive Learners of the Acoustic Piano)

Although claviation cannot be directly applied to the acoustic piano—since it requires electronic control—a significant and unexpected advantage is that a learning path involving the claviating keyboard can greatly assist adaptive players whose ultimate goal is multikey fluency on the acoustic piano.

For such players, the Total Multikey Overhead cannot be eliminated. Less obviously, however, and potentially surprisingly, claviation can reduce and positively restructure that burden, especially for improvisers. Claviating keyboards function as powerful practice tools, allowing adaptive players to internalize musical patterns more intuitively, with less frustration and ultimately greater speed. This effect is achieved through the method of “hybrid kal signatures”—see Appendix B.4 (“Hybrid kal signatures—an easier learning path for improvising on acoustic piano”) —which stages the progression across notational key signatures on the acoustic piano in a cumulative, pleasant and non-regressive manner.

### (Benefits for Players of Isomorphic Keyboards)

As detailed in Appendix B.5 (“Isomorphic keyboard benefits”), claviation offers significant advantages to isomorphic keyboard players.

### (Enabling Dynamic Just Intonation)

As explained in Appendix B.6 (“Enabling dynamic just-intonation”), claviation can also be used to implement dynamic just intonation.

### 1.3 Summary of Embodiments

Key embodiments of the invention are as follows:
1. Claviation functionality embedded directly into the keyboard at the time of manufacture, with built-in button and/or pedal jack as claviation trigger. See Section 3.1. for further details.
2. A MIDI module that can be used with an existing MIDI keyboard or MIDI controller, effectively enabling claviation functionality for a keyboard that does not have it. See Section 3.2 for further details. Ideally, the MIDI module includes a pedal jack or equivalent input port capable of receiving the claviation trigger signal.
3. A software utility that applies claviation functionality to a MIDI stream before it is sent to a DAW (Digital Audio Workstation). See Section 3.3.
4. Embodiment in the software of a DAW itself. See Section 3.4.

### (Repurposing a Key as Trigger)

In MIDI embodiments 2, 3, and 4 listed above, the claviation trigger signal should ideally be configurable by the user in a sufficiently general way within the MIDI environment, that it allows a physical key on the instrument itself to be repurposed as the trigger—eliminating the need for additional hardware. Common choices for the trigger key would be the highest or lowest key, or both. Ideally, the environment includes a learn mode in which the user designates the playing key to be repurposed as the claviation trigger by simply pressing it, providing an intuitive and user-friendly setup process.

### 1.4 Patentability Considerations

### 1.4.1 Inventive Step/Non-Obviousness

Multiple persuasive considerations support the conclusion that the present invention possesses an inventive step—or, stated differently, that it was not obvious to a person skilled in the art (POSITA) at the relevant time. In this context, the POSITA is best characterized as a professional developer of electronic musical keyboards, a designer of musical interfaces, or a specialist in digital performance systems.

The supporting considerations fall under two complementary headings:
Objective Considerations: Real-world evidence, including utility, cost, market history, and the failure of others, all of which point toward non-obviousness.
Hallmarks of Inventiveness: Qualitative traits long associated with inventive activity, including elegance, emergence from parallel endeavor.
Together, these considerations reinforce the conclusion that the invention was not obvious, both in practical and theoretical terms.

### 1.4.1.1 Objective Considerations (Secondary Factors/Secondary Indicia)

Objective considerations—also known as secondary factors or secondary indicia—serve as real-world evidence that an invention was not obvious.

A considerable class of objective considerations are those which support the argument that:
If the invention were obvious, it likely would already have been invented.

This class is often labeled under the heading ‘failure of others’. This invention is strongly supported by such considerations. The core concept underlying the invention has been technologically feasible since the first electronic keyboards, approximately 70 years ago. For at least the past 40 years—when microprocessor-based keyboards and firmware have been standard—it has also been remarkably inexpensive to implement, both in development and per-unit cost.

Its utility is not only clear but, in many respects, profound. The combination of high utility, low development cost, and minimal per-unit cost makes its prolonged absence from the market striking. This absence—despite favorable conditions for development and no genuine external barriers—represents precisely what patent law terms the longstanding failure of others—a situation in which the non-obviousness of the invention itself is overwhelmingly the best explanation of the failure of others to reap the fruits of earlier invention.

These circumstances exemplify the classic objective considerations supporting inventive step.

Where objective considerations are strong, courts have repeatedly held that they can be decisive—establishing non-obviousness on their own and rendering further analyses unnecessary or contrary arguments irrelevant.

As an illustration, consider Appendix C.1.1 (“Type 1 Prior Art—Absolute Single-Key Selection”). This Type 1 approach has existed for decades, since at least 1982, appearing in 1982 in the Roland Juno-6 and Juno-60, Yamaha DX7 (1983), and Oberheim OB-8 (c. 1983). It is still implemented in several Roland models today, including the Roland F-90 digital piano. It shares with the present invention the use of the keyboard's own muted keys as transposition controls. However, it did so only with a single key and without satisfying Relativity, (shown to be a requirement in Appendix A.7) making it insufficient in two distinct respects.

A potential claim of an adversary to the inventor that this prior art effectively ‘teaches toward’ the present invention is completely neutralized by the objective considerations of the interim 43 years. In this case, an adversary asserting that the objective considerations are insufficient faces a legitimate two-part challenge:
If non-obviousness was not the barrier in this classic longstanding-failure-of-others situation, what barrier plausibly explains the decades of inaction despite such low cost and high utility?
If an adversary deems these objective considerations insufficient here, can they point to any case—approved by an examination office or court—where objective considerations were demonstrably stronger?

Another class of objective considerations concerns
unexpected, surprising, or unanticipated results.

This invention is replete with them:
Since at least 1982, the accepted view has been that transposition functionalities could at best nibble away at Incidental Multikey Overhead. To discover—over four decades later—a solution that is cheap, easy to implement, and that can entirely eliminate the Total Multikey Overhead, creating a genuinely key-independent keyboard, playable withoout key signatures, is unexpected in the strongest sense.
The capacity of fully smart-tuned playing to generate diatonic transparency—where the instrument itself performs the actively pursued pedagogical goal of recognized music schools such as those of the Kodály Method, by reinforcing internalization of kal notes—is both surprising and unprecedented. The inventor has found no documentation of diatonic transparency itself, let alone any suggestion that full smart-tuning could unlock it. (See Appendix B.2.)
The degree of enablement for jazz improvisation is striking. Before claviation, it was unthinkable that relative beginners could improvise real-time key changes in any key, entrain the listener's ear to them through the jazz ‘2-5-1’ progression, and do so freely within and between both Major and Minor modes—all without studying music theory, without learning to distinguish between major chords, minor chords or the various types of seventh chords, and by relying almost exclusively on simple, uniformly shaped chords. (See Appendix B.3.)
Equally surprising is that this invention, while implemented on an electronic keyboard, makes such a device an excellent practice instrument for learning to improvise on the acoustic piano. (See Appendix B.4.)

### 1.4.1.2 Hallmarks of Inventiveness

The invention exhibits multiple qualitative traits historically associated with inventive activity.
Elegance
Emerging from a parallel endeavor, which extends unexpected benefit

### (Elegance)

In this context, “elegance” may be understood as the quality of components and concepts fitting together naturally and effectively.

Claviation demonstrates elegance at multiple levels. At the interface level, it achieves—through a single button—what in the predominant prior art, historically required more than one button, and even then was achieved vastly less effectively. It transforms the keyboard surface itself into a control surface for smart-tuning, without occupying any additional space.

Elegance is also evident in the KALC Framework—the framework devised by the inventor for using claviation described in Appendix Part A. The kal staff, for example, removes the need for key signatures while introducing only a minimal set of new notation elements: one notehead-like symbol and parentheses. This lightweight adaptation enables an experienced sight-reader to learn to read for claviation within minutes. The kal staff supports key changes during play with equal elegance, and its system of names for key changes is elegantly structured in parallel with the names of the musical keys themselves.

### (Parallel Endeavor Yielding Unexpected Benefit)

While not a requirement for inventive step, it is a recognized hallmark that an invention may emerge from efforts to solve a problem in a parallel domain. Claviation originated not as a general solution for transposition on the piano-style keyboard, but as a targeted enhancement for the Wicki-Hayden isomorphic keyboard—an established yet niche layout with strong theoretical and practical advantages. The objective was to unlock its mass-market potential by overcoming practical and ergonomic limitations that had limited its wider adoption as an electronic keyboard format—and ironically, not to add key-independence to that instrument, which already had it—but rather to enhance it further by making it diatonically transparent. The improvements sought and found for this class of isomorphic keyboards through claviation are described in Appendix B.5 (“Isomorphic keyboard benefits”). Only after the invention was complete did the inventor recognize its broader value for enabling smart-tuning and creating key-independence on conventional keyboards, which at least in the shorter term, will likely be the main application. This fits the pattern of inventions often being made in a domain somewhat collateral to the one in which it at first offers the greatest promise.

### 1.4.2 Eligibility of Claims Covering Software Embodiment

### 1.4.2.1 U.S. Jurisdiction: Patent Eligibility Under U.S. Law (35 U.S.C. § 101)

The claimed method is not directed to an abstract idea. The facts that none of the fruits of this invention:
can be obtained when an equivalent is practiced on pen and paper;
can be obtained except when it is embodied technologically in an electronic musical keyboard environment and used in real time;
   end any claim that it is ‘directed to’ an abstract idea.

The resulting transposed output is not a theoretical construct but a functional change in instrument behavior, produced by a configured machine in operation.

### Part 2: Definitions for Claims

Up to this point in the specification, terminology has been introduced for the purpose of illustrating the usability and merits of the invention. These terms aid in understanding of merits, but are not used in the claims.

From this point forward, definitions are introduced for terms used directly in the claims or in describing embodiments. They are intended to provide structural clarity and ensure consistency between the specification and the claim scope.

As used in the claims, the phrase “produce a note” is used in accordance with its customary meaning in the field of electronic musical instruments and MIDI systems. This includes initiating or causing a musical output in response to a keypress or other triggering event, and encompasses, without limitation:
Emitting an audible tone (e.g., via speakers, headphones, or an internal synthesizer);
Generating or transmitting a MIDI message corresponding to a musical note;
Generating or transmitting data that represents a musical note.

### (‘Setup’ and ‘Environment’)

Musicians using electronic instruments—whether in live performance or studio recording—are accustomed to their instrument being effectively distributed across multiple devices. Such configurations, including one or more electronic instruments, are commonly referred to as “setups,” and will be referred to as such in this specification.

As used in the claims, the term “electronic musical keyboard instrument environment” (referred to herein as the “e-keyboard environment”) refers to:
Any system or configuration that comprises exactly one electronic keybed, as defined herein, along with any supporting components (e.g., tone generators, control logic, software, or output channels) required to produce notes in real time in response to keypresses of the keybed on the electronic keybed.
In a specific configuration of the e-keyboard environment, each key of the keybed is mapped to one specific note. When the key is pressed, that note is normally produced. Multiple keys may be mapped to the same note, as is common in the case of isomorphic keyboards.
It is noted that a typical musical setup may include multiple keybeds (e.g., multiple keyboards sending MIDI signals to a common MIDI interface or router). In such cases, each keybed is part of a distinct e-keyboard environment within the overall setup.

As used in the claims, the term “electronic keybed” refers to:
A physical or virtual set of keys operable by a player for the purpose of musical input, wherein each keypress results in a signal (whether generated actively or made available passively) that identifies the pressed key within the e-keyboard environment, the pressing of such key normally producing a note.

As used in the claims, the term “transposition change” refers to:
A modification of the configuration of the e-keyboard environment such that an identical interval shift is applied uniformly to all keys of the keybed, causing each key to produce a corresponding different note after the change. This shift is normally uniformly additive across the pitch field, but for the purposes of the claims, transposition change also includes any process recognized in the art as transposition, even if the mapping is not strictly uniformly additive—for example, a transposition combined with dynamic just intonation.

As used in the claims the term “electronic keyboard” refers to:
An apparatus comprising an electronic keybed with physical keys and confgured to produce notes. The term includes standalone digital keyboard instruments as well as MIDI controllers.

As used in the claims, the term “muted” applies to an input or element normally intended to produce sound when it is temporarily configured not to produce sound.

### (Not Narrowed to Preferred Order of Picking and Dropping Key)

The term “first key” as used in the claims corresponds to the picking key described in sections prior to this chapter, and the term “second key” corresponds to the dropping key. In the preferred embodiment described throughout the specification, the picking key is distinguished by the e-keyboard environment from the dropping key by being the first key pressed in time. However, alternative embodiments are contemplated in which the picking key is distinguished by being the second key pressed, and the dropping key is pressed first. The claims are not limited by the order in which the first and second keys are pressed, while the descriptions for the embodiments are written on the assumption of the specified order.

### Part 3: Embodiments

In this part of the specification, terms that were introduced earlier to explain the merits and usage conventions of the invention—such as “picking” and “dropping”—are deliberately avoided. From this point forward, only the terminology formally defined in Part 2 is used.

Each of the following four embodiments:
1. directly in keyboard
2. in a dedicated MIDI module
3. in a software utility (‘MIDI middleware’)
4. directly in a Digital Audio Workstation (DAW)
   is first explained in plain language, and then restated using the formal terminology of Part 2 which reflects claim language. This dual presentation helps reinforce the meaning and scope of the formal language.

### 3.1 Embodiment in Keyboard

### 3.1.1 Plain Language Description of Embodiment in Keyboard

This embodiment describes an electronic keyboard with the transposition functionality of the invention built in. This is the illustrative embodiment referred to throughout Part 1.

The keyboard includes a mechanism by which the player can trigger entry into transposition mode, such as a dedicated panel button or a foot pedal input.

When in transposition mode, the keyboard mutes input—that is, it temporarily suspends the production of notes in response to keypresses—allowing the player to press two keys without disrupting play. The first key is used to select the note that that key currently produces, and the second key indicates the new position on the keyboard where that note should subsequently be produced after the transpose.

As soon as the second key is pressed, the keyboard adjusts its internal transposition setting so that the second key now produces the note that the first key previously produced.

After this change, the keyboard exits transposition mode automatically, and subsequent keypresses produce notes that are transposed by the selected interval.

The transposition functionality is implemented entirely within the firmware of the keyboard, requiring no external device or configuration.

### 3.1.2 Claim-Language Description of Embodiment in Keyboard

(Note: this is a repetition of the embodiment above, but in the formal language of this chapter, which serves the purpose of providing examples that reinforce the meaning of that language.)

In this embodiment, the e-keyboard environment comprises an electronic keyboard having internal firmware that implements a transpose control subsystem, which performs the claimed transposition change.

The electronic keyboard includes an input interface configured to receive a signal from the player that triggers entry into a transposition mode, in which two keypresses are muted. This interface may be implemented as a built-in button or a pedal jack.

While in transposition mode, the e-keyboard environment receives an input signal corresponding to the pressing of a first key, followed by an input signal corresponding to the pressing of a second key. During this time, keypresses do not result in the production of notes—that is, they are muted until the transposition change is effected

The transpose control subsystem is configured to effect a transposition change, wherein the transposition change is characterized in that the note produced by the second key after the transposition change is the note produced by the first key before the transposition change.

Following the change, the electronic keyboard exits transposition mode and resumes producing notes under the new configuration. The player cannot enter transposition mode again until they have released the trigger in the interim.

This embodiment, implemented within the electronic keyboard itself, is captured by claim 3, as well as by claim 2.

### 3.2 Embodiment in MIDI Module

### 3.2.1 Plain Language Description of MIDI Module

This embodiment describes an external MIDI module that maintains its own transposition setting and provides the special transposition functionality of this invention to a standard MIDI keyboard. Within such a setup, the connected keyboard continues to operate conventionally, transmitting only standard MIDI messages, while the module supplies the claviation capability.

The module includes a means for the player to enter transposition mode. This can be done using a built-in button, a pedal input, or a configuration mode that allows a specific MIDI message—such as pressing a user-selected playing key—to be configured to trigger transposition mode. In practice, if a playing key is used as the trigger, users will typically assign it to the lowest key, the highest key, or both, in order to keep the rest of the keyboard available for normal playing.

When transposition mode is activated, the input is muted: the module temporarily stops forwarding MIDI keypress messages received, so keypresses do not produce audible output or transmitted note data. This allows the player to define the transposition change using the keys without disrupting play.

While muted, the player presses two keys on the connected keyboard. The first key is used to select the note that the key currently produces, and the second key indicates the new location on the keyboard where that note should now be produced after the transpose.

As soon as the second key is pressed, the module updates its transposition setting so that this second key now produces the same MIDI note that the first key previously produced. The module then exits transposition mode and resumes forwarding MIDI messages to its output port, with transposition applied as usual but now under the new transposition setting. The player cannot re-enter transposition mode until the trigger has first been released.

This setup enables standard MIDI keyboards to gain real-time transposition functionality through firmware in the external module, without requiring changes to the keyboard itself.

### 3.2.2 Claim-Language Description of MIDI Module

In this embodiment, the e-keyboard environment comprises an external MIDI module that performs the claimed transposition change.

The MIDI module includes an input interface configured to receive a signal from the player that triggers entry into a transposition mode, in which two keypresses are muted. This interface may be implemented as a physical button, a pedal jack, or a configurable MIDI trigger such that specific keypresses or MIDI messages are interpreted as a transpose trigger.

While in transposition mode, the MIDI module receives input signals via MIDI from an electronic keyboard, corresponding to the pressing of a first key, followed by the pressing of a second key. During this mode, the module does not forward MIDI messages corresponding to these muted keypresses to downstream devices.

The module includes a transpose control subsystem configured to effect a transposition change, wherein the transposition change is characterized in that the note produced by the second key after the transposition change is the note produced by the first key before the transposition change.

Following the transposition change, the MIDI module exits transposition mode and resumes forwarding transposed MIDI signals in response to subsequent keypresses. The player cannot enter transposition mode again until they have released the trigger in the interim.

This embodiment in the external MIDI module itself is captured by claim 4, as well as by claim 2.

### 3.3 Embodiment in MIDI Middleware

### 3.3.1 Plain Language Description of MIDI Middleware

This embodiment describes a software utility—referred to herein as “MIDI middleware”—that operates between a MIDI input device (e.g., a keyboard) and a MIDI output destination (e.g., a synthesizer, digital audio workstation (DAW), or other sound-producing system). The utility maintains its own transposition setting and is configured to intercept, modify, and forward MIDI messages in real time, thereby implementing the transposition functionality of the present invention.

The MIDI middleware receives input from a user-selected port, typically connected to an electronic keyboard. It includes a mechanism for entering transposition mode, which may be invoked by a keyboard shortcut, a user interface control, or a configurable MIDI trigger. Such a trigger may be assigned to a playing key, but is not limited to this: any MIDI message can be designated by the user, including a note event, a control-change command, or another signal from a connected MIDI device.

When transposition mode is activated, input is muted; that is, keypresses do not result in audible sound or output. The middleware temporarily suppresses the forwarding of MIDI note messages, allowing the player to press two keys on the input device without affecting any downstream system and disrupting the music.

These two keys define the transposition change: the first key is used to select the note that that key currently produces, and the second key indicates the new position on the keyboard where that note should now be produced after the transpose.

After the second key is pressed, the software adjusts its internal transpose mapping so that the second key now produces the note that the first key previously produced.

The utility then exits transposition mode and resumes forwarding transposed MIDI messages based on subsequent keypresses.

### 3.3.2 Claim-Language Description of MIDI Middleware

In this embodiment, the e-keyboard environment comprises a running instance of a software utility—referred to in this specification as MIDI middleware—that performs the claimed transposition change by intercepting and processing MIDI signals in real time.

The software includes an input interface configured to receive a signal from the player that triggers entry into a transposition mode in which two keypresses are muted. This interface may take the form of a graphical button, a configurable MIDI message, or a designated playing key interpreted as a trigger to enter transposition mode.

While in transposition mode, the utility receives input signals from an electronic keyboard, corresponding to the pressing of a first key, followed by the pressing of a second key. During this mode, MIDI messages corresponding to the muted keypresses, being muted, are not forwarded by the utility to any downstream device.

The utility effects a transposition change, wherein the transposition change is characterized in that the note produced by the second key after the transposition change is the note produced by the first key before the transposition change.

Following the transposition change, the utility exits transposition mode and resumes outputting transposed MIDI signals based on subsequent keypresses.

This embodiment in the software utility is captured by claim 5, and corresponds functionally to the apparatus of claim 2 as implemented in software.

### 3.4 Embodiment in DAW

### 3.4.1 Plain Language Description of Embodiment in DAW

This embodiment describes a digital audio workstation (DAW) that implements the transposition functionality internally. The DAW receives MIDI input from a connected keyboard or other controller and includes a mechanism to enter transposition mode.

The player can enter transposition mode through a GUI control, a key command, a configured MIDI message, or a control surface. When transposition mode is activated, incoming MIDI note messages are temporarily muted—meaning they are ignored or suppressed—so that pressing keys does not produce sound or forwarded MIDI output. This allows the performer to specify a transposition change without disrupting play.

While in transposition mode, the performer presses two keys on the MIDI input device. The first key identifies the note that is currently produced by that key, and the second key identifies where on the keyboard that same note should now be produced.

Once the second key is pressed, the DAW updates its internal transposition setting accordingly: it shifts all keys by the interval required to make the second key produce the note that the first key previously produced.

The DAW then exits transposition mode and resumes normal operation, generating or forwarding transposed MIDI notes in response to subsequent keypresses. The performer must release the trigger before re-entering transposition mode.

This embodiment enables professional music software to implement the core functionality of the invention without requiring changes to external hardware or use of middleware.

### 3.4.2 Claim-Language Description of Embodiment in DAW

In this embodiment, the e-keyboard environment comprises a software implementation embedded within a digital audio workstation (DAW) that performs the claimed transposition change.

The DAW includes an input interface configured to receive a signal from the player that triggers entry into a transposition mode in which two keypresses are muted. This trigger may originate from a GUI element, a MIDI command, a control surface action, or a designated keypress.

While in transposition mode, the DAW receives input signals from an electronic keyboard, corresponding to the pressing of a first key, followed by a second key. During this muted mode, the DAW does not forward or render MIDI messages corresponding to the keypresses used to define the transposition change.

The DAW effects a transposition change, wherein the transposition change is characterized in that the note produced by the second key after the transposition change is the note produced by the first key before the transposition change.

Following the transposition change, the DAW exits transposition mode, unmutes input, and resumes producing or transmitting transposed MIDI signals in response to subsequent keypresses.

This embodiment, implemented within a DAW software environment, is captured by claim 5.

### 3.5 Equivalents—Claviation Input Through Chord Actuators Rather than Note Actuators

While claviation is described primarily in the context of individual key inputs, the same mechanism applies equally to controls—whether physical or virtual—that trigger the production of predefined chords or note clusters, provided there is a definable musical interval between those controls. In such embodiments, the pick and drop actions are performed on these multi-note actuators rather than on individual notes. The resulting transposition logic is identical: the instrument is reconfigured so that one control region assumes the tonal identity previously held by another.

This variation, although differing in the surface form of the user interface, performs the same essential function in the same way. It would be recognized as conceptually equivalent by musicians and interface designers. Accordingly, claviation is not limited to key-by-key input but extends to any sufficiently expressive interface in which stable physical or virtual controls trigger the production of defined tonal outputs and a well-defined tonal interval exists between those outputs.

### Appendix

### Required Background for Appendix

While it is not necessary to read the entire main body of the specification before reading the Appendix, the material from Part 0 through Part 1, Section 1.2 (“Advantages and benefits of claviation”) should be reviewed first.

### Appendix, Part A: General Usability of Claviation

The primary objective of this Appendix Part A is to demonstrate the General Usability of claviation for smart-tuning.

### A. 1 The KALC Framework

The KALC Framework, devised to support this invention, is a pedagogical and conceptual framework designed to make claviation musically usable, powerful, intuitive, and easily learnable, communicable, and teachable. The acronym KALC comes from “Key Access Language for Claviation,” but is also backronymic and was chosen in part in recognition of Zoltan Kodaly, creator of the Kodály Method. Everything in this specification specifying how claviation is used musically forms part of the KALC Framework. While the framework introduces a substantial vocabulary and theoretical structure, it is not required for the technological implementation or understanding of the invention as claimed. The core enablement—introduced in Chapter 3—requires only a functional grasp of claviation as a transposition functionality of a musical keyboard, along with ordinary knowledge in the art. However, the KALC Framework is used here as an indispensable tool for demonstrating the invention's real-world usability, musical relevance and therefore its merits.

A central feature of the KALC Framework is the prefix “kal”, which serves as a compact linguistic device for coining precise terms unique to the framework. Functioning as an adjective meaning “of the KALC Framework,” it eliminates ambiguity by marking a term as carrying the specific meaning assigned to it here, rather than any competing or historical usage. This ensures clarity, consistency, and expandability. Two foundational examples—“kal signature” and “kal key change”—will be defined immediately.

Smart-tuning occurs at two fundamentally different occasions during play:

### 1. The Kal Signature—at Start of Play

A smart-tuning by claviation at start of play is called (executing) a “kal signature” and generally means smart-tuning to a known concert pitch key (e.g., F Major). It sets TS to the appropriate value for the selected key. Setting TS rather than ΔTS, it is therefore an absolute, not a relative transposition (the distinction is to be further explained shortly).
Executing a kal signature sets the TS value to match the required key, but the user does not have to memorize or enter this number. The KALC Framework provides a very usable way to do this which is intuitive, and involves using the keyboard itself like a control surface in a way which is somewhat like typing out the key name with the picking and placing keys.
A kal signature is executed once for a given piece at the start of play, and never again during the piece. Normally, the ‘start of play’ will mean at the beginning of a piece, but a player can enter in the middle of a piece and if so will execute the applicable kal signature for what the key is at that time.
To make the transposition absolute, the execution of a kal signature starts with a transpose reset (to be precisely explained shortly) then proceeds with a claviation.

### 2. The Kal Key Change—During Play

Such a smart-tuning by claviation is called (executing) a “kal key change”. this is the kind of smart-tuning applied in real time during performance of a single piece to accommodate a change of key. A piece may include any number of kal key changes—one for each change of key during the piece. The form of its execution is identical to that of a kal signature except that the transpose reset is omitted.

### (Relative and Absolute Transposition Operations)

As used in this specification:
A “relative transposition operation” is a transposition operation in which the user's interaction defines ΔTS, representing a change in transposition state relative to the current value of TS. This is the kind of transposition operation presented in the main specification body.
An “absolute transposition operation” is a transposition operation in which the user's interaction defines TS directly, such that the absolute transposition state is set by the input.

A “transpose reset” operation is defined as an action that sets TS=0.
It is noted that a relative transposition operation, when immediately preceded by a reset, functions equivalently to an absolute transposition operation.

The following table compares and contrasts the two smart-tuning types

| | | Character of | |
|---|---|---|---|
| Smart-tuning | | transpose | |
| type | Occasion | operation | Executed with |
| kal signature | Before starting to | Absolute, sets | Reset + |
| | play | TS | claviation |
| kal key change | During | Relative, sets | Claviation |
| | performance | ΔTS | only |
| | initiating key | | |
| | change | | |

For both types of smart-tuning, the KALC Framework provides:
A method to execute them (reset-claviate for kal signatures, or claviate-only for kal key changes) A vocabulary to learn, teach, name, discuss and help conceptualize them,
through what will be called ‘verbalizations’ (to be explained shortly);
A system to annotate them on the musical staff, using corresponding “kal signature marks” or “kal key change marks”, enabling a “kal score”, a musical score without key signature for use by claviating keyboard players.

To minimize the effort of learning, the KALC Framework is designed so that there is maximal carry-over of learning of kal signatures to kal key changes.

### (Reframing Appendix Part A Objectives)

In light of the above division into the two cases—kal signature and kal key change—the overarching objective of Part A, namely to demonstrate the usability of claviation, can be further specified as follows:
1. To show how smart-tuning by claviation is carried out in its two fundamental cases.
2. To demonstrate how readily the technique can be taught and learned.
3. To illustrate its natural integration with musical communication, especially through staff notation.
4. To explain the process and implications of large-scale, low-barrier conversion of existing digital music into kal scores—scores adapted for claviation with no key signatures.

### (More Groundwork on Smart-Tuning)

Smart-tuning has been formally defined in the main body. We will now recall the definition, integrating it with the terminology of ‘current’ and ‘upcoming’.

### Groundwork—Smart-Tuning Recalled

Smart-tuning refers to using the transposition functionality to perform in a given upcoming key (the target key) while playing as if in the home musical key corresponding to that upcoming key, a key with empty key signature.
Smart-tuning therefore always involves two and may involve three keys:
The current key—the key being departed from. This is not an applicable concept at the start of play, but is applicable during a key change during play.
The upcoming key—The actual key in which the player will be performing after smart-tuning is applied. This is the key they are smart-tuning to. It is the key which the listener will hear. It applies both at the start of play, and at a key change.
The home musical key which corresponds to that upcoming key—The key with an empty key signature, which the player plays as if reading from; their fingerings during play hit exactly the keys as if they were playing in the home musical key, while the music is coming out in the upcoming key, due to transposition.
Each musical mode has exactly one corresponding home musical key, therefore there is only one key in which that mode can be played on white keys alone. For example, as can be determined from basic music theory:
   The home musical key for Major mode is C Major.
   The home musical key for Minor mode is A Minor.
   The home musical key for Dorian mode is D Dorian
   etc. through four other modes
When playing in a smart-tuned manner, the player physically plays using the physical keys, key patterns, fingerings, and note relationships of the home musical key, while the transposition setting ensures that the correct pitches are produced in the upcoming key. A succinct way of saying this is that they're playing in the upcoming key but as if reading the piece in the home musical key. If a silent video were taken of them playing, an analyst who assumed no transpose would determine that it was in the home musical key.

We will now define smart-tuning in a richer way which accommodates all 7 musical modes explicitly:

### Groundwork—Home Musical Key and Home White Key of any Mode

The above principles extend to all seven modes. Each mode has two defining characteristics:
   the “home musical key of a mode”—The musical key in which the mode can be played without a key signature (i.e., using only white keys).
   the “home white key of a mode”—A specific physical key on the keyboard, colored white, where the mode can be played on white keys alone, using this white key as the tonic (starting key). (We are speaking in what will be called the “octave-folded perspective”, so ‘physical key’ here refers to a class of keys, not a specific one; for example, C3, C4, and C5 are all home white keys of Major mode.)
      Groundwork—the Seven Modes, their Home White Keys and Home Musical Keys

The table below lists each mode with its corresponding home musical key and home white key. While the musical relationships in the table are well-established in music theory, the terms home musical key and home white key are introduced here specifically for explaining claviation.

| | Mode's | | Home |
|---|---|---|---|
| Mode | Academic | Home | white key |
| (Common | Name (if | musical | (physical |
| Name) | different) | key | key class) |
| Major | Ionian | C Major | C |
| Minor | Aeolian | A Minor | A |
| Dorian | — | D Dorian | D |
| Phrygian | — | E Phrygian | E |
| Lydian | — | F Lydian | F |
| Mixo | Mixolydian | G Mixo | G |
| Locrian | — | B Locrian | B |

As a shorthand, a “mode's home” refers to the home white key of a given mode. For example, the physical D, being the home white key of Dorian, is Dorian's home.

### Groundwork—Equal Standing of Every Mode

The seven modes are treated here as having equal standing and full independence. For example, Mixo is not considered here to be “a mode of the Major scale.” It is simply Mixo; its third happens to be major, as is that of Major mode.

Every musical key has a root note (its tonic note) and a mode. The name of such a key will generally be presumed to follow the template <root note> <mode>, for example D Major fits this template with root note=D, mode=Major. Using this definition of the home white key of a mode established in the groundwork, we can now redefine smart-tuning more succinctly:

To smart-tune a keyboard to a musical key is
to transpose it such that the home white key of
the mode of the key plays the root note of the
key.
(With the result that a piece written in that
key can be performed as if in the home musical
key for the mode, with the home white key
playing the tonic.)

As the groundwork makes clear, there is nothing controversial in the above definition for smart-tuning—it arises from well-known musical theory. However, it is worth emphasizing that the terminology used in the above definition:
smart-tuning
home white key (of a mode)
home musical key (of a mode)
   are original to this document. The above definition for smart-tuning comprises a specific and concise formulation for smart-tuning, which is very well suited for use with claviation.

### A.2 Developing a Formula for Smart-Tuning by Claviation

The claviation interface is very suitable for smart-tuning. If we recall the formulation above of smart-tuning:
To smart-tune a keyboard to a musical key is to transpose it such that the home white key of the mode plays the root note of the key.

This can also be described in terms of making a chosen physical key play a chosen note—and this is what claviation does, which explains why it dovetails so well into smart-tuning: claviation causes a chosen physical key—the dropping key—to play whatever note is currently played by another key—the picking key.

Thus, the formal definition for smart-tuning can be:
To smart-tune a keyboard to an upcoming musical key by claviation can be done by selecting as picking key the key currently playing the root note of the key, and as dropping key the home white key of the mode.

This is precise, but wordy. With a more intuitive language of picking and dropping notes, we can express it more simply, and in the form of an instruction:
To smart-tune by claviation to a given key:
   Pick the root note of the upcoming key.
   Drop it onto the home white key of the mode

The above is probably easily understood as it stands, but for greater rigor we will develop this pick/drop terminology explictly:

### Groundwork—Physical Key

Physical keys will be named by the notes they normally play (that is, in zero transposition setting), and the word key can be omitted so, for example physical C means the physical key which normally plays the C note. Physical keys are identified in this specification by their native notes. For example, the phrase “physical key E4” refers to the key whose native note is E4. A shorthand for this is to leave out the word key, so “physical E4” is equivalent to physical key E4.

### Groundwork—Physical Keys

In musical English, the word key is inherently ambiguous in music—it refers both to physical keys on an instrument (e.g., “this key on the piano”) and to musical keys or tonal centers (e.g., “the key of D minor”). To avoid this ambiguity, this specification uses the term physical key to unambiguously designate the individual key mechanisms of a keyboard instrument. When referring specifically to a white key, the word white is similarly employed for disambiguation—for example, white physical key or simply white key.

### Groundwork—Notes on Keys, and Field of Notes

Throughout this specification, we adopt a helpful convention: the note played by a key is said to be ‘on’ that key. Consistent with mathematical usage of the word field, there is exactly one note on any key at a given moment, and collectively these define a field of notes across the keyboard.

### Groundwork—Native Note of a Physical Key; Native Key of a Note

At TS=0 (zero transposition setting), the note on a given key is referred to as that key's native note, and the key that plays a given note is called that note's native physical key.
The following statements illustrate and verify these conventions:
   In zero transposition setting, the note C5 is on physical C5.
   Therefore physical C5 is the native physical key of note C5.
   With TS=+1, the note D♭5 is on physical C5.
   With TS=+3, the note E^{b}5 is on physical C5.
   If the note E^{b}5 is dropped onto physical C5, the resulting TS will be +3.
   If the note E^{b}4 is dropped onto physical C5, then TS=−9.
   If the note E5 is dropped on physical G5, the result is that TS=−3.

### Groundwork—Picking a Note and Dropping a Note

“Picking a note” refers to pressing a physical key—as the picking key in a claviation act—at a moment when the desired note is present on that key. Crucially, it is the note that is regarded as picked, not the key. The note—understood as a discrete element in the pitch field—is seen as the true object of the action; the key merely serves as the picking key by virtue of holding that note at that moment.
This distinction reflects natural human intuitions and language about handling physical objects. In claviation, the performer picks a thing—a note—and drops it onto a place—a physical key. The keys are seen as locations or vessels, not the objects being picked or dropped. The picking key is simply where the desired note is accessed. Crucially, the note is not an isolated object but part of a larger structure: the pitch field. Claviation thus moves the entire pitch field by extracting a note from its position in that structure and reassigning it elsewhere—shifting the system through a pick-and-drop gesture.
Similarly, “dropping” a note on a physical key means using claviation to make that key play that note—by selecting that key as the dropping key.

### Groundwork—the Verb ‘Trigger’

The verb ‘trigger’ when used alone will be a shorthand for ‘engage the claviation trigger’.

### Groundwork—Root Notes and Tonics

The “root note” of a musical key is its tonic. For example, in the key of D Major, the root note is D. Conventional scales in a given key are played beginning on their root note.

With this special language, a very concise formula for smart-tuning by claviation to any give key can be made:

```
  “The general smart-tuning instruction”
      (for claviation)
To smart-tune by claviation to a given musical key:
    Pick the root note of the key
    Drop it onto the home white key of the mode of
    the musical key.
```

The above is called the “general smart-tuning instruction” for claviation and is both rigorous and complete. Although it does not explicitly state that the trigger must be pressed, this is not a gap: claviation can only occur when the trigger is engaged. Therefore, using the trigger is considered an intrinsic requirement of the picking action.

### A.3 How the Formula is Applied to the Two Fundamental Cases

The general smart-tuning instruction says:
Pick the root note of the key, and drop it onto the home white key of the mode.

Where to drop it is therefore clear, but how does the player locate the root note?
For a kal signature: The player is smart-tuning to a key whose name is already known in concert pitch, and therefore also knows the name of its root note. They begin with a reset, which restores every note to its native key. The root note is then picked directly from its native location on the keyboard.
For a kal key change: The player identifies the root note by choosing a physical key they already know on the keyboard—one that corresponds to the nature of the key change required. In practice, players internalize these key changes not through abstract music-theory calculation but through a practical, embodied sense of “which key to pick from to match this key change type” This intuitive mapping develops naturally through use, and its emergence is demonstrated throughout this Part A of the Appendix.

### A.3.1 Ergonomic Transpose Reset as a Key Adjunct to Claviation

As already stated, easy, efficient, and ergonomic transpose reset is an important adjunct function to claviation for smart-tuning. A recommended implementation is to allow a long press followed by release of the claviation trigger to act as a transpose reset. This implementation will be assumed available throughout this specification.

The length of time required for a long press is not specified here, but should strike a balance: it must be short enough not to interfere with preparation to play, yet long enough to avoid accidental activation. A few seconds would be too long; a value around 700 milliseconds may be appropriate.

To aid usability, the system should give clear feedback to indicate that the long press has been successfully recognized. Feedback in audio form is inappropriate in this musical context. A simple and effective solution is to have the trigger button illuminate while pressed, and turn off once the long-press threshold has been crossed. The player should release the trigger and engage again to do a claviation following the reset.

### A.4 A Brief Orientation on What is to Follow

Two subsections follow:
A.5—A walk-through of claviation in use
A.6—General usability in greater depth: teaching and application

The purpose of the walk-through subsection is to first highlight smart-tuning from the user experience perspective. It focuses on the kal signature, but also effectively illustrates the experience of the kal key change, which differs only minimally—as partially explained already and explained more in the following subsection. It also introduces verbalizations, spoken phrases that are particularly useful in learning claviation.

The General usability in greater depth subsection builds upon the walk-through, expanding especially on the process of teaching and learning. It also develops the material further by fully explaining the kal key change.

### A.5 A Walk-Through of Claviation in Use

### (Verbalizations)

A central part of the KALC Framework's pedagogical design is the use of “verbalizations”—short phrases meant to guide the player during smart-tuning. They are designed to guide in a way that supports early-stage cognitive reinforcement while also preparing for fluent, intuitive mastery. These verbalizations are first spoken aloud by the student while they smart-tune, and later internalized as mental cues. In the early stages, their functionality is to help as instructions. Later, their help is through the understanding that they give or have already given.

Recall that among smart-tunings, this walk-through focuses exclusively on kal signatures. Kal key changes on the other hand are deferred to the next section. However, the framework is designed to preserve maximal similarity and continuity between kal signatures and kal key changes: every concept, term, verbalization, muscle-memory pattern, and staff representation introduced for kal signatures carries forward with minimal but recognizable modification into kal key changes—the real-time smart-tuning actions that occur mid-performance. As a result, once fluency in kal signatures is achieved, fluency in kal key changes follows with minimal additional time or effort.

### A.5.1 Walk-Through of Smart-Tuning at Start of Play

### (Smart-Tuning to E♭ Major)

To smart-tune at the start of play is to execute a kal signature.

Applying the general smart-tuning instruction:
Pick the root note of the key (E♭).
Drop it onto the home white key of the mode (for Major, the physical C).

Recall that for a kal signature, a reset is done first, to set TS=0, in order to place the root note on its native key from where it can be picked.

The smart-tuning is then completed by the claviation triple—a coordinated three-part action:
1. Trigger (press the trigger to enter claviation transposition mode)
2. Pick E♭ (press the physical E♭)
3. Drop it onto the home white key of Major (press the physical C)

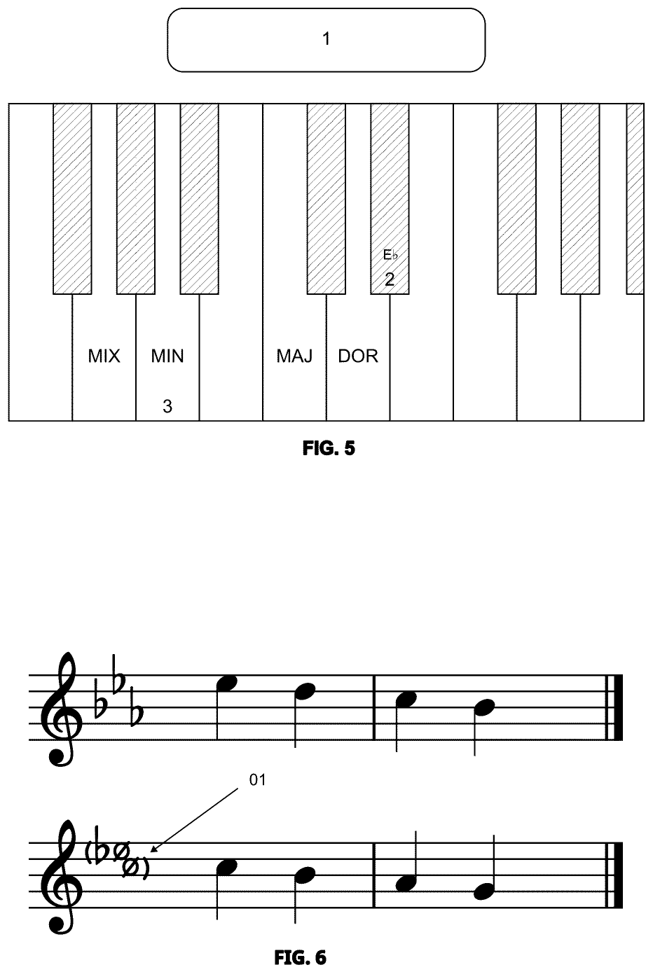

FIG. 4 illustrates this triple. The numbers correspond to the three above-numbered actions in sequence. The trigger is shown as a button for illustration (in the form of a rectangle with rounded corners), though in practice it may also be a pedal or other ergonomic control.

Where the following reference signs are used in FIG. 4 and other figures in the specification, they are have the following meaning:
MAJ—Major (mode).
MIN—Minor
DOR—Dorian
MIX—Mixo

In the diagram, four modes—likely the most commonly used in modern playing—are shown written on one of their respective home white keys. All white keys have a home mode but only to reduce visual clutter, the home modes of other white keys are omitted.

The mode labels in the diagram can be interpreted in one of two ways:
As part of the diagram purely as labels thereon for explanatory purposes; or
As representations of removable training stickers that may be placed on the keys to aid learners.

These mode labels on the keys in the diagram reflect how players are taught to conceptually see each key. Just as a player naturally regards the physical A key as having a “A” identity, also being Minor's home, it should also be recognized as having a “Minor's home” identity—and similarly for the other white keys.

### (Control Surface for Smart-Tuning)

The above example makes clear that claviation turns the keyboard itself into an intuitive control surface for smart-tuning—one that naturally supports all modes. Later, it will be shown that this same intuitiveness extends to key changes during play as well.

### (Learning the Modes' Homes)

Players becoming familiar with modes should learn the home white key of each mode. (As will be explained later, they should also learn to recognize these homes on the musical staff.)

This is not an onerous task, as the modes' homes can be learned gradually, on an as-needed basis. For many learners—often indefinitely—only Major's home (C) and Minor's home (A) are required. Those learning Rock will likely move on to Mixo's home (G), while many Jazz students will eventually learn Dorian's home (D).

(Verbalization Purpose, Design, and Role in this Specification)

For each smart-tuning action, the KALC Framework provides a set of verbalizations. These serve multiple complementary purposes:
As instructions provided by the teacher.
As self-talk cues for the student during practice.
As identifiers or “names” for the smart-tuning actions themselves.
As explanations and representations of the actions in descriptive or analytic contexts.

The design of verbalizations is pedagogical: they are engineered as learning tools that evolve into performance cues. They also have a vital communicational role, and this specification itself makes the first formal use of them—employing verbalizations as part of its explanatory language.

The Framework standardizes verbalizations so that each has a consistent meaning but can appear at different levels of verbosity. Verbose forms, emphasized in early learning, make details explicit and integrate linguistic with motor faculties, reinforcing both what to do and when to do it. As fluency develops, concise forms replace them, serving as compact cues while still engaging the brain's linguistic pathways. For improvisers especially, verbalizations guide not only execution of the motor action but also awareness of its musical significance in real time.

Because verbalizations provide a precise and economical way to describe smart-tuning variants and related operations—where ordinary prose would be lengthy and ambiguous—the language of verbalizations is required to follow this specification. The discussion that follows is therefore not merely illustrative but an integral component of the specification itself. Verbalizations are presented here by example rather than by formal templates or semantic mappings, and they are simple and regular enough that the reader can readily generalize them to any key and mode.

For the example of smart-tuning to E♭ Major, the three forms are:
with “maximal verbosity”:
   ‘Pick E♭ drop on Major's home’
A complete imperative instruction, ideal for beginners or formal explanations.
with “intermediate verbosity”:
   ‘Pick E♭ drop Major’
A shortened version omitting predictable structure.
with “minimal verbosity”:
   ‘E♭ Major’
As concise as naming a key, and textually equal to the key it names, yet still denotes a specific smart-tuning action.

All three verbalizations are regarded as semantically equivalent: they convey the same instruction to carry out the same claviation action. Each can also be treated as a name for that action, and also as a contextual instantiation of the general smart-tuning instruction. These standard verbalizations deliberately omit mention of the transpose reset and trigger-press steps, since those are common to all kal signatures and do not distinguish one smart-tuning operation from another. Punctuation is likewise omitted in the written forms as a design choice. Later, “extended verbalizations” will be introduced that explicitly include the reset and trigger steps.

(Synchronization of Verbalization with Physical Action)

One purpose of the verbalizations is to support synchronized self-talk, where speech is aligned with the keypresses. When synchronizing:
The player speaks ‘E♭’ (not “Pick”) in synchrony with pressing the E♭ key.
The word ‘Major’ is spoken in synchrony with pressing the C key (C being Major's home).

To reinforce this effect, the words ‘E♭’ and ‘Major’ were shown in bold within the verbalizations above, indicating synchronization with a keypress. This alignment between the spoken cue and the physical action creates verbal-physical synchrony, which strengthens internalization and what is essentially the learning of a language. The practice provides multiple layers of reinforcement—visual, auditory, and kinesthetic—each contributing to more effective learning.

### (Fluency Progression—Towards Minimal Forms)

As players advance, under the guidance of the teacher, they will typically transition from maximal→intermediate→minimal forms. Eventually, the smart-tuning process becomes automatic, and the minimal form suffices. When performing publicly of course, they would not verbalize aloud.

### (Smart-Tuning to E♭ Minor)

This one more example, to a different mode to Major, will be shown for completeness and comparison. It is easy to extend to any key with any root note and mode. As before, the player begins with a transpose reset.

Please see FIG. 5, and compare with FIG. 4. The smart-tuning is again completed by the claviation triple—which differs only in the dropping key which is now Minor's home:
1. Trigger claviation mode
2. Pick E♭ (press the physical E♭)
3. Drop it onto the home white key of Minor (press the physical A)

The verbalizations are exactly as before, except with Minor replacing Major and again with bold indicating synchronization with a keypress:
‘Pick E♭ drop on Minor's home’
‘Pick E♭ drop Minor’
‘E♭ Minor’

Under the KALC Framework, the keyboard itself is converted into a highly-usable control surface for intuitive smart-tuning.

Bold type being used up to now to illustrate synchronization with keypresses, it will no longer be continued, but synchronization should be understood.

(Verbalizations with Octave-Distinction)

Recall that verbalizations can and will be used to refer to smart-tuning actions and that they are also effectively the names of smart-tunings.

The verbalizations shown so far have been “octave-folded”—they do not specify which octave the pick and drop actions occur in. For example:
‘Pick E♭ drop on Major's home [C]’

This instruction does not indicate which E♭ or which C to use. In many cases, however, it is useful to be precise about octave locations. Verbalizations which support that precision are called “octave-distinguished” verbalizations.

A draft form—not the actual recommended form—of an octave-distinguished verbalization for the above smart-tuning might be obtained just by making the octave numbers of the picking and the placing explicit:
‘Pick E♭5 drop on Major's home 5 [C5]’

Although the diagram above does not specify which octave of the keyboard is shown, if the picking key shown is interpreted as E♭5, then this verbalization would correspond to the claviation illustrated. The octave-distinguished verbalization provides a precise, unambiguous directive for executing the smart-tuning on the physical keyboard. If the verbalization included ‘drop on Major's home 6 (C6)’ instead, it would also smart-tune to E♭ Major, though the keyboard would ‘play an octave lower’—and playing would have to be moved an octave higher to compensate.

However, the KALC Framework does not favor the particular draft octave-distinguished form for the verbalization that was just shown. Instead, the preferred language of the verbalization does specify the octave number of the picked note but uses a directional term—up or down—relative to the picking key, to indicate the relative position of the dropping key.

In this convention:
“up” means the dropping key lies to the right (i.e., higher in pitch—corresponding to a higher position on the staff) of the picking key;
“down” means the dropping key lies to the left (i.e., lower in pitch—corresponding to a lower position on the staff).

The directional term is inserted immediately after the named note (which includes an octave number), and—if the word drop is present—immediately precedes it, forming phrases such as ‘Pick E♭5 up drop on Major's home’.

Note that the KALC framework has placed ‘up’ before ‘drop’, and this is intentional for reasons which will be made clear. The favored form here is not quite grammatical on its surface in English. The verbalizations are an instruction in their own language, whose grammar has been crafted for optimality, while still clearly easy to learn and understand for those fluent in the spoken natural language on which they are based.

This convention eliminates the need to explicitly name the octave of the dropping key. Accordingly, the preferred KALC verbalization of the same instruction is:
‘Pick E♭5 down drop on Major's home’

This indicates that E♭5 is picked, and the drop occurs on a C that lies lower (physically leftward) on the keyboard, which is C5. Notably, this same smart-tuning result—TS=+3—could be achieved with:
‘Pick E♭4 down drop on Major's home’

Octave-folded verbalizations like “E♭ Major” are musically definite—they specify unambiguously which the instrument is being smart-tuned to. The underlying instruction from the general smart-tuning instruction is likewise musically definite.

However, these forms are not practically definite with respect to the physical keyboard. They do not specify:
Where the smart-tuning action is performed on the keyboard, nor.
Whether the resulting transposition setting will make the keyboard play either ‘an octave higher or lower’ and place the piece higher or lower on the instrument.

To actually execute the smart-tuning to a specified key on a keyboard, two practical decisions must be made, called the “decisions of octave”:
1. “First decision of octave”: Which octave contains the picked note.
2. “Second decision of octave”: In which direction—down (leftward) or up (rightward) —the note is dropped onto the target key.

Of the two, the second decision of octave is more consequential, as it directly determines the transposition setting (TS) and shifts the entire playing range on the keyboard. The numbering is based not on importance but on the order in which they are needed in the action. The first decision of octave affects only where the claviation is performed on the keyboard; it does not influence the TS.

When executing a kal signature:
A downward drop direction produces a positive ΔTS, shifting the required fingering for the same subsequent performance an octave lower on the keyboard and staff than the upward drop does;
An upward drop direction produces a negative ΔTS, and shifts the same subsequent performance an octave higher on the keyboard than the downward drop does.

In both cases, the value of ΔTS is equivalent modulo 12, and the resulting music is the same in pitch and is performed as if in the home musical key.

For example:
‘Pick E♭5 down drop on Major's home’
   ΔTS=+3
   The music is played in a lower physical range.

Relative to this if we change only the first decision and instead pick E♭4 while keeping the drop direction down, we get:
‘Pick E♭4 down drop on Major's home’
   ΔTS=+3
   The music is still played in the same physical range as the last (Pick E♭5) case.

But if we change the drop direction instead—keeping E♭4 but dropping up—we get:
‘Pick E♭4 up drop on Major's home’
   ΔTS=−9
   The music must now be played an octave higher on the keyboard for the same sound.

In all of the above examples, the smart-tuning is to E♭ Major. The resulting performance is identical in sound, but the transpose state differs by an octave, and the physical range of the keyboard used to produce the music shifts accordingly.

In summary:
An octave-folded representation of a smart-tuning determines ΔTS only up to modulo 12.
An octave-distinguished representation of a smart-tuning determines ΔTS as a full integer, with the drop direction governing the outcome. The drop direction, in turn, sets the physical octave of the keyboard on which the music will be played. The picking octave only affects where on the keyboard the claviation is done.

### (Decisions of Octave are Easily Classified)

One might wonder why the phrasing “down drop” was chosen in the language design instead of “drop down.” The selected order allows octave decisions to be compactly classified and named, while that classification is conveniently embedded as a unit in the verbalization. Each two-part decision of octave is called an “octave realization” and is labeled by combining the octave number with the drop direction—such as 5-down, 5-up, 4-down, 4-up, and so on.

This structure ensures that the octave realization always fits naturally into the verbalization, appearing immediately after the note and making the smart-tuning action easy to interpret at a glance. For example if we begin with the octave-folded verbalization:
‘Pick E♭ drop on Major's home’
   and insert the octave realization “5-down,” we get the octave-distinguished version:
‘Pick E♭5 down drop on Major's home.’

The same formula applies at all levels of verbosity: insert the octave realization directly after the note name in any octave-folded verbalization to produce an octave-distinguished form.

### (‘Table of Six’ Verbalizations)

An octave-distinguished verbalization fully specifies the smart-tuning action, including exactly where on the keyboard it occurs. It defined the value of ΔTS as an integer, not just as an integer modulo 12.

From any octave-distinguished verbalization, a corresponding set of six variants—referred to here as a “table of six”—can be constructed: Three totally equivalent verbalizations, at three different levels of verbosity, that have the same octave-realization and therefore retain the performer's octave decisions (octave-distinguished), and

Three more that omit the information of the octave-realization, therefore being octave-folded, describing the musical result without specifying how it was achieved on the keyboard.

For example:

| | Verbalizations | |
|---|---|---|
| | (octave-distinguished) | |
| | Octave-realization: | Verbalizations |
| Verbosity | “5-down” | (octave-folded) |
| Maximal | ‘Pick E [symbol] 5 down drop on | ‘Pick E [symbol] drop on Major's |
| | Major's home’ | home’ |
| Intermediate | ‘Pick E [symbol] 5 down drop | ‘Pick E [symbol] drop Major’ |
| | Major’ | |
| Minimal | ‘E [symbol] 5 down Major’ | ‘E [symbol] Major’ |

It is now clear how to derive all verbalizations of a given smart-tuning, and therefore all equivalent smart-tunings—including those corresponding to different octave realizations—by systematically varying the octave-realization within the octave-distinguished form. This process yields a complete set of equivalent verbalizations describing the same musical outcome.

By then allowing the octave realization to vary freely, one can generate the full set of possible smart-tunings to the desired key, across all playable locations and with all valid octave placements. In this way, the KALC Framework provides a deterministic method for enumerating every equivalent expression of a smart-tuning.

### A.5.2 Walk-Through of the Kal Score

(Seamless Integration into Standard Notation—a Major Merit of the Invention)

A major merit of the invention—and a major contributor to its usability, rapid adoption and commercial value—is how seamlessly claviation integrates with standard musical notation through an extension introduced by the KALC Framework, producing what is called the kal staff, which eliminates key signatures while still defining the played music completely. Recall that a kal staff combined with musical content forms what is called a kal score. The usability impact is immediate: a player already fluent in sight-reading can begin reading kal scores within minutes and achieve practical fluency with only modest additional practice.

The reason for this seamless fit is that each kal signature is defined solely by a picking key and a dropping key—a pair of physical keys on the keyboard. But on a musical staff, notes already imply physical keys on a keyboard. Thus, existing notation can be used, with minimal augmentation, to specify claviation actions unambiguously.

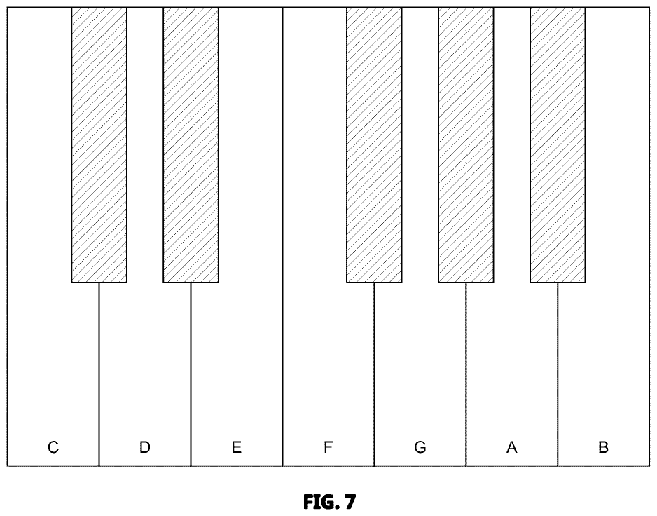

To demonstrate how this notation functions in practice, we now introduce the
“First Model Piece”—shown in FIG. 6,
   which is one of two deliberately simplified examples created to illustrate the kal staff.

The following legend applies to FIG. 6:
01—kal signature

These model pieces are technically playable but not intended as viable music. They are minimized in both length and complexity to focus entirely on showing the structure and behavior of kal scores within the KALC Framework within a single diagram. This particular piece is in E♭ Major. It is presented in FIG. 6, first using a conventional staff, and then using a kal staff directly underneath it, with corresponding notes aligned vertically.

Observe that on the kal score, the traditional key signature for E♭ Major is absent. It is replaced by a kal signature, which specifies exactly what the performer must do to smart-tune the instrument by claviation to E♭ Major—allowing performance in the home musical key of C Major. As is common in music, the same term, kal signature, refers both to the musical entity and to the staff symbol that represents it: just as “rest” and “note” name both a concept and its mark on the staff, “kal signature” refers both to the musical event and to the notated sign.

On the staff, the kal signature represents an octave-distinguished smart-tuning instruction. Unlike a conventional key signature, it is not merely informational but is meant to be executed: a one-time physical action performed on the instrument just before playing the piece. The illustrated pick-drop pair generates a transposition setting (TS) of +3 semitones, the shift required to change C5 to E♭5. To compensate, the musical content on the kal score is transposed downward by 3 semitones relative to the traditional staff, thereby preserving concert pitch output even though the instrument itself has been transposed by the smart-tuning encoded in the kal signature. In this example, the instruction is “Pick E♭5 down drop Major.”

Although it is played only once when starting to play the piece, the kal signature is repeated visually in the score wherever a conventional key signature would normally recur—typically at the start of each staff line. This ensures that a performer can begin at any point in the score—even pages from the beginning—and immediately execute the correct smart-tuning to start playing in the written key.

### (The ø Symbol in Kal Staff Notation)

As shown in the kal score diagram for the First Model Piece, the KALC Framework uses the ø symbol—here called the “slashed o”—to form “claviation marks” on the score to indicate what we define as “claviation keypresses”. The symbol was chosen for its balance of subtlety and visibility: it is distinct from standard musical symbols on the staff, unobtrusive yet clear in context, easy to write by hand, and widely available in character sets.

A single symbol is used for both actions, but their roles are named and distinguished as follows:
The ø placed first in the pair is what is called the “picking mark”, indicating the picking key.
The ø placed second (to the right) is the “dropping mark”, indicating the dropping key.

Thus, a picking mark and a dropping mark are the two role-specific instances of the same ø symbol; their roles are determined solely by horizontal order within the pair, mirroring left-to-right reading and the temporal sequence of the claviation action.

In the example above, a ø symbol placed on the staff at the space for E5, modified with a flat symbol to its left, indicates the picking key E♭5. A second ø placed just to the right on C5 indicates the dropping key—Major's home 5. Together, this pick-drop pair visually represents:
‘Pick E♭5 down drop on Major's home’

On the staff the pick-drop pair are enclosed in parentheses, the opening parenthesis vertically aligned with the picking symbol and the closing one with the dropping symbol. The parentheses identify the mark as a kal signature. Later, kal key changes will be introduced, which are different in appearance only in that the parentheses are omitted, and are different in execution only in that the reset is omitted.

An analysis will show that this smart-tuning yields TS=+3.

### (A Transposing Staff)

The kal staff is a transposing staff. Under the KALC Framework, which defines the kal staff, the claviating keyboard is treated as a transposing instrument. In keeping with centuries of tradition surrounding transposing instruments and their staves, each physical key on the instrument is mapped to a fixed position on the staff for the performer's convenience. Likewise, the instrument uses a local naming system for notes, in which the name assigned to each physical key remains stable across transpositions.

However, the KALC Framework introduces a modern refinement not found in historical transposing instruments: the performer's local note names may optionally be prefixed with the prefix “kal”. This makes explicit the distinction between (i) the performer's instrument-local naming system, stable on both keyboard keys and staff positions, and (ii) global concert pitch naming. The complementary prefix “con” is available to indicate concert pitch explicitly.

These dual disambiguators—kal and con—serve to clarify the relationship between local and global pitch references. They function somewhat like indicators of coordinates in local and global coordinate systems, enhancing clarity of communication.

As with other transposing instruments, the staff includes an annotation to indicate the transposition setting (TS) applicable to the score. Traditionally, this is done by naming the instrument along with a note—e.g., “E♭ Clarinet” or “Trumpet in D.” On the claviating keyboard, however, this function is fulfilled by the kal signature itself, which in a different way unambiguously indicates the applicable transposition setting.

(Conventional Keyboard with Standard Note Labels)

FIG. 7 shows a standard keyboard layout with conventional note names labeled on the keys. The white keys correspond to the notes of the C major scale, and the black keys fill in the chromatic semitones.

(Claviating Keyboard with Kal Note Labels)

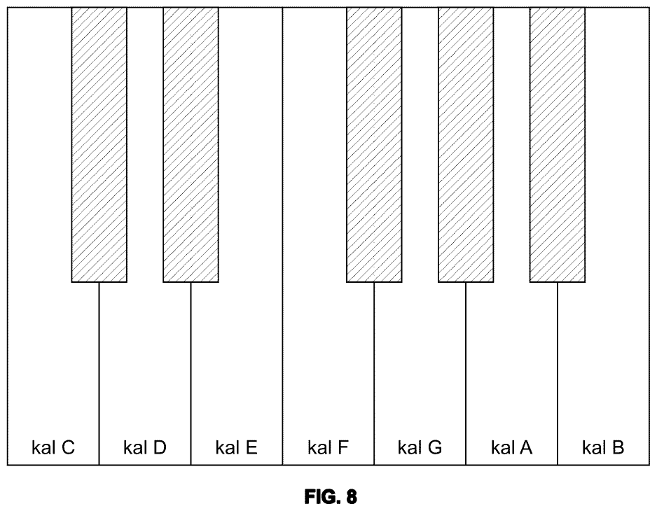

FIG. 8 shows an octave of a claviating keyboard, with each key labeled by its kal note name.

The transposition setting TS is not specified, so we cannot tell what concert notes these keys play. We cannot see the mode from the diagram, but we know from knowledge of the modes' homes that:
If the current mode is Major, kal C is the tonic note.
If the mode is Minor, kal A is the tonic note.
If the mode is Dorian, kal D is the tonic note.
etc.

For the case described above when the instrument is smart-tuned to E♭ Major, since E♭ lies on Major's home (i.e., physical C, which plays kal C), we have:

$$kal C = E , kal D = F etc .$$

The above diagram showed one unspecified octave. If the octave were number 4, then this number can be added explicitly, so for example kal C4.

### (Specifying Concert Pitch Using ‘Con’)

For disambiguation in the other direction, the KALC Framework provides the prefix con to explicitly indicate that a note name refers to standard concert pitch.

Using this convention, the above equivalence can be written more explicitly—but still equivalently—as:

$$kal C = con E$$

This indicates that, in the current smart-tuning (E♭ Major), the kal note C corresponds to E♭ in concert pitch.

### (‘Kal Name’ and ‘Con Name’)

A “kal name” is the name of a note in the kal note system, as determined by the current smart-tuning. It is therefore the name of the physical key which currently plays it on the claviating keyboard.

A “con name” is the name of the same note in standard concert pitch notation.

For example, in E♭ Major smart-tuning:
The kal name of con E♭ is kal C.
The con name of kal C is con E♭.

### (in Zero-Transpose State)

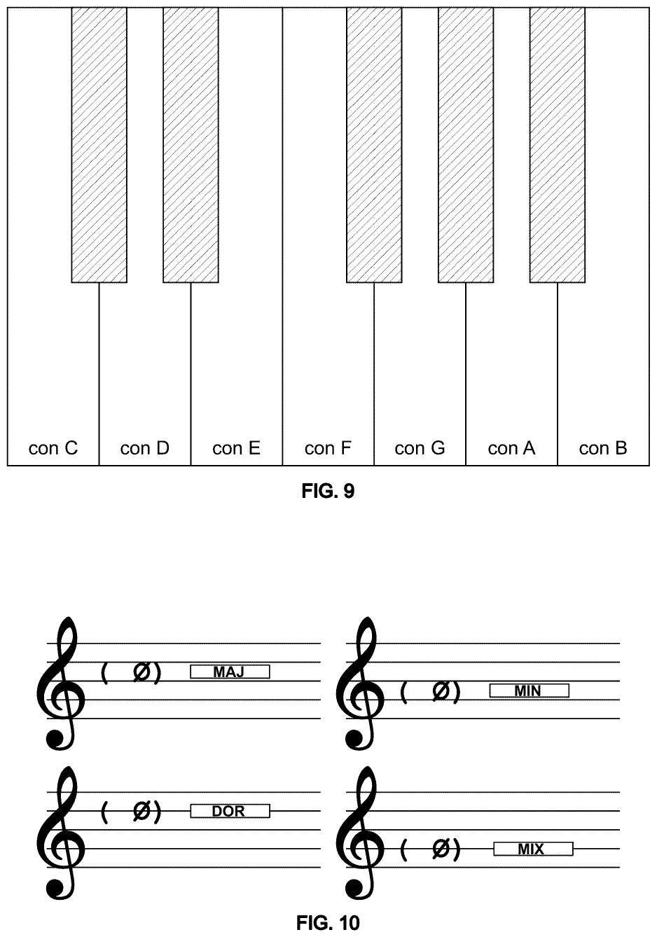

For completeness, FIG. 9 shows a claviating keyboard in the zero-transpose state—for example, immediately after a reset. In this state, each physical key plays its corresponding concert pitch. For instance, the physical C produces concert pitch C, denoted as con C.

Thus, in this configuration:

$$kal C = con C$$

(‘Kal Perspective’ Changes when Key Signature Changes)

Historically, transposing instrument players used a naming system offset from concert pitch. The claviating keyboard introduces an equivalent system, and it is given a name called the “kal perspective”.

For example, when smart-tuned to E♭ Major, kal C=con E♭. After a reset, kal C=con C. Thus, the kal perspective is defined by TS, shifts with each smart-tuning—and changes again if the key changes mid-piece.

There is centuries-old precedent for this kind of shift of perspective even during play of a single piece: for instruments like the French horn, which historically sometimes changed transposition settings mid-piece, the composer would indicate the change by modifying the instrument label—e.g., from Horn in F to Horn in D—with the latter being written very prominently on the staff to get the players attention. As with the claviating keyboard, the player's names for each note would shift mid-piece to a different concert pitch counterpart, but the mapping from instrument-local note names to physical keys and staff positions would remain constant.

Whenever there is a change in kal perspective:
The kal name of each note in concert pitch changes
The con name of each kal note changes.
   (Default for ‘Kal’ or ‘Con’ is not Prescribed, with Exceptions)

In the context of a performer using the claviating keyboard, if a note or chord name is given without either the kal or con prefix, should it be interpreted in the kal or con perspective?

The KALC Framework is carefully non-prescriptive on this question. It leaves the default interpretation to the discretion of educators and musicians, recognizing that either default may be preferred in different settings. With minimal exceptions, the framework simply provides kal and con as useful disambiguators and makes no assumption in the absence of either.

There are, however, three important defined exceptions:
Distribution of modifiers in lists, list-like structures and diagrams
Implicit ka/perspective in kal scores
In verbalizations of kal key changes

### (Distribution of Modifiers in Lists, List-Like Structures and Diagrams)

In lists of notes or chords, the modifier kal or con need only appear once, on the first element of the list. It is implicitly carried forward as the default for the remainder of that list.
Example: the chord kal C is defined as consisting of kal C, kal E, kal G.
For readability, this may also be written as kal C, E, G.

The more compact form is generally preferable. For readers accustomed to chord notation, a list such as C, E, G is immediately recognizable, whereas a repeated prefix such as kal C, kal E, kal G tends to obscure the chord structure.

In diagrams, the same principle applies. If kal or con is written prominently (for example, centered within a diagram, as happens later in this specification), it applies by default to all symbols within the diagram unless otherwise specified. This keeps diagrams visually clear and avoids clutter.

These defaults are permissive rather than mandatory. The modifier may still be repeated explicitly wherever clarity requires it. In earlier diagrams of this specification, the rule was not applied for stylistic reasons, but it is applied in certain later diagrams. The author retains discretion: whether to repeat the modifier depends on whether repetition enhances clarity or introduces clutter.

### (Implicit Kal Perspective in Kal Scores)

Within a kal score, (which can be recognized by the presence of a kal signature) any unprefixed note or chord name in a part is assumed to be in the kal perspective defined by the applicable kal signature. If it is desired to represent a concert-pitch note or chord in such a score, the prefix con is required.

### (in Verbalizations of Kal Key Changes)

This rule reflects a crucial design decision of the KALC Framework:
In the verbalization of a kal key change, the note being picked must be expressed explicitly—and therefore unambiguously—as a kal note.

This requirement ensures that the verbalization is recognized as a kal key change rather than a kal signature, and is therefore executed accordingly. The underlying design principle is that:
All verbalizations are contextual instantiations of the general smart-tuning instruction
   and this rule ensures that the principle can be efficiently maintained. Since verbalizations form the basis for naming, the same requirement applies to the formal names of kal key changes. The result is that the name of a kal key change remains unambiguously distinct from that of a kal signature, yet both remain specific variants of the general smart-tuning instruction. In pedagogical terms, this explicit reference to the root note of the upcoming key in the general formula gives students—especially those at a more advanced musical level—a direct reinforcement of tonal structure. In this way, the design rule not only preserves terminological clarity but also teaches music theory in use.

It is important to note that the standard is “unambiguously a kal note,” not “must contain the prefix kal.” As will be discussed later, in the ABC Regions solfège syllables are, in the KALC Framework, regarded as explicitly kal notes, even though they do not carry the kal prefix, making, for example, la Major a kal key change in those regions and equivalent to kal A Major. By contrast, in the Do-Re-Mi Regions a different treatment is required, to avoid confusion.

For kal signatures, the use of con is optional—it may be added for emphasis but is not necessary for clarity, because the fact that the note's name it is not explicitly kal makes it definitely a kal signature.

For example, the following two verbalizations are equivalent and both clearly indicate that a kal signature was executed:
‘He executed a B Major.’
‘He executed a con B Major.’

In contrast, the following unambiguously, explicitly, refer to a kal note and therefore to a kal key change:
‘He executed a kal B Major.’

### (Kal Chords)

Kal note names have now been defined. The mechanism to define the kal notes can be extended to create kal chord names. In the KALC Framework, a “kal chord” name is derived directly from the name of a chord given in concert pitch. The rule is simple:
Any valid chord symbol in concert pitch can be prefixed with ‘kal’ to form its kal counterpart.
The expansion of a kal chord into individual notes mirrors the expansion of the concert pitch chord, with ‘kal’ being applied to each note in the list. This makes the system work with any notation system for chords and compatible with any standard chord symbol set.

For example, the ‘Δ’ symbol and ‘Maj7’ are equivalent notations used in different systems to represent major seventh chords:
Since CΔ=CMaj7=C, E, G, B
   kal CA=kal CMaj7=kal C, E, G, B
Similarly, since F7=F, A, C, E♭
   kal F7=kal F, A, C, E♭

With this definition, kal chords therefore preserve the same shape on the claviating keyboard as their con counterparts do on the untransposed (zero-transpose) keyboard. They also appear in the same position and shape on the kal staff staff as their con counterparts do on the untransposed staff.

As will be shown later, kal chords function as a kind of abstract chord, in the same spirit as Roman numeral chord functions, but grounded in the player's current kal perspective, rather than in relation to a tonic.

### (Recognizing Home Positions of Modes on the Staff)

An earlier diagram showed mode names written on physical keys to teach students how to conceptualize white keys as the homes of modes. Similarly, students should also learn to conceptualize specific lines and spaces on the musical staff as the home positions of modes.

The kal signature for a piece conveys two key elements: the picked note and the dropped-on key, which establishes the mode. The latter—the vertical placement of the drop mark—visually identifies the mode by aligning the claviation symbol with the mode's home position on the staff.

FIG. 10 contains four subdiagrams, each corresponding to a mode. In each subdiagram:
A rectangle containing the reference sign of the mode name is used as a label on the diagram only (it should not be confused as part of the appearance of the staff itself). It covers the line or space representing that mode's home, indicating for which mode the form of a kal signature is being illustrated.
The dropping mark of a kal signature, “Ø)”, is placed on the staff at the mode's home, with the associated mode labeled to the right. This demonstrates how players can infer the mode from the drop position alone.
The opening parenthesis of a kal signature is shown with a blank to its right where the picking mark would normally appear. This creates a wildcard diagram: it can be read as representing any kal signature in the given mode, since the pick is left unspecified. At the same time, it is also the KALC Framework's formal “rootless kal signature”, written as “(Ø)”. In this form, the opening parenthesis with a blank space stands for an unspecified or wildcard picking key—signaling that the picking key is unknown or that any pick is acceptable. The parenthesis is aligned vertically with the drop mark purely for visual tidiness.

A rootless kal signature is useful in instructional contexts where the focus is on the mode rather than on a specific key. A “rootless kal score” is a kal score in which all kal signatures are rootless. Kal scores are either entirely rootless or not rootless; there is no mixing of rootless and non-rootless kal signatures within a single score.

### (An Advantage for the Player: Mode is Explicit)

Kal signatures have a clear advantage over traditional key signatures: the mode is made explicit by the dropping mark, placed on the staff position of the mode's home. This keeps the player continuously aware of which mode is in play and where the scale begins, both on the staff and on the keyboard. The dropping key always identifies the starting point of the scale.

Kal signatures are required in kal scores even when the key signature is empty, ensuring that the mode is always unambiguously visible in those cases as well.

### (Drop Direction for Home Musical Keys is Neither Up Nor Down)

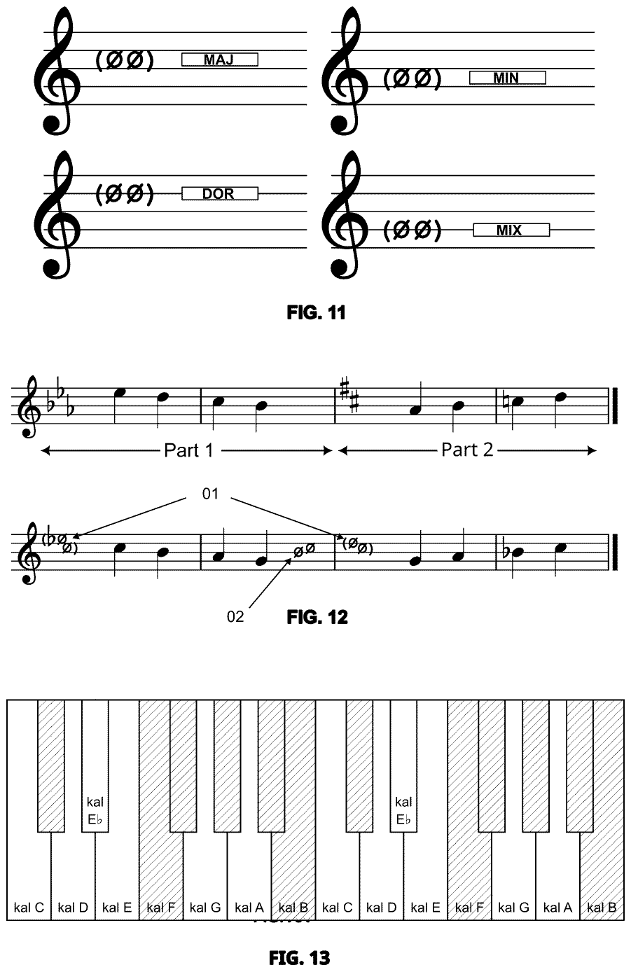

The kal signature for home musical keys—the keys with empty key signature, there being one for each mode—the picking key and dropping keys are the same, making them easy to recognize on the staff, as shown in FIG. 11.

For the octave-distinguished verbalization of a kal signature corresponding to one of the seven home musical keys, the drop direction is neither up nor down. A special rule applies: the word ‘stay’ is used instead. For example, the verbalizations for the kal signature of D Dorian—at the staff position shown in the diagram—would be:
‘Pick D5 stay drop on Dorian's home’
‘Pick D5 stay drop Dorian’
‘D5 stay Dorian’

This implies that octave realizations can take values not introduced earlier, such as 5-stay, in addition to 5-up and 5-down.

### (Automatable Score Conversion—a Commercially Significant Merit)

As will be discussed in more detail later, existing digital scores can be converted into kal scores with straightforward automation. Given the millions of users worldwide who already possess music in digital form, this makes it possible to release an enormous volume of repertoire in kal scores rapidly and at scale. Moreover, as will also be shown, the technological and distributive barriers to such conversion are extremely low. This ease of adapting already-available music represents a commercially significant advantage of claviation.

### A.6 General Usability in Greater Depth: Teaching and Application

The previous subsection served as a preview—a walkthrough designed to illustrate the player interface for claviation. It demonstrated how easily a performer can smart-tune to any key in any mode using the prescribed method provided by the KALC Framework, and introduced the concept of the kal score. The emphasis was on a clear, unobstructed presentation of the end-user experience—not on formal rigor.

This section now builds upon the material of that preview. It has three key goals:

### Goal 1: Teaching and Learning.

To outline how claviation can be taught effectively and learned intuitively, offering a pedagogical toolkit that includes core techniques such as verbalizations. Teachers may emphasize different parts of this toolkit based on their specific goals for each student.

### Goal 2: Real-Time Use—Kal Key Changes.

To introduce and explain kal key changes, the mechanism by which smart-tuning adjustments can be made mid-performance, and to show how the player's fluency in kal signatures transfers naturally to this real-time usage.

### Goal 3: Score Automation.

To describe how kal signatures can be automatically generated from conventional digital scores, enabling rapid adoption of the system and making large volumes of existing music playable with claviation.

### (Noting the Scale)

The KALC Framework encourages foundational habits that support long-term musical understanding. One such habit is “noting the scale”, considered an integral final step of smart-tuning—always following the claviation triple.

In its mature form, this step is mental: the player recognizes that the new scale now begins on the dropping key (e.g., C for Major), making a note of where that scale lies on the keyboard. This step has no effect on the instrument; it is a best practice on the performer's side, meant to reinforce musical awareness, not to trigger a system response.

There are three forms of noting the scale:
“Unaugmented”—purely mental (the mature, performance form)
“Augmented with running the scale”—playing one octave from the dropping key, which obviously cannot be done while performing
“Augmented with dummy-running the scale”—tracing the keys physically without sounding them.

Further, as will be explained later, noting the scale may be further augmented with singing kal notes or, alternatively, singing scale degrees.

A good learning sequence is to begin on the learning journey with augmenting the noting the scale step with running the scale always during practice: after each claviation triple during practice, the student plays one octave upward from the dropping key, optionally descending as well. This reinforces the new scale position, especially when mode changes, making the new mode, its scale notes and their position on the keyboard clear to the player.

For example, in pure diatonic scales (which are keys in unmodified form), such as Major or natural Minor, running the scale from the dropping key will involve just the white notes. For scales which are not purely diatonic, like harmonic minor, black notes may be included (e.g., A to A with G # as the raised 7th). In the KALC Framework, in naming a modified scale, in the name of a scale it is preferred to place the name of the modification after the name of the key, so ‘A Minor harmonic’ is preferred to ‘A harmonic Minor’. This former form better accommodates verbalizations and makes understanding easier.

Once this action is internalized, students may transition to dummy-running—during practice, after each claviation, sliding the thumb (or a finger) across the relevant white keys for one octave without pressing them. This delivers the same physical-cognitive reinforcement but avoids interrupting flow.

In live performance, players will generally omit even the dummy-running gesture, but the noting the scale step continues mentally—and automatically. A refreshed internal sense of scale location—which reinforces sense of the mode also—is useful for all players, but essential for adaptive performers who change key and often do it into a different mode, With the result that the scale begins on a different part of the keyboard.

### (Verbalization Extension for Early Learning)

Standard verbalizations are designed to highlight what distinguishes one smart-tuning action from another. As such, they omit the recurring operations—resetting, triggering, and noting the scale—which are common to every kal signature and are typically internalized through repetition.

However, in early instruction, there is pedagogical value in verbalizing these operations also as synchronized self-talk. For this purpose, the “verbalization extension” is introduced. It wraps around any standard verbalization using the following template form:
‘Reset, trigger— . . . —note the scale’

The placeholder “— . . . —” is replaced with either:
Any standard verbalization, of any verbosity level (e.g. ‘Pick D drop Minor’), or
A shell verbalization (to be explained immediately).

The KALC Framework provides as a tool a simplified “shell verbalization”, defined dimply as “pick drop”—a mechanical placeholder verbalization used to accompany the claviation action without naming the musical result. When being synchronized, the word ‘pick’ is synchronized with pressing the picking key, and similarly for the word ‘drop’. The shell verbalization is used with an extension, so that it highlights the reset, trigger and noting the scale steps only, not the musical key or key change.

Adding an extension to a standard verbalization or the shell verbalization yields an “extended verbalization”—a complete phrase encompassing both the musical content and its surrounding operational steps.

Examples for an extended verbalization for a smart-tuning to D Minor (octave-folded form):

| Verbalization | |
|---|---|
| Type | Example |
| Maximal | ‘Reset, trigger, pick D drop on Minor's home, |
| | note the scale’ |
| Intermediate | ‘Reset, trigger, pick D drop Minor, note the scale’ |
| Minimal | ‘Reset, trigger, D Minor, note the scale’ |
| Shell | ‘Reset, trigger, pick drop, note the scale’ |

Action Mapping (for the learner's coordination):
Reset→do a transpose reset
Trigger→press the claviation trigger
Pick drop→press picking and dropping keys
Note the scale→mentally confirm scale position, or reinforce it by running or dummy-running the scale

As students gain fluency, the verbalization extension is phased out, leaving only the smart-tuning phrase itself, which in turn will typically be phased out also but may remain as an internal utterance. This keeps attention focused on what varies and helps encode a vocabulary for describing tunings.

### (Pedagogically Configuring a Smart-Tuning)

The teacher can configure any given smart-tuning action pedagogically—whether and to what extent verbalized and augmented—in a way that can be described using a structured approach: that is, they will decide which of the tools of the KALC Framework are brought into play when the student does a particular smart-tuning action. Such a configuration can be conceived as being done by four sets of radio buttons, the sets represented with number and title below, and the radio buttons represented as bullet points, with only one option active in each set of bullet points at a time. Options higher in each list of bullet points typically lay the foundation for those below and the options are often introduced in top-to-bottom order as the student becomes ready.

### 1. Noting the Scale.

Augmented with running the scale
   Further suboption: Augment with singing?
      Singing as kal notes
      Singing as scale degrees
      No singing.
Augmented with dummy-running the scale
Mental only

### 2. Octave Distinction in Verbalization

Octave-distinguished (full)
Octave-folded (no distinction)

### 3. Verbalization Level

Maximal
Intermediate
Minimal
Shell

### 4. Add Verbalization Extension

Yes
No

Observe that the option of singing the scale has been added above, and will be explained in more detail later, in Part B.

With these tools provided by the KALC Framework, the teacher can tailor the learning experience to match the student's developmental stage—beginning with more guided, explicit forms and gradually removing scaffolding.

The goal is to foster fluent internalization of claviation, allowing students to progress from verbal and physical aids toward intuitive mastery, while at all times being able to express what they are doing, comprehend it, and communicate it.

To reinforce a point, refresh a student's memory, or reintroduce a new element, a teacher may at any time bring back—temporarily—an earlier form of verbalization that had been set aside. This follows a familiar pedagogical pattern: the metaphorical “training wheels” are removed once no longer needed, but can be restored when helpful. For example, the verbalization extension is normally left behind, yet may be temporarily reinstated when first introducing kal key changes.

Students would not generally need to how to structure verbalizations and the terminology for structuring them, rather the teacher would typically configure them for the student by example only.

### (Verbalizations as Names for Smart-Tunings)

Since these verbalizations also serve as names, they are naturally used as substantives, as in the following examples for kal signatures (at three levels of verbosity):
She executed a ‘Pick E♭ drop on Major's home’
She executed a ‘Pick E♭ drop Major’
She executed an ‘E♭ Major.’

Here, the absence of the word kal before the note E♭ indicates that it is not explicitly a kal note, which signals that these are kal signatures, and indicates that a reset is required before the trigger.

### (The Two “Octave Perspectives”)

The concepts of octave distinction and octave folding, first introduced in the context of smart-tunings, are now generalized and formalized with added rigor.

### Groundwork

### Groundwork—Octave-Folded Versus Octave-Distinguished

For centuries, Western musical language has carried an inherent ambiguity, as certain terms can be understood from two distinct but typically unnamed perspectives: the octave-folded perspective and the octave-distinguished perspective. These perspectives determine whether musical elements differing only in octave are treated as equivalent or distinct.
Octave-folding groups elements that differ only in octave into equivalence classes, meaning the “octave-folded perspective” considers them identical. It can also be described as an octave-blind perspective. In contrast, the “octave-distinguished perspective” distinguishes elements by their octave, treating them as separate.
As a pair, these two perspectives are referred to as the “octave perspectives”.
The word ‘note’ is frequently used in the field of music in a way in which it is left to context to determine whether the term is meant in an octave-folded or octave-distinguished way:

### In the Octave-Folded Perspective

the note ‘B’ refers to B at all octaves, therefore includes B2, B3, B5 etc.
   This is used, among other ways, in the names of keys, chords and in many cases notes, like the notes of chords.

### In the Octave-Distinguished Perspective:

B2, B3, B4 are all different notes
The term ‘pitch class’ is often formally used in the field to refer to a note from an octave-folded perspective, but we will avoid it for better accessibility, and just use ‘note’, because, in keeping with general use in music, the ambiguity which these two terms ‘octave-distinguished’ and ‘octave-folded’ can resolve is usually easily resolved by context alone without problems,
The two octave perspectives also apply to the physical keys of a piano-type keyboard, and as with notes, context typically allows the reader to infer which perspective is intended. For example, in the sentence “the physical C is the only key starting from which a Major mode scale can be played with no black keys,” the octave-folded perspective is clearly implied: it refers to any physical C key, regardless of octave. Although there are multiple C keys across the keyboard, each differing by octave, the use of the word “only” remains valid because the octave-folded perspective is in play, making, effectively, all of these keys regarded as the same. By contrast, in a phrase like “physical C5,” the octave-distinguished perspective is clearly invoked.

### Groundwork—the Verb ‘Trigger’

The verb ‘trigger’ when used alone will be a shorthand for ‘engage the claviation trigger’.

### A.6.1 The Kal Key Change

Recall that the KALC Framework is designed so that kal key changes extend kal signatures with maximal similarity. This enables a natural learning progression: students first master kal signatures—executing them at the start of all pieces, verbalizing them, understanding them and recognizing them on the staff—before moving on to kal key changes.

Although key changes are common in music, music without them is extremely common, so much so that early learners can build strong fluency with kal signatures alone. Many students may play for years using only pieces without key changes, gaining confidence before encountering kal key changes.

Critically, the entire framework developed for kal signatures—execution steps, verbalizations, octave decisions, and muscle memory—applies directly to kal key changes with only minimal adjustments.

This deep structural similarity is proven here in that the differences between them are given by only two rules, Rule 1 and Rule 2. The contents of these rules have been largely revealed already:

Definition: A kal signature and a kal key change are “twins” if they share the same picking key and the same dropping key (and therefore the same picking and dropping symbols on the staff).

Rule 1: Twins differ in only three ways:
I. A kal signature when executed is preceded by a transpose reset; its twin kal key change is not. The physical action on the keyboard is otherwise identical.
II. On the staff, the kal signature mark is enclosed in parentheses; the twin kal key change mark is not.
III. In a verbalization of a kal key change, the note name is explicitly a kal note, (for example, with modifier “kal” before the note name, e.g., ‘kal E♭ Major’) while in the kal signature it is not.

Rule 2: In any score, only the kal signature that is active at the point where play begins is executed—just before performance starts. All subsequent kal key changes are executed as they are encountered during play.

Together, Rules 1 and 2, along with the foundation provided in the last section, are sufficient for a person to figure out how perform pieces involving multiple key changes, and extend everything they learned about kal signatures to kal key changes. However, a player is not expected to learn from these rules: they are not intended to be explicitly taught to general learners but can be valuable to teachers or systematic learners, especially autodidacts. In a teaching context, especially with beginners or children, the teacher would be much more likely just to teach directly by examples: how to use the kal key change, drawing direct attention to the difference with kal signatures. However, it is a very useful exercise here to walk through an example score—the “Second Model Piece”—to show these rules in action.

The Second Model Piece is shown in FIG. 12. It has two parts, the first in E♭ Major, the second in D Major. It has two staves, the upper staff representing the piece in traditional notation, and the second being a kal score. It has two parts which we give schematic labels Part 1 and Part 2. Its first part is in fact identical to the whole of the First Model Piece. The following legend applies:
01—kal signature
02—kal key change

A kal key change, occurs between the first and second part. If Part 1 were long enough, the kal signature for E♭ Major would be repeated many times; similarly, if Part 2 were long enough, the kal signature for D Major would be repeated. This mirrors traditional music notation, where key signatures are repeated at the start of each line. The reason is the same: the player must be able to start at any point in the score, possibly pages into the piece, and smart-tune correctly by referring to the nearest preceding kal signature.

Just before Part 2, the diagram introduces the kal key change, which—like the kal signature—is annotated using claviation marks, but these ones have no parentheses. Because these keypresses of the kal key change occur during active musical beats, the question arises: do they consume rhythmic time?

They do not. Claviation keypresses are muted and rhythmically inert—they function similarly to grace notes in that they do not occupy time value in the score. However, unlike typical grace notes, they are not required to be executed rapidly. Their only constraint is timing: they must be executed in synchrony with the claviation trigger and within the broader musical context.

In the diagram, the kal key change is shown occurring immediately after the final quarter note of the measure. While this may appear rhythmically tight or awkward, it is only an artifact of the model piece's unusual construction. The model pieces were intentionally crafted to be structurally small and to fit within a compact diagram, rather than to be musically naturalistic. Fortunately, as discussed in Appendix C.2 (“The transposition window”), there are strong musical reasons why kal key changes will rarely, if ever, be difficult to execute in practical use—and in those rare cases where they are, the difficulty can readily be worked around.

Suppose a player starts at the beginning and plays through. Rule 2 implies that, they do not execute the kal signature of Part 2, so the only smart-tuning done mid-piece is the kal key change shown, and the second kal signature is information only for them. It would of course be used by a player who decides to start in Part 2.

Recall that the above is an artificially minimized model piece. In a real substitute, Part 1 and Part 2 might both be several pages long, and their kal signatures repeated at every line, allowing entry by a player anywhere mid-piece.

Recall that a “table of six” standard verbalizations can be generated from any one octave-distinguished claviation mark—whether a kal signature or a kal key change. As an instructive example, we construct the six forms corresponding to the second kal signature shown, which reads:
‘Pick D5 down drop on Major's home’

From this, we derive the following ‘table of six’ standard verbalizations across the three verbosity classes, dropping octave information to get the octave-folded versions:

| | Verbalizations | Verbalizations |
|---|---|---|
| Verbosity | (octave-distinguished) | (octave-folded) |
| Maximal | ‘Pick D5 down drop on | ‘Pick D drop on |
| | Major's home’ | Major's home’ |
| Intermediate | ‘Pick D5 down drop | ‘Pick D drop |
| | Major’ | Major’ |
| Minimal | ‘D5 down Major’ | ‘D Major’ |

Similarly, Rule 1 enables us to construct the corresponding table for a kal key change. If we imagine placing parentheses around the kal key change on the staff, we are effectively imagining its twin kal signature. In this case, we may verbalize that twin as:
‘Pick B4 up drop on Major's home’

The ‘table of six’ can be made for the twin, and using Rule 1 (iii), we can produce the table of six for the kal key change, which will be different only in that the ‘kal B’—explicitly kal note—form of the note is used:

| | Verbalizations | Verbalizations |
|---|---|---|
| Verbosity | (octave-distinguished) | (octave-folded) |
| Maximal | ‘Pick kal B4 up drop on | ‘Pick kal B drop on |
| | Major's home’ | Major's home’ |
| Intermediate | ‘Pick kal B4 up drop | ‘Pick kal B drop |
| | Major’ | Major’ |
| Minimal | ‘kal B4 up Major’ | ‘kal B Major’ |

We know how to execute all of these because Rule 1(i) tells us that it is the same as for its twin B Major except that the reset is omitted.

The octave-folded verbalizations capture the significant musical identity of the smart-tuning, while the octave-distinguished forms reflect the specific physical execution chosen on the keyboard. Thus, the most compact name which is still musically expressive for the meaning of this kal key change is simply:
kal B Major

This naming logic is identical to that of the kal signatures shown earlier: the first kal signature is most compactly named E♭ Major, and the second, D Major.

To reiterate: Rule 1 and Rule 2 are not part of the student-facing pedagogy. Students are not taught to apply these rules directly; instead, they learn through example and guided experience. However, examining the application of the rules on the examples reveals the deep structural similarity between kal signatures and kal key changes. It becomes clear how little differs between them—and therefore how naturally the learning from one transfers to the other.

In practice, once students are comfortable with kal signatures, kal key changes can be introduced and reinforced with just a few targeted examples. From there, fluency develops quickly through structured exercises generated by sets either of verbalizations and/or staff-based representations.

Recall that in the octave-folded perspective, the minimal verbalization—and natural name—of a kal signature is simply the name of the key it smart-tunes to—for example, “E♭ Major.” A useful consequence of Rule 1 (iii) is that kal key changes can be given a parallel naming convention: they are similarly named by their minimal verbalization, which amounts to placing the modifier “kal” before a key name—for example, “kal E♭ Major.” This instantly yields the full set of possible kal key change names—each one matching a familiar key name, with “kal” prepended. A useful musical connection between a kal key change and the musical key of its twin kal signature will be explained later, and this connection can further support understanding and intuition of what kal key changes are.

### (A Quick Overview of Kal Key Changes)

More detail on kal key changes will follow, but for now: players do not require theoretical grounding to use them effectively. They learn their character and function through practical execution and naming alone. For example:

From a Major key, for example:
kal G Major corresponds to modulating up a fifth or down a fourth.
kal F Major corresponds to modulating up a fourth or down a fifth.

Players do not need to compute, learn or remember the intervals stated above—rather they simply learn to recognize and execute kal key changes by name and by action, just as one learns to recognize and play chords. Where on a traditional keyboard, a teacher of Jazz keyboard would instruct a student to ‘now modulate up a fifth’, a teacher instructing them on the claviating keyboard would simply say ‘Now do a kal G Major’ instead. The student therefore does not have to have learned any music theory in order to reproduce or even improvise a chosen key change.

The set of musically relevant kal key changes that a player learns—what we might call a player's kal key change palette—is compact and learnable. In fact, it's smaller and easier to master than the set of common chords in even a single key.

In modulation-rich genres like jazz, traditional keyboards require significant multikey fluency of the player to navigate frequent key changes. A claviating keyboard transforms that paradigm: with a small, practical palette of kal key changes, relative beginners can gain fluency and agility in key changes at a speed that would be unthinkable using a traditional keyboard.

### (Extended Verbalization for a Kal Key Change)

According to Rule 1(i), a kal key change does not include a reset operation.

Accordingly, the verbalization extension must be adapted:
Recall the verbalization extension for a kal signature:
   ‘Reset, trigger— . . . —note the scale’
For kal key change it is simply:
   ‘Trigger— . . . —note the scale’

### (Pedagogical Use of Shell Verbalizations)

After they have learned kal signatures, when a student is first introduced to kal key changes, a teacher may reintroduce the verbalization extension—even if it has already been dropped for kal signatures—to emphasize what's new. For some students, it may be useful, during a set of exercises or for a while during practice, to use shell verbalizations for both the kal signature and its corresponding key change. These forms put the name of the tuning aside so that the differences in the supporting action stands out more.

### Example Comparison (Using Shell Verbalization):

| Context | Extended Shell Verbalization |
|---|---|
| Kal Signature | ‘Reset, trigger, pick drop, note the |
| | scale’ |
| Kal Key Change | ‘Trigger, pick drop, note the scale’ |

This contrast gives students a kinesthetic and verbal grasp of what distinguishes these two operations—same drop location, same picked note, but different source key and musical context.

Once comfortable, the student may begin using non-shell verbalizations again to reinforce the understanding of the smart-tuning:

| Context | Standard Verbalization |
|---|---|
| Kal Signature | ‘Reset, trigger, B Major, note the |
| | scale’ |
| Kal Key Change | ‘Trigger, kal B Major, note the scale’ |

Both verbalization types—shell and standard—are valid and useful. The choice depends on the teaching goal at the time. The KALC Framework accommodates both, and the teacher would chose which are used at what time in the learning process.

### A.6.2 Deeper Understanding of Kal Key Changes

### (Relative Kal Key Changes and Instructional Claviation)

Among kal key changes, there exists a pedagogically important subset called relative kal key changes. These transitions switch modes without altering the key signature or transposition state of the keyboard. They are conceptually paired—in fact, they are twins—with the home musical key kal signatures introduced earlier—those written with both picking and dropping marks horizontally aligned on the home line or space of the mode.

To understand their effect, consider a player already smart-tuned to a Major key. Suppose they execute the following kal key change:
kal C Major

If this is verbalized in octave-distinguished and extended form, choosing octave 4 to pick from, it will be:
‘Trigger, pick kal C4 stay drop Major, note the scale.’

Here, the dropping key is the same as the picking key—physical C4. The gesture is visually recognizable and optionally augmented with scale-running or dummy-running. Yet in practice, nothing has changed. The keyboard's transposition setting remains stable: the note kal C was picked from key C and dropped onto the same key C. Thus, this gesture has Δx=ΔTS=0 (no transpositional shift), and the mode remains Major.

Now contrast this with a more meaningful case. Suppose the keyboard was tuned to Minor instead, and the player then executes kal C Major in the same way. Again, the physical claviation has no effect on transposition—but the mode has shifted from Minor to Major. The scale has moved from running A to A (minor) to running C to C (major), even though the keys used are the same. Here, the noting the scale step becomes meaningful. For adaptive players especially, such reinforcement of the new scale is valuable.

This kind of transition—where the transpose state remains constant but the mode changes—is a relative kal key change. It is defined by the following features:
It carries the name of a home musical key except with kal before it (e.g., kal A Minor, kal C Major).
The same physical key is used for both picking and dropping key.
It results in no change to the transpose state (ΔTS=0). The underlying traditional key signature is unchanged.
It is easily recognized on the staff by the horizontal alignment of the picking and dropping symbols.

Because such key changes produce no functional transposition, they are elective. The claviation gesture is optional—used as a training aid rather than a requirement. These are called “instructional claviations”.

### (Pedagogical Use of Instructional Claviation)

The instructional claviation is a tool for guiding students through relative mode changes. Its optional nature supports a graceful learning curve, progressing from explicit action to internalized awareness.

This sequence helps develop intuitive awareness of mode shifts. Early on, the gesture acts as an anchor. Later, the player may internalize the effect entirely, skipping the physical gesture while still updating their mental model of the scale.

A recommended progression is:

### Beginner Stage

Students perform the instructional claviation in full just like regular claviations, including the trigger and both picking and dropping keypresses. They reinforce the scale shift by augmenting with a full scale run during practice.

### Intermediate Stage

Students skip sounding the scale, instead dummy-running it—sliding a finger across the relevant keys—to reinforce the new mode's physical location.

### Advanced Stage

Students may skip the claviation action entirely, recognizing that no transposition is needed. To signal this skipped action, they may:
   Omit the trigger,
   Lightly double-tap the shared picking/dropping key as a physical cue. (This is known as a “dummy claviation”.)
   Optionally follow with a dummy-run if time permits.

### Final Advanced Stage

Do nothing except noting the scale.

Note that in even the final advanced stage of an instructional claviation, the noting the scale step is prescribed, keeping the player aware of the mode change.

On traditional staff notation, relative key changes are musically significant yet visually invisible: the key signature remains unchanged, and the mode shift is not represented. In the KALC Framework, by contrast, such changes are made explicit. The corresponding kal key change is shown directly on the staff, with a clear symbol and gesture that can be taught, practiced, and reinforced.

What is glossed over in traditional pedagogy thus becomes a structured opportunity for learning and mastery. And because the gesture is ultimately optional—able to be set aside once fluency is achieved—it functions as a training scaffold: present when needed, but naturally disappearing as the player advances.

### (Kal Key Changes for Adaptive Players)

Fully-scripted players typically execute kal key changes as they are shown—either demonstrated directly or notated in a kal score they've learned to interpret. For them, understanding the broader musical implications of a key change is not essential, as they are following a predetermined path.

Adaptive players by contrast—especially improvisers—must often choose key changes in real time. For them, it is crucial to understand how kal key changes operate musically and how they interact with the current mode. The kal key change alone does not determine the nature of the modulation; the effect depends on the combination of the current mode and the kal key change.

To account for this, kal key change palettes are best organized by origin mode (i.e., the mode the player is currently in, before the change). This allows for better contextual understanding and faster retrieval of musically meaningful transitions. In this setting, the word origin may be regarded as a synonym for current.

The following are good but minimal ‘core palettes’ for kal key changes:

### (Kal Key Change Core Palettes)

### Origin Mode: Major

| Kal Key Change | Traditional Description |
|---|---|
| kal A Minor | Move to relative minor |
| kal G Major | Modulate up a fifth or down |
| | a fourth |
| kal D Major | Modulate up a whole step |
| kal E Major | Modulate up a major third or |
| | down a minor sixth |
| kal E [symbol] Major | Modulate up a minor third or |
| | down a major sixth |
| kal F Major | Modulate up a fourth or down |
| | a fifth |
| kal C Minor | Move to parallel minor (same |
| | tonic, different mode) |

### Origin Mode: Minor

| Kal Key Change | Traditional Description |
|---|---|
| kal C Major | Move to relative Major |
| kal E Minor | Modulate up a fifth or down a |
| | fourth (to dominant Minor) |
| kal D Minor | Modulate up a fourth or down a |
| | fifth (to subdominant Minor) |
| kal A Major | Move to parallel Major (same |
| | tonic, different mode) |
| kal C Minor | Modulate up a minor third |
| | (A minor → C Minor) |
| kal F Major | Modulate down a major third |
| | (A minor → F Major) |
| kal C Major | Move to relative Major |

A reasonable estimate is that over 90% of key changes encountered in contemporary playing from origin Major or Minor are covered by the small core palettes above. Doubling the size of each palette would likely raise that coverage above 99%. This reflects the highly patterned nature of tonal modulation—and the fact that kal key changes are drawn from a compact, musically grounded set that is not at all burdensome to learn. As already noted, learning a new kal key change is easier than learning a new chord: it involves a single gesture, accompanied by a clear verbalization based on a key name. In fact, once the naming rule is understood, the typical learner already knows the name of every possible kal key change—because they already know the names of all possible keys. What remains to be learned is simply the musical function of each change, and where to apply it, which is learned from teachers and by experience and exploration.

### (Movement to Parallel Key)

The kal key change palettes above include relative key changes, previously discussed, and also parallel key changes, which merit further remark. In a parallel key change, the mode changes but the root note does not. This results in a distinctive experience during claviation, one that helps reinforce the special nature of the transition.

For example, from an origin mode of Major, executing the kal key change to kal C Minor constitutes a move to the parallel Minor. The player ‘picks’ from physical key C, which is Major's home—the same key on which they last ‘dropped’. They now ‘drop’ this onto Minor's home.

This act of picking up what was last dropped reinforces the fact that the root note remains unchanged, even as the mode shifts. The player is moving the root note to a new home which means the home for a new mode. The physical and cognitive symmetry of this gesture supports learning and helps internalize the concept of a parallel key change.

### (A Useful Tip for Learner's Understanding Kal Key Changes)

A practical aid can make kal key changes easier to grasp for many learners. In common teaching practice, students are often introduced to key changes using examples which involve the simplest keys, which are in fact the home musical keys—such as C Major or A Minor—as neutral origin reference points. This approach proves helpful when introducing kal key changes, as it enables a simple and reliable teaching strategy.

Recall that every kal key change has a corresponding twin kal signature—the key change includes the prefix kal, while its twin does not. A kal key change's twin key is simply the key to which its corresponding twin kal signature smart-tunes (and with which the name is visibly related). For example, the twin key of kal D Major is just the key D Major.

A useful teaching rule arises:
Teaching Rule: To understand the nature of a kal key change from any origin mode, compare it to the modulation from the home musical key of that origin mode to the twin key of the kal key change.

For example:
To evaluate: (any root) Major→kal D Major
   Compare with: C Major→D Major (modulation up a whole tone)
To evaluate: (any root) Minor→kal D Minor
   Compare with: A Minor→D Minor (modulation up a fourth)

This tip helps learners to reason about kal key changes using modulations from home musical keys, the latter being common in examples to teach modulation. Since the musical type of modulation remains the same across transpositions, the comparison holds regardless of the actual starting key. It is a conceptual shortcut that builds understanding, confidence and fluency—especially for adaptive players making real-time decisions.

### (The Possibility of Slurs for Kal Key Changes)

In a kal signature, it is always clear which symbol represents the picking key and which represents the dropping key, even when the two are vertically distant and the horizontal displacement between the two not so evident. This clarity is maintained by the placement of the opening parenthesis immediately before (the left of) and horizontally in line with the picking symbol and the closing parenthesis immediately after the dropping symbol. In the case of kal key changes, which do not use parentheses, additional visual clarity may be warranted when the picking and placing symbols are significantly separated in vertical position. In such cases, it may be advisable to introduce additional horizontal offset between them as well. If further visual reinforcement is desired, a slur may be introduced as a notational convention to associate the two symbols, emphasizing their unity as the two components of a single claviation mark.

### A.7 why Transpose for a Kal Key Change Must be Relative

A natural question arises: why the duality between kal signatures and kal key changes? In the current design, a kal key change is relative, operating by ΔTS, while a kal signature requires a transpose reset before execution. At first glance, it might seem simpler to eliminate this distinction. If every claviation reset were built into the definition itself, then all claviations would be absolute, setting TS directly rather than ΔTS. In that design, kal signatures could be executed at the same speed as kal key changes, and the score could simply warn the player when a new kal signature was to be applied.

Such a system would work well enough for learning a given piece with fixed key changes. But it breaks down when transposition is required in performance. Suppose a player learns a piece this way and then, at performance time, discovers it must be transposed three semitones higher to suit a singer. They would have to adjust every kal signature in the piece by three semitones. There is no straightforward way to do this in real time—and even if it were possible, it would force them to play differently than they practiced.

By contrast, the current design preserves flexibility. With kal signatures defined as absolute but kal key changes defined as relative, a global transposition is simple. The player can perform an “adjusting claviation” at the start of the piece, either after the reset and before their usual claviation, or immediately afterward. An adjusting claviation shifts the entire piece by a chosen number of semitones: it is any claviation that produces the required ΔTS according to Equation 3. For example, to shift the piece up by four semitones, the player could pick E and drop on C, or use any other pick-drop pair that spans four semitones

### A.8 Determining a Kal Key Change Between Two Key Signatures

The framework for determining the picking and dropping keys of kal signatures has already been established, aside from octave decisions. This process requires three inputs: the key signature, the mode of the piece, and the resolution of octave choices (to be elaborated later). Once the key signatures are given, these inputs fully determine the kal signatures.

But if the key signatures themselves are given, what determines the kal key changes between them? (Performers who improvise key changes will generally be choosing the kal key change directly, so this concern does not apply to them.)

Given the smart-tuning states of both the current key and the upcoming key, a unique kal key change can be constructed which, when executed, transforms the instrument from the current state to the upcoming one.

The dropping key of the kal key change is straightforward: it is the home of the upcoming mode. The value of ΔTS is also known, since both the current and upcoming TS are defined. The x-value of the picking key then follows directly from Equation 3:

$$Δ TS = x ( picking key ) - x ( dropping key )$$

This relation determines the picking key and therefore its staff position. If the result corresponds to a black key, two enharmonic spellings are theoretically possible, but since the upcoming key's spelling is already known, the sensible and expected choice is unambiguous.

Thus every kal key change is uniquely determined in notation by the two notational key signatures it connects—assuming mode can be inferred.

For example, in the Model Piece, the claviation signatures correspond to the following transposition settings:
Part 1: TS=3
Part 2: TS=2

$$Δ TS = - 1 = x ( picking key ) - x ( dropping key )$$

From the above, with the dropping key decided as C5 (home of Major), the picking key is therefore B4.

### A.9 Conversion of Scores Automatically in Software

Note: Generally the Appendix requires musical knowledge but not engineering knowledge. The current subsection of the Appendix, which shows how scores can be converted from traditional scores to kal scores in software requires both kinds of knowledge.

Another major advantage of claviation—and therefore a significant merit of the invention—is that converting a traditional score into a kal score is fully automatable in software. This enables the rapid adaptation of large volumes of existing music, even at the end-user level.

Several existing technologies make this possible:
Rich digital music libraries already exist in widely used formats such as MusicXML and the MuseScore file format.
MuseScore, a free and open-source notation program with millions of users worldwide, supports extensive plugin-based customization for display, playback, and printing.
Free MuseScore plugins can be developed to convert traditional scores into kal scores. Such a plugin is referred to here as a kal-converting utility.
The MuseScore plugin API abstracts away many implementation details, allowing developers to focus on notation logic rather than low-level rendering.

Together, these capabilities create, with minimal barriers, a viable path toward widespread adoption of kal scores and position the kal staff as a candidate for a new standard of notation for the claviating keyboard.

In fact, many of the core functions required to build a kal-converting utility are already implemented in existing open-source MuseScore plugins. For example, plugins already exist that transpose entire scores arbitrarily. Extending these to support kal conversion would require only a modest combination of capabilities:
The ability to assess the mode of a passage (numerous reliable methods already exist).
The ability to transpose directly on the staff (already supported by MuseScore's plugin architecture).
A mechanism to resolve the decisions of octave, which fully specify the claviation mark.

### Groundwork; Key Signature Region

A “key signature region” is a part of the piece on the score that is governed by the same underlying key signature. Equivalently, this can mean the same kal signature on a kal score or traditional key signature on a traditional score.

In pieces that contain key changes, these octave decisions are required not just once but for each key signature region within the piece. As such, the software must determine a set of picking-dropping pairs—one for each key signature region.

Recall that the more important decision is the second decision of octave, which determines the position of the notes on the staff. If such a decision were consistently resolved upwards for example in a piece with many key changes, the piece would soon run off of the top of the staff, requiring many ledger lines. Resolving these decisions is fundamentally a discrete optimization problem. The objective is to select a set of octave-distinguished picking-dropping pairs, one for each key signature region, that minimize notational or playing drawbacks—such as excessive ledger line usage or unnecessarily large claviation intervals. Although kal key changes are explained in more detail in the following section, it is useful to note here that earlier octave decisions influence the desirability of later ones, particularly in the case of kal key changes.

By assigning weights to undesirable conditions—such as significant gap between picking and dropping key, staff-crossing behavior, or forcing of ledger lines—the plugin can identify an optimal solution using established optimization techniques. This is a well-studied class of problem in the domain of automated typesetting and should respond well to known methods in score engraving and computational layout optimization.

On the grand staff, each kal signature must be rendered in a way that integrates cleanly with both the treble and bass staves. Ideally, the system generates two equivalent kal signatures—one on each staff—giving the player a choice of where to execute the action. In practice, the player will typically perform the upper one with the right hand and the lower one with the left, in line with common performance habits, and as in common performance habits, it is not obligatory.

When two kal signatures are rendered (one per staff), the player must execute only one and they must share the same second decision of octave—that is, the drop direction must be identical in both, to ensure a consistent transpose value and actual octave of the music.

### (A Failure to Infer Mode Correctly is not Fatal)

If the entity (person or program) doing the conversion from a traditional score to a kal score infers the mode incorrectly, the piece will still play exactly as intended. The only consequence is that the resulting kal score will misinform the player about which mode is in use—it will sound correct, but the labeling of the mode, indicated by the dropping key, will be wrong.

### A.10 Concluding Remarks on the KALC Framework

Taken together, these usability elements illustrate how the KALC Framework operates as a complete and self-reinforcing system. It bridges notation, gesture, and cognition—guiding the player from explicit instruction to intuitive fluency. What traditional systems leave implicit or scattered across domains, KALC renders teachable, traceable, and reusable. Its structured verbalizations, transposing staff, and instructional scaffolds create not just a method for playing smart-tuned music, but a replicable method for learning it. As such, it supports not only skilled performance but scalable pedagogy and reliable transfer of expertise.

### Appendix, Part B: Advantages and Benefits of Claviation

The previous part of this Appendix, Part A, demonstrated that claviation provides a highly usable and learnable framework for fully smart-tuned playing, enabling fluent performance across all musical keys. This section now turns to the merits of the invention by elaborating on its advantages and benefits.

A useful starting point is the overview already provided in the main specification body. The reader is therefore referred to Section 1.2 (“Advantages and benefits of claviation”) which will be regarded as the introduction to this present part of the Appendix. That section classifies the advantages of claviation into two categories:
executional enablement
perceptual-creative enablement

It also identifies a key property underlying perceptual-creative enablement on a claviating keyboard—its distinctive and novel property of diatonic transparency.

Executional enablement is easy to conceptualize, and no further detail needs to be added beyond what is already covered in Section 1.2. The purpose of this section of the Appendix is therefore to expand upon the other advantages of claviation identified in Section 1.2., under the following headings:
B.1—A showcasing of the advantages for adaptive players.
B.2—Theoretical grounding of diatonic transparency
B.3—A further look at advantages for jazz players.
B.4—Hybrid kal signatures—an easier learning path for improvising on acoustic piano
B.5—Isomorphic keyboard benefits
B.6—Enabling dynamic just-intonation

### B.1 A Showcasing of the Advantages for Adaptive Players

### (Demonstration: Blues Improvisation on a Claviating Keyboard)

Before turning to theory, it is valuable to illustrate both executional enablement and perceptual-creative enablement in practice. Consider a student beginning to improvise blues—a setting where claviation's advantages appear immediately.

Please see FIG. 13. In it, two octaves of the claviating keyboard are recolored for Major pentatonic blues. Physical keys F and B are taped over in black to exclude them; E♭ is highlighted in blueas the blue note, though it is shown the same way as the white keys in the figure. This “blues recoloring” reduces the scale to just six notes: C, D, E♭, E, G, A.

The student is taught only 3 foundational chords—kal C7, F7, and G7—and plays them with the left hand, one chord per measure, in the standard 12-bar blues progression:

| | | | |
|---|---|---|---|
| kal C7 | C7 | C7 | C7 |
| kal F7 | F7 | C7 | C7 |
| kal G7 | F7 | C7 | G7 |

While the left hand marks time with these chords, the right hand improvises the blues melody freely, using the recolored six-note scale.

Because claviation maintains a constant physical mapping, this exact layout, scale, and chord set works in every musical key. It works in Minor pentatonic blues also, though using a different pallette of 3 kal chords. Students can even change key mid-play by claviating, and do so confidently even as beginners.

The immediate gains are mechanical through executional enablement:
Students improvise across all keys from the first day, rather than relearning with each new key.
Attention shifts to rhythm, articulation, and phrasing instead of fingering logistics.
The Total Multikey Overhead is avoided, saving months or years of slowed progress.

Traditional keyboards impose the reverse: mechanical disruption. Each new key shifts patterns, alters fingerings, and demands new muscle memory. From a mechanical standpoint, it is like having to internalize 12 separate motor schemas—one for each key—as though learning 12 different instruments.

The benefits through perceptual-creative enablement go deeper: on a traditional keyboard, every key change scrambles the mapping of musical roles—tonic, dominant, subdominant, blue note—forcing the student to relearn them in different physical locations. This is like being asked to master 12 different languages without cues to distinguish them. Children raised with multiple spoken languages keep them apart effortlessly, because the brain is evolutionarily tuned to lock onto cues such as register, rhythm, and context. Keyboard learners are given no such natural signals. With key signatures shifting roles arbitrarily from one group of keys to another, the brain cannot reliably tag them as distinct systems. The result is pattern interference: anchors slip, roles blur, and the sense of underlying structure is harder to grasp.

Claviation solves this by fixing roles to stable physical anchors. The blue note is always kal E♭; only the kal C7 chord can serve as the tonic seventh chord of a Major key (in dominant seventh form). These physical keys and the shapes of the chords become cognitive anchors for their related concepts—they become consistent physical locations tied to stable musical roles. Students internalize not only the shapes of scales and chords, but their meanings, and those meanings never shift under their fingers.

The result is that with executional enablement and perceptual-creative enablement reinforcing each other, fluency emerges much earlier, more naturally, with less frustration, more reward and therefore heightening of motivation. The student perceives music through stable, reusable structures and expresses it without mechanical burden. Improvisation feels like speaking one coherent language fluently, rather than struggling through 12 dialects.

### B.2 Theoretical Grounding of Diatonic Transparency

Section 1.2 (“Advantages and benefits of claviation”) introduces perceptual-creative enablement as a general concept. It also explains diatonic transparency as a cognitive benefit to players, but does not rigorously define it in music-theoretical terms. That is the purpose of this section, as well as to give a deeper understanding of it, its implications, and how to enhance it.

Diatonic transparency is one contributor to perceptual-creative enablement, but perceptual-creative enablement is broader. The isomorphism of isomorphic keyboards, for example, is also powerfully perceptual-creatively enabling. However, isomorphic keyboards do not inherently provide diatonic transparency—although claviation can add it to electronic isomorphic keyboards as well.

The KALC Framework developed here does not introduce new music theory in the strict sense; all of its foundations have been known for centuries. What it provides are new, succinct formulations of those concepts, developed because the claviating keyboard creates a practical need for them. Older terminology is often ambiguous, and new terms are required to explain longstanding concepts in a systematic way.

### B.2.1 Kal Notes as Abstract Notes, and Defining Diatonic Transparency

### Groundwork—Abstract Notes and Chords

The defining quality of “abstractness” in a musical notational system is this:
   If the system correctly describes any part of any piece, then if it is abstract, it must still describe it in the same way correctly if the piece as a whole is transposed.
This transposability principle is central to abstract notes—and abstract chords follow naturally as sets of abstract notes. Scale degrees and their corresponding sets, chord functions are traditionally established abstract notes and abstract chords respectively.

### Groundwork—Dual Denotation—Both Abstract and Concrete

“Dual denotation” is occurring when the same term or symbol is used in an abstract way and concrete way at the same time. It occurs frequently in music usage, and indeed is a feature of natural language in general.
When a teacher says ‘sing that fifth again’, dual denotation is occurring. When saying ‘that fifth’, the teacher is identifying an actual note, but is making a reference also to an abstract note, the fifth scale degree, of which the concrete note is representative in the context.
Just as dual denotation is the accepted practice for scale degrees an Roman numeral chord functions, it is applicable to kal notes and kal chords also: in a context, the same symbol or name is used to mean both.

### (Kal Notes are Abstract Notes)

For music with a meaningful key signature written on a staff, every note of the piece has a specific, deterministically defined kal note associated with it. This has been constructively demonstrated in Appendix Part A, where a procedure was given to generate the kal score from a traditional score. The requirement that the key signature is meaningful and non-arbitrary anchors the scope to diatonically-based music.

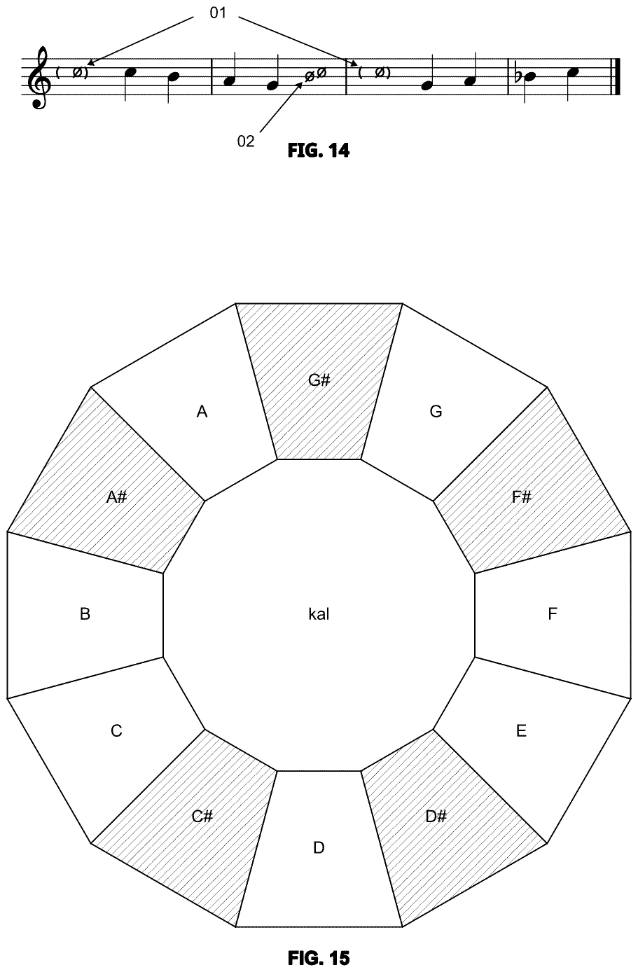

Inspection of that deterministic process shows that—setting aside the claviation marks, and allowing for octave ambiguity produced by the decisions of octave—the staff content of a kal score does not depend on the root note of the key. FIG. 14 shows the rootless kal score of the Second Model Piece.

The following legend applies to FIG. 14:
01—kal signature
02—kal key change

To convert a regular kal score to a rootless kal score, one simply removes the root notes, represented by the picking marks, from the kal signatures, and nothing more. The kal key changes remain unchanged. Assigning a picking key at any single kal signature is sufficient to determine all others throughout the score, thereby converting the rootless kal score into a regular kal score. Once made concrete in this way, transposing the entire piece involves only shifting all picking keys in the kal signatures alone by a uniform interval. This operation similarly leaves all other staff content—including kal key changes—unchanged. In this sense, the staff content (apart from exclusively the picking keys in the kal signatures) represents abstract pitch relationships rather than absolute pitches.

Accordingly, kal notes are abstract as defined, and so are kal chords, in the same sense that scale degrees and Roman-numeral chord functions are abstract.

The rootless kal score, in a very real sense, represents music in its most abstract form—and on the claviating keyboard it can be played directly in that form. It is not a unique representation of a piece, but the only elements of choice in such a representation have already been accounted for: the two decisions of octave. The only concrete details in any kal score are the picking keys specified in the kal signatures—and in a rootless kal score, these are precisely the elements left blank. Concreteness enters playing only at the moment of the first keypress, when the kal signature is executed.

In this way, the claviating keyboard allows music to be performed as abstract structure, with concreteness deferred until the act of performance itself, and entering only with the first keypress of the piece.

Kal notes, in octave-folded perspective, are by definition the members of what will be called the “filled abstract diatonic circlet”—a set of abstract notes whose name will be justified and abstract structure explained in the next subsection, B.2.2 (“What are the kal notes musically?”). For now, it is enough to note that the word diatonic is inherent to their meaning. With this in place, we can now formally define “diatonic transparency”:

### (Definition of Diatonic Transparency)

The definition has two parts: a binary condition and a qualitative dimension.
Binary condition: For an instrument to qualify as diatonically transparent at all, every physical key of the instrument must be stably mapped to a particular kal note.
Qualitative dimension: The degree of diatonic transparency is measured by how effectively the keyboard supports the recognition of the distinction between the octave-folded physical keys by the player, especially the diatonic (white) ones, across visual, tactile, and kinesthetic channels.

On this definition, the traditional piano keyboard has zero diatonic transparency, because it fails the binary condition. The claviating keyboard in piano layout passes the binary condition, and in the opinion of the inventor, achieves a very good qualitative rating, while further modifications to the key surfaces (at manufacture time or through the use of removable overlays) can raise it further.

On the claviating keyboard, learning to recognize kal notes individually is effectively the same as learning to recognize and distinguish the individual physical keys of the piano, in the octave-folded perspective. The irregular spacing and shape of black and white keys plays a very helpful role in this recognition, both visually and kinesthetically. When a finger moves to a black key, its “blackness”—its role as an altered, nondiatonic note among the diatonic kal notes—is reinforced. Perception of the difference between physical keys is felt as well as seen. It is felt in a tactile way, and also in a kinesthetic way, because the hand has to move to a different position to press a black key.

To help understand why the claviating keyboard in traditional piano layout qualifies as ‘very good’ for diatonic transparency, it is instructive to give an example of what would get a rating of poor or terrible: if all keys were equally spaced but still retained black/white coloring, diatonic transparency would technically remain, but its quality would be considerably weakened: essentially all kinesthetic reinforcement would be lost, and the remaining visual cue would be reduced to color alone rather than shape and spacing. If, in addition to equal spacing, all keys were the same color, the instrument would still satisfy the binary condition of diatonic transparency, but its practical quality would collapse—recognition would be extremely poor across visual, tactile, and kinesthetic modalities—rendering it diatonically transparent in name only.

(Kodály-ification of Physical Keys)

While the term kal notes is new to this specification, they have been in use for centuries as will be emerging later. A core principle of the Kodaly Method is the cultivation of internalization of kal notes, using whatever modalities are available. In Kodaly's pedagogy, the motor modality is engaged through hand signs, and the sensory and language modalities through singing solfège syllables. Some educators have added color to piano keys for reinforcement. Yet before claviation, such coloring could only function consistently in one key, so its usefulness was limited to very young children or those content to remain in a single key.

In recognition of this educational mission and achievement, the verb “to kodály-ify the physical keys” will here mean: enhancing the keyboard keys to increase the keyboard's diatonic transparency—which means to enhance the perceptibility of kal notes.

A promising way to kodály-ify a claviating keyboard is through tactile differentiation—making them feel different to the touch. Here we introduce the term “terrain” to describe how the keys provide positional feedback to player, and it exists qualtitatively and in different modalities (for example, visual, tactile or kinesthetic):
“Global terrain” refers to assisting orientation (sense of position) across the keyboard as a whole. If all keys were white and of equal width, the global terrain would be terrible. The addition of black keys in groups of two and three provides a critical improvement, giving players reliable visual landmarks.

The quality of global terrain can even vary depending on the musical key when using a traditional keyboard. Historically, performers have valued keys with many sharps or flats for the superior tactile and kinesthetic orientation they provide-though this was not expressed in terms of global terrain before. The concept of global terrain is introduced here as a new framework for describing this long-recognized phenomenon.
“Local terrain” refers to the capacity to assist the player's orientation (sense of position) of a finger on a single key—whether the finger lands at the center or off to one side. Tactile terrain is crucial here. Black keys, being narrow, provide good local terrain: their shape lets the finger sense exact placement. White keys, by contrast, offer poor local terrain; their flat, large, uniform surface gives no tactile cue of off-center contact. A simple ridge running lengthwise down the center of each white key would immediately improve local terrain, yet such an enhancement has rarely been prioritized in instrument design.

In summary:
Global terrain is good if the player can easily perceive their position on the board—and therefore in the pitch field.
Local terrain is good if the player can accurately perceive their finger position on an individual key.

Ironically, the traditional piano layout was optimized for ease of playing in keys with few black keys, but in terms of terrain—both global and local—the advantage lies with heavily altered key signatures. Players have long recognized this advantage, even if it was not previously articulated in these terms.

The claviating keyboard can capture the best of both worlds: the ergonomic simplicity of the empty key signature together with the reinforcing terrain that historically accompanied altered signatures. This is achieved when the keys are kodály-ified in tactile ways. Distinct tactile identities for the white keys—anchored to their kal note roles—immediately enhance diatonic transparency, because the tactile modality joins the visual and cognitive ones in reinforcing kal note identity.

A ridge or comparable contour running down the center—tactilely differentiated by its surface texture—can provide improved local terrain, giving players precise feedback on finger placement from the contour itself, while the differentiated surface texture of the ridge contributes to global orientation. The purpose of enhancing local terrain is not to increase diatonic transparency, but to support general technique and confidence. By contrast, it is global terrain that directly enhances diatonic transparency.

The white keys can be produced with kodály-ified surfaces as part of their manufacture, or fitted with removable overlays that provide the same effect. Black keys may also be kodály-ified, but the benefit is limited and may not justify the added complexity. This is a case of diminishing returns, since black keys already provide strong kinesthetic differentiation from their neighbors, and on the claviating keyboard, are played far less often than the white keys.

### B.2.2 What are the Kal Notes Musically?

### (Entrainment: The Tonic and Diatonic Backbone)

Musical perception depends on entrainment: the ear becomes attached both to a set of pitches which are diatonically related (diatonic entrainment) and also one of them which among them which is the tonic (tonic entrainment). This happens automatically by simply listening to a musical piece. Experiments and common musical experience suggest that diatonic entrainment is often more persistent than tonic entrainment.

For example, suppose a listener has just heard a piece in C Major. Their ear becomes entrained to that key, which is played all on the white notes of the piano. If quickly asked to sing Happy Birthday—a major-mode tune beginning on the fifth—they will likely begin on G—still in the key of C Major, and its fifth. If asked instead to sing Twinkle, Twinkle, Little Star, a song which starts on its tonic—they will typically begin on C, remaining in C Major. Both are effortless, because the listener is entrained both to the tonic (C) and to the diatonic set (the white keys).

But if asked to sing Greensleeves which is in Minor, they cannot continue singing this in the same key to which they are entrained: they are being given an unspoken choice: either keep tonic (C) or keep the diatonic backbone—they cannot keep both, and they often, totally unconsiously and automically and knowing nothing about music theory, choose to keep the diatonic backbone and let the tonic change: they begin on A rather than C, thus transitioning to A Minor, treating A as the new tonic while remaining within the same diatonic set of white keys which applied to C Major. Likewise, when entrained to C Major and asked to sing Scarborough Fair they may begin on D and sing in D Dorian. These cases show that listeners often retain the diatonic set even as the tonic shifts.

This demonstrates an important principle: the diatonic framework can serve as a stronger perceptual anchor than the tonic itself. In other words, diatonic entrainment can be “stickier” than tonic entrainment.

This framework also helps explain why some key changes feel smoother than others. A modulation from C Major to A Minor retains the same diatonic set (the notes on the white keys) and therefore feels almost continuous. A change from C Major to G Major or F Major preserves all but one note of the diatonic set of notes, producing what musicians perceive as a smooth key change. By contrast, a change from C Major to Bb Major introduces a markedly different diatonic set, resulting in a sharper perceptual break.

(from Scales to Circlets)

The persistence of diatonic entrainment motivates a refinement in terminology. The word scale is strongly bound to the idea of a tonic, which defines its start, end, and linear presentation. Yet the perceptual phenomenon described above—the shared diatonic set—does not privilege a tonic.

We therefore introduce the term “circlet”: a set of notes arranged in sequence, like a scale, but inherently circular and without hierarchy. Although a circlet lacks a global start or end, it preserves “local sequence”: for every note there is a well-defined “scale previous” and “scale next,” corresponding to one step down or up in scale degree, in an unaltered mode and regardless of mode. While the notes cannot literally form a circle when distinguished by octave, they can be represented that way in octave-folded (pitch-class) perspective. A circlet may be visualized as a circle whose orientation is arbitrary—a frozen snapshot of a continuous rotation.
A “diatonic circlet” is a circlet formed by seven diatonically spaced notes (which means they are spaced in the 2-2-1-2-2-2-1 semitone).
The “active diatonic circlet” is the diatonic circlet actually in play at a given moment, determined by the key signature and therefore by the transposition setting (TS). At any time it is the set of notes played by the white keys on the claviating keyboard. A key signature can be regarded as an identifier for the active diatonic circlet. Note that a kal signature is more than that—it identifies the mode as well.
The “abstract diatonic circlet” is its general counterpart when no TS is specified. It corresponds to the set of “white kal notes” viewed abstractly.

To extend this structure, the circlet can be filled by adding the notes that occupy gaps larger than a semitone between adjacent diatonic notes. These added notes are designated as “black kal notes” or “altered kal notes”. They are members of the circlet but marked as a distinct, non-diatonic subset. Unlike the diatonic kal notes, also called “white kal notes”, the “scale previous/scale next” sequence does not apply to them. Black kal notes cannot belong to purely diatonic or modal scales, such as natural Minor, but they may appear in altered scales, such as harmonic Minor; in conventional notation black kal notes are represented by accidentals even if they are part of the scale.

We introduce two figures to illustrate the Filled Abstract Diatonic Circlet:

In “Intervallically-spaced layout”—See FIG. 15:
Each note of the circlet, whether black or white, is represented by an icoseles trapezoid which is part of a 12-sided polygonal annulus. This layout depicts the structure in which angle is analogous to musical interval.

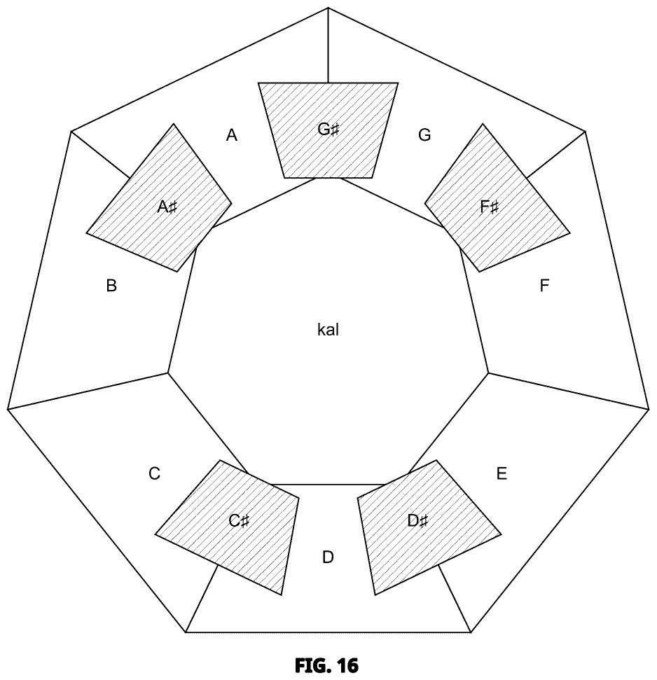

In “Piano-schematic layout”—See FIG. 16:
The same circlet is drawn but in a way mirroring piano key relationships. If can be seen as a 7-sided polygonal annulus representing the white kal notes and, inside and overlaid on it, a representation of the black kal notes. It can be conceived as obtained by (i) taking one octave of the piano, and (ii) wrapping it around a circle positioned just behind the back edge of the keys. This heavily distorts the keys but crucial relationships are preserved. In this visualization, the player imagines their hand at the bottom, aligned with the familiar piano orientation, while the circle rotates to match the point of play.

Note the prominent ‘kal’ prefix in the center of the diagram, applying, by the rules, to all notes in the diagram.

Both schematic layouts are octave-folded views of the same diatonic circlet, and can represent both abstract and concrete kal notes: at a specific TS, each note of the circlet corresponds to a kal note with a definite concert counterpart, making them represent concrete notes also. When TS is unspecified, the same diagram represents the abstract case: the notes are then purely abstract kal notes.

### (Abstract Notes and Chord Systems)

To understand the similarities and differences between the two abstract note systems, scale degrees and kal notes, abstract note systems can be evaluated by three attributes:
1. “Intervallic stability”—a system has this if intervals between any two specific abstract notes remain constant across all contexts.
2. “Tonic stability”—a system has this if each abstract note maintains a fixed position relative to the tonic, in terms of steps of the scale.
3. “Diatonic stability”—the system designates a specific diatonic subset that remains coherent across contexts.

We can compare scale degrees and kal notes against these attributes:

| | Intervallic | Tonic | Diatonic |
|---|---|---|---|
| System | Stability | Stability | Stability |
| Scale degrees | X | ✓ | X |
| Kal notes | ✓ | X | ✓ |

Scale degrees provide tonic stability but lack intervallic and diatonic stability. Kal notes, by contrast, provide intervallic and diatonic stability.

Abstract chords are just sets of abstract notes, so each abstract note system naturally induces an abstract chord system.
Scale degrees give rise to Roman numeral chords functions (e.g., ii-V-I).
Kal notes give rise to kal chords.

Roman numeral chord functions achieve tonic stability but change quality across modes and are not intervallically stable. Kal chords sacrifice tonic stability but have intervalic stability and gain consistent physical mapping on the claviating keyboard, providing a complementary and powerful tool for analysis and performance.

### (Historical Use of Kal Notes)

The abstract notes here called kal notes have been in use for centuries, though mainly in contexts where they were used for solfège singing or pitch training—where their intervallic stability is helpful.

Solfège systems fall into a few categories:
Fixed-Do: syllables are mapped to fixed pitch classes (e.g., “Do”, always written with capitals, means concert note C). This is the norm in Romance-language countries, where the letters A-G are not normally used for note names, though they are for chords.
“Movable-do”: syllables are relative, sometimes tied to scale degrees. These are abstract note systems.

Within movable-do systems, one subtype—“tonic solfa”—is really traditional scale degrees just using the solfège syllables rather than numbers for the scale degrees.

But the system called “movable-do with la-based minor” is different: it uses the solfa syllables to represent what are effectively the (white) kal notes. This is the solfège syllable system used in the Kodaly Method, which also assigns hand signs to the kal notes.

The inventor has been unable to find any historical record of a concept equivalent to kal chords—sets of kal notes. Their absence is likely explained by the fact that, prior to the claviating keyboard, no instrument possessed diatonic transparency. Without that property, kal chords could not exist as stable, playable entities; they remained only a theoretical possibility, not something concrete and useful enough to be recognized, named or recorded.

### (Notational Power of Kal Notes and Chords)

The intervallic stability of kal notes and chords gives them an absolute, perspective-free quality. This makes them notationally powerful: they can express a great deal in very little space. For example, any scale and a corresponding chord palette can be specified in just two short lines. Note that chord palettes, like an artist's choice of colors, are matters of selection and context. Representative palettes nevertheless stand out as common practice, and the following examples show such minimal palettes, each capped at four chords for clarity.

### Major

scale: kal C, D, E, F, G, A, B
palette of chords: kal C, F, G, Am

### Minor

scale: kal A, B, C, D, E, F, G
palette of chords: kal Am, Dm, Em, C

### Major Blues

scale: kal C, D, E♭, E, G, A
palette of chords: kal C7, F7, G7

### Minor Blues

scale: kal A, C, D, E♭, E, G
palette of chords: kal A7, D7, E7 (note: dominants, despite the Minor scale)

### Mixo (Rock)

scale: kal G, A, B, C, D, E, F
palette of chords: kal G, F, C, D

### Dorian (Jazz)

scale: kal D, E, F, G, A, B, C
palette of chords: kal Dm, G, F, C

### Minor Pentatonic (Rock/Soloing)

scale: kal A, C, D, E, G
palette of chords: kal Am, Dm, G, C

The kal expressions above are crisp and unambiguous: they need no further clarification and musicians can use them as is. Chords of any complexity can be used, and kal chord notation is consistent with any chord notation. By contrast, the traditional Roman numeral system suffers from different conventions for how scales and chords should be expressed. Depending on the chosen framework, the same chord or interval can be written in different ways, leading to ambiguity and potential confusion.

One example illustrates the problem. In Mixo, the scale degrees are often labeled as if the mode were a variant of Major. As a result, the seventh degree is shown as “♭vii,” and the chord built on it as “♭VII.” To the learner, this looks exotic—an accidental departure from Major—when in fact it is simply an ordinary part of the mode.

Historically, Roman numeral practice—and similarly, staff representation and key signature—has tended to shoehorn the modes into the Major/Minor system, creating notations that suggest unusual alterations. Some writers do adopt a fully modal Roman numeral style—in which the seventh degree of Mixo is simply written as “VII”—but usage is inconsistent, and the learner cannot assume which convention is being applied.

In kal form, by contrast, the same structures appear in their natural, stable shapes, without the artificial sense of being exceptions. The claviating keyboard likewise encourages full respect for the actual mode. Roman numeral chords can be in a deterministic way built on top of kal chords, in a way to be explained, eliminating any ambiguity. In Mixo, when it is not under disguise as Major, what traditional notation might call “♭VII”—and which looks exotic and appears non-diatonic—is simply “VII”, appearing both ordinary and diatonic as it should.

Because of this historical tendency toward modal shoehorning on the staff, a kal-converting score utility ideally should include a user-settable mode option which might be best left on by default. This mode would allow the system to detect when notation has been ‘shoehorned’ through the Major/Minor lens and automatically correct it, ensuring that the mode is represented faithfully and playing is easier, with no unnecessarily odd chords like the ♭VII.

### (Interplay of Kal Notes and Scale Degrees)

While the kal notes can be plotted on the intervallically-spaced layout, the scale degrees cannot—because scale degrees lack intervallic stability, and that layout enforces it. However, scale degrees can be placed to good effect on the piano-schematic layout alongside the kal notes. Arabic numerals are used here for the scale degrees. FIG. 17 is an example of such a diagram, and is the same as FIG. 16 except that an inner 7-sided polygonal annulus representing the scale degrees is placed inside and concentric with the outer annulus. This inner annulus can be conceived as a knob that can be rotated, snapping into positions where a given scale degree aligns radially with a kal note. The word ‘kal’ in the center of the diagram is integral to it, indicating according to convention, that the token ‘kal’ is implicit on all note name tokens.

In the configuration shown, scale degree 1 is aligned with kal C, which represents the Major mode. If the heptagonal “knob” of scale degrees is rotated two settings clockwise, the 1 aligns with kal A, and the diagram will then represent the Minor mode.

For adaptive players—particularly those working toward fluency in jazz keyboard—the concepts of scale degrees and the chords built upon them are fundamental. On the claviating keyboard, all purely modal scales remain mapped to the white keys regardless of musical key. What distinguishes one mode from another is not the fingering pattern but the mapping of scale degrees onto those same white keys.

The dropping key in claviation plays a central role: it establishes and continually reinforces which white key functions as the tonic, and therefore as scale degree 1. This provides a stable, physical anchor for the learner's tonal center. Conceptually, claviating into a new mode is like rotating a knob: scale degree 1 aligns with the dropping key, so the moment of pressing the dropping key is analogous to letting the knob snap to alignment in its destination after twisting it.

Changing key is an important musical event, and the KALC Framework is structured to cultivate the player's understanding of it. Recall that within the KALC Framework, every claviation is concluded by noting the scale—a practice in which the performer identifies the resulting scale degrees after the transposition, thereby knowing both the mode and where the scale runs on the keyboard. Recall that while in its mature form this practice is mental only, an augmented variant done in practice only involves not merely noting but running the scale itself. This can be extended further: as the student runs the scale, they also sing the scale degrees in pitch—or, as will be explained shortly, alternatively the kal notes in syllabified form-taking their pitch reference directly from the smart-tuned keyboard. This augmented practice strengthens the mapping between abstract notes (whether kal or scale degrees) and fixed physical anchors, deepening both recognition and fluency. For example:

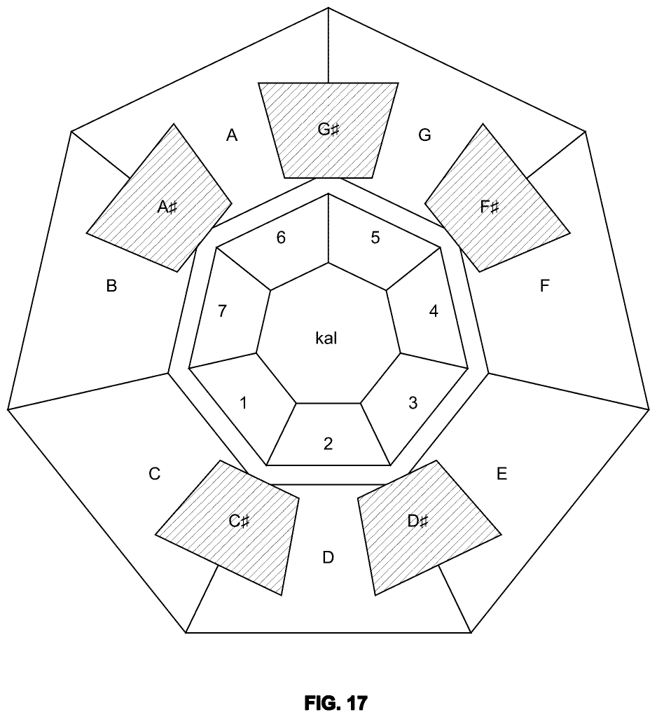

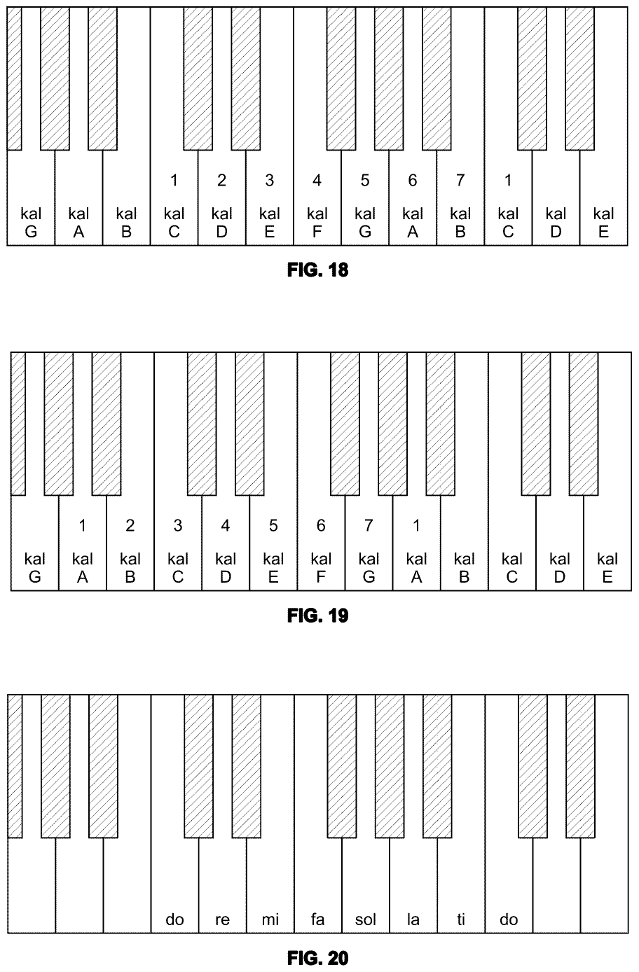

When smart-tuned into a Major key—whether by kal signature or kal key change—the sung scale degrees during a run appear as illustrated in FIG. 18.

When smart-tuned into a Minor key, the same white physical keys are used, but the degree assignments shift as shown in FIG. 19.

And so on for all 7 modes. This illustrates the dual identity of the white keys on a claviating keyboard: C
As kal notes, they remain fixed and stable.
As scale degrees, their identity shifts with the mode, enabling a direct and embodied way to perceive modal variation.

In jazz pedagogy, harmonic progressions are traditionally expressed using Roman numeral scale degrees or chord functions. On the claviating keyboard, kal chords can be treated as direct proxies—or aliases—for these Roman numeral chord functions, provided they are understood within the framework of a particular mode. In this sense, players effectively “play the Roman numeral chords” directly on the instrument.

Critically, claviation removes the disruptive variability caused by root-note changes. In conventional training, recognition of chord functions is fragmented by 12 root note variants (or, equivalently but stated differently, key signature variants), each multiplied across the modes. By contrast, on the claviating keyboard recognition is disrupted only by the change of mode, while the effect of root-note changes is normalized away. For learners—especially those beginning in the common Major and Minor modes—this reduction is profound, making functional harmony far more accessible.

On a claviating keyboard with a traditional piano-style layout, the majority of jazz chords become physically simple, because most are diatonic. On the claviating keyboard this means that the vast bulk of chords can be played using only the white keys. This invites a streamlined system of chord notation tailored for claviation in jazz, one that aligns with the functional framework of jazz harmony while greatly simplifying the learning curve for beginners. The details of this simplified notation are set out in the following section.

### (Syllabified Kal Note Names)

The prescribed noting-the-scale step after a claviation, as described above, can also be used to reinforce either the scale degrees or the “syllabified kal note names” themselves, by singing them. In this variant, solfège is applied, introducing a syllabic modality of kal note reinforcement.

The use of a single-syllable kal note naming system, such as solfège, is highly advantageous. Syllables selected for distinctiveness, as in solfège, avoid ambiguity; and because they consist of a single syllable, they can be fitted to any note without creating rhythmic confusion. This explains their longstanding popularity for singing and makes them well-suited for integration with claviation. They are mapped below to their historical norm in the system described earlier, solfège with moveable do and la-based minor.

| kal C | kal D | kal E | kal F | kal G | kal A | kal B |
|---|---|---|---|---|---|---|
| do | re | mi | fa | sol | la | ti |

In the ABC Regions, the KALC Framework prescribes the above assignments as default. (For those in Do-Re-Mi Regions, note the use of the lowercase letters.) Well-established sharp and flat forms are also used. To illustrate the sharp forms, chromatic ascent is expressed as:
do-di-re-ri-mi-fa-fi-sol-si-la-li-ti-do.

To illustrate the flat forms, chromatic descent is expressed as:
do-ti-the-la-le-sol-se-fa-mi-me-re-ra-do.

Note that since these syllables are regarded as explicitly kal in perspective, they do not need a ‘kal’ prefix and without it they can be used as part of a verbalization (and therefore name) of a kal key change. The following are examples of words said by a teacher using these verbalizations in a noun form representing a kal key change, as part of an instruction to a student to execute the kal key change kal A Dorian, at various levels of verbosity and with and without octave-specificity:
‘Execute a pick la drop on Dorian's home’
‘Execute a la Dorian.’
‘Execute a pick la5 down drop on Dorian's home.’
‘Execute a la5 down Dorian.’

As an illustration of altered kal notes (black kal notes) used in a kal key change, kal E♭ Major may be expressed in syllabified form as me Major. Its enharmonic equivalent, kal D # Major, is expressed as ri Major.

In Do-Re-Mi Regions, where fixed-do solfège is already employed for general note names, the single-syllable kal note names are usable, but cannot be regarded as explicitly kal perspective, which means that they can't be used alone in the name of a kal key change, and instead, key change names such as kal Sol Major are applied. While this convention does not generally create difficulties, it introduces limitations when applying the hybrid kal signatures technique discussed later. Suggested resolutions are provided in Appendix section C.4 (“Regional issues with syllabified kal note names”).

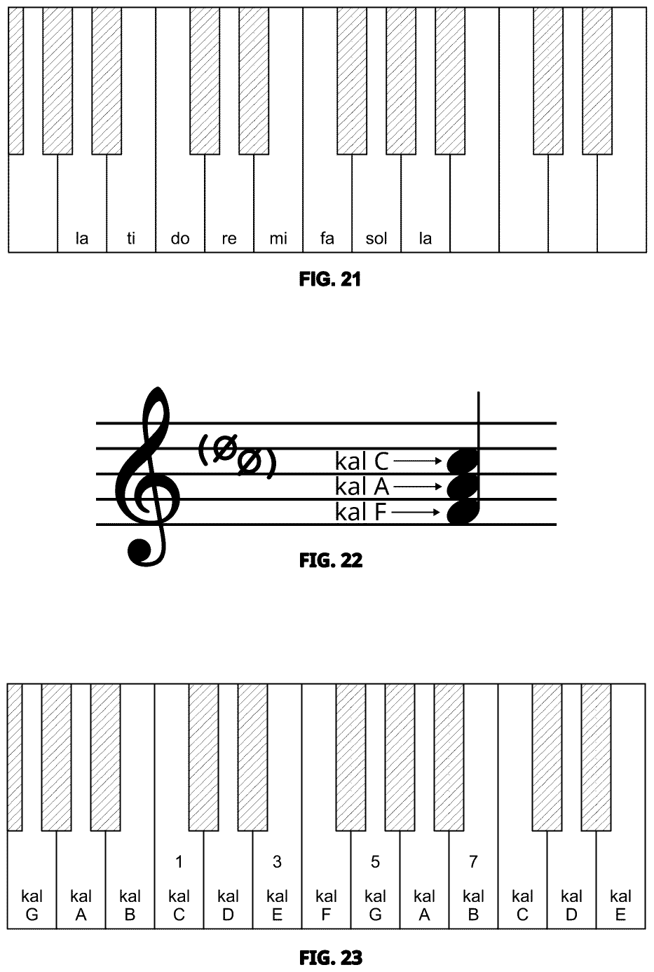

FIG. 20 illustrates an example of the mapping of syllabified kal note names to the keys of the instrument, shown as a Major scale run. FIG. 21 shows the same mapping represented as a Minor scale run. The identity of the mapping in both cases demonstrates the principle of diatonic transparency.

This practice extends naturally: the singing of syllabified kal notes can also accompany the playing of melodies, further strengthening recognition and internalization of kal notes through their syllabic cognitive anchors. In this way, it builds a direct and intuitive bridge between solfège syllables and the fixed physical keys of the claviating keyboard, and also opens up pathways between language systems in the brain, motor systems, and abstract musical logic.

The development of a fluent syllabic language for the kal notes is very advantageous especially for adaptive players, especially if they want to use the claviating keyboard as a bridge to learning to improvise on the acoustic piano, using the technique to be described shortly in section B.4 (“Hybrid kal signatures—an easier learning path for improvising on acoustic piano”).

### (Full Syllabification)

“Full syllabification” refers to the combined use of syllabified note names (described earlier) together with “syllabified mode names” (introduced here).

A syllabified mode name designates the mode according to the syllable of the kal note that shares its home key. For example, do-mode corresponds to Major, and la-mode corresponds to Minor. The table below shows the mapping across all seven modes:

| | kal note | | | | | | |
|---|---|---|---|---|---|---|---|
| | kal C | kal D | kal E | kal F | kal G | kal A | kal B |
| | do | re | mi | fa | sol | la | ti |
| mode | do-mode | re-mode | mi-mode | fa-mode | sol-mode | la-mode | ti-mode |
| | (Major) | (Dorian) | (Phrygian) | (Lydian) | (Mixo) | (Minor) | (Locrian) |

Full syllabification is very useful for the technique of hybrid kal signatures to be explained later.

### B.2.3 Summary of Diatonic Transparency: Keyboard and Staff Become Powerful Teaching Aids

Since almost all tonal music—as measured by what is listened to—is diatonically based, diatonic transparency is in a real sense musical transparency. Kal notes and kal chords, true elements of meaning, are revealed and reinforced. Reinforcement and internalization of kal notes is already recognized as a pedagogical value in established systems such as the Kodaly Method. On a claviating keyboard, this reinforcement occurs naturally: the keyboard itself becomes a teaching aid.

Kal scores likewise embody diatonic transparency. Kal notes map to stable staff positions, and kal chords appear with consistent shapes, enabling recognition of chords and perception of their function. For example, the chord kal F in root position is shown in FIG. 22—which is the only way in which the subdominant chord appears in Major mode in the applicable octave.

The kal signature shown in the FIG. 22 is randomly chosen as D Major, but kal F occupies the same position in every key. In the same way, the blue note (not shown) assumes a stable, recognizable position on the staff in each octave. Just as on the keyboard, its location is fixed and undisrupted by changes in root note, making it reliably identifiable.

Through this diatonic transparency, students learn to recognize kal notes and chords—and their functions—consistently across both keyboard and notation. At the same time, they experience music-making itself as “playing the kal notes” and their chords, reinforcing musical meaning through stable physical and visual anchors. For improvisers, practicing in this way—uttering the syllabic names of the kal notes as they play—provides direct preparation for the technique of hybrid kal signatures, explained later. As a result, when they choose to extend their improvisation to the acoustic piano, they face a substantially reduced Total Multikey Overhead.

### B.3 A Further Look at Advantages for Jazz Players

### (Diatonic Chord Palettes in Jazz and in Claviation)

Jazz students on the traditional keyboard are typically taught using Roman numeral chord functions. The character of the chord is integrated into the symbol: major chords in uppercase, minor chords in lowercase, and further alterations indicated as needed. In jazz, the seventh is assumed by default and often omitted from the shorthand.

Thus, the chord palette of a given key is usually presented in Roman numerals. For each scale degree there is a prevailing chord, and its quality is built into the notation. For Major mode, for example, the system can be summarized as follows:

| | Scale degree of root | | | | | | |
|---|---|---|---|---|---|---|---|
| | 1 | 2 | 3 | 4 | 5 | 6 | 7 |
| Jazz | I | ii | iii | IV | V | vi | viiø |
| shorthand | | | | | | | |
| Full | Imaj7 | iim7 | iiim 7 | IVmaj7 | V7 | vim7 | viim7♭5 |
| Roman | | | | | | | |
| numeral | | | | | | | |
| notation | | | | | | | |
| kal | kal Cmaj7 | kal Dm7 | kal Em7 | kal Fmaj7 | kal G7 | kal Am7 | kal Bø7 |
| chords | | | | | | | |

(Note: “Bø7” is shorthand for B half-diminished 7, i.e. Bm7♭5.)

If we fold these chords down to their triadic cores, we find only three types: major, minor, and diminished. Adding sevenths introduces distinct tetrad types, yielding four seventh chord types in total:
Major seventh (Maj7): roots at scale degrees 1 and 4.
Minor seventh (m7): at scale degrees 2, 3, and 6.
Dominant seventh (7): at scale degree 5.
Half-diminished seventh (m7♭5): at scale degree 7.

Traditionally, students are taught to understand these four chord types first which involves theory of major and minor chord types, as well as seventh chord types.

But on the claviating keyboard this is not necessary—they can sidestep learning the types and their theory by learning only their shapes (in root position), and all of their shapes are as simple as possible and the same. The traditional piano layout privileges diatonic notes in the favored keys (C Major, A Minor), which has the favorable effect of making all of the simplest diatonic tetrads have the same shape, which shape we will name as follows:
Definition. As used in this specification, the term “minimal tetrad shape” means the configuration of four played physical white keys, each separated by a single unplayed white key.

The shape of the chord kal Cmaj7 shown in the following diagram has the minimal tetrad shape. No mode or scale is implied in the diagram: the physical keys of the chord are shown selected by having a number on them, and the number is the traditional number given to the respective note in the chord—notating that the chord is in root position—not a scale degree:

For example, in C Major all seven diatonic chords (Cmaj7, Dm7, Em7, Fmaj7, G7, Am7, Bø7) are realized using the same minimal tetrad shape, displaced to the appropriate root. This uniformity eliminates the need to learn multiple hand-shapes for diatonic chords: a single canonical form can be reused across the entire palette.

On the claviating keyboard, the uniformity of the chords of the C Major scale is transferred to all scales, and this uniformity is especially advantageous in jazz. Even beginners can begin directly with seventh-chord playing in any key, without prior theoretical knowledge. Yet while the geometry is simple, traditional notations (Roman numerals, functional symbols, etc.) remain relatively complex.

To align notation with geometry, the KALC Framework introduces a new class of chords called “psan chords”. Pronounced like “san,” psan is a coined blend of the Greek psilos and Latin sanus, both meaning “pure” or “simple.” In jazz contexts, psan chords default to seventh chords, consistent with jazz convention; outside jazz they typically denote triads. In all cases, psan chords represent the purest, simplest forms of diatonic harmony.

On the claviating keyboard, a psan chord in root position is always realized by striking every other white key over a span of seven keys, producing a total of four played keys. For example, C psan, which can be abbreviated to Cp, is shown in
FIG. 23—The minimal tetrad chord shape shown in the chord:

$$C psan = kal CMaj 7 = Cp$$

The figure uses the traditional numberings of chord elements, for example, 3 is the chords ‘third’, not scale degree 3.

The term “psan chord” can be defined in two equivalent ways-one musical, suited to formal use, and one geometric, suited to learning on the claviating keyboard:

Where X is any of A, B, C, D, E, F, or G:
Musical definition: X psan is the diatonic seventh chord with kal X as its root.
Geometric definition: X psan is the chord formed in root position by applying the minimal tetrad shape on the claviating keyboard with kal X on the leftmost played white key of the shape.

For convenience in notation, X psan may be abbreviated “Xp”. Note also that the kal perspective is built into the definition of psan chords, so no kal prefix is needed to qualify them. Being shown a root on any white key representing kal note X, a beginner is very easily taught how to form the psan chord there in root position.

This definition establishes the entire set of psan chords. For example, D psan, written simply as Dp, corresponds exactly to kal Dm7. For good measure the shape of D psan (Dp) in root position, also illustrating its minimal tetrad shape is illustrated in:
FIG. 24—The psan chord shape (minimal tetrad chord shape:
Example: D psan (Dp).=kal D, F, A,

Again, the numbers in this figure are the traditional numbers of the notes of the chord relative to the chord, not scale degrees.

Note also that psan chords are sets of kal notes and therefore are kal chords, abstract chords and are intervallically stable as kal notes are.

### (Caveat on Psan Chords)

A caveat about psan chords is that ‘psan’ or the notation Xp (for example, Ap, where the root is A) does not designate a chord type analogous to “major,” “minor,” “minor seventh” or any other quality; it simply denotes the psan form derived from the minimal tetrad shape. Psan defines being a member of a set, but does not indicate that all of the set have the same harmonic properties. The harmonic nature of Ap derives from kal A, at its root: the nature of Cp, is entirely different, based as it is on kal C, which has an entirely different relationship to the rest of the kal notes as kal A does.

Accordingly, psan chords are not intertransposable types. For instance, one cannot transpose Cp into Ap, because psan designates a structural form derived from the minimal tetrad shape, not a harmonic quality. By contrast, a chord type such as Cm7 can readily transpose to Am7, since “minor seventh” is a defined quality that persists under transposition. This distinction is central to the usefulness of psan notation—much as in Nashville notation, where scale-degree roots define chord sets that likewise do not intertranspose directly.

### (KALCville Notation)

The purpose of scale degrees is to expose commonalities between different scales and modes. In the KALC Framework, players are encouraged to note scales both in kal syllables and in scale degrees, so that at any time in any mode they have access to both perspectives.

Psan chord notation takes advantage of the fact that on the claviating keyboard in piano layout, all diatonic seventh chords share the same minimal tetrad shape. This collapses a family of complex chord types into a single geometric form. The most important chords are thereby simplified both in shape and in notation.

However, kal chords in themselves do not show the underlying unity and patterns between Major and Minor modes. For example, the jazz “2-5-1” (ii-V-I) is crucial in both modes, and in some details its expression looks different in traditional Roman numeral notation: ii-V-I in Major, but iiø-V-i in Minor—but clear commonality is expressed also in the numeral, exposing the pattern. To reveal such commonalities, the KALC Framework provides a specialized notation called “KALCville notation”. The ‘ville’ part of the name comes from Nashville notation, with which it shares similarities.

### (Primary Chords in KALCville Notation)

The table below shows the primary chords in KALCville notation, covering all scale degrees in both Major and Minor modes. The table is defining all of the chords named by the symbols in the second row. 1p is read ‘1 psan’. Note that as the bold shows, where a 5p might be expected, the pattern is deliberately broken and this one is only ‘5’, which represents dominant 5^{th}, not 5 psan:

Jazz primary seventh chords Major and Minor

| | Scale degree on which chord's root lies | | | | | | |
|---|---|---|---|---|---|---|---|
| | 1 | 2 | 3 | 4 | 5 | 6 | 7 |
| Chord in | 1p | 2p | 3p | 4p | 5 | 6p | 7p |
| KALCville | | | | | | | |
| notation | | | | | | | |
| kal chord | Cp | Dp | Ep | Fp | Gp | Ap | Bp |
| in Major | | | | | | | |
| mode | | | | | | | |
| kal chord | Ap | Bp | Cp | Dp | kal E7 | Fp | Gp |
| in Minor | | | | | | | |
| mode | | | | | | | |

In KALCville notation, whether for Major or Minor mode, the primary chords covering all scale degrees are:
1p, 2p, 3p, 4p, 5, 6p, 7p.

As shown in the table, these provide a complete palette of diatonic seventh chords in both modes, all with a uniform simple shape, with the single exception that the chord notated as “5” is in Minor mode alone not a psan chord but the altered kal E7, which is the same as Ep except that it has the ‘3’ of the chord sharpened. The ‘5’ KALCville chord is defined not through the psan shape but as the dominant seventh. In Major mode, it happens to have the psan shape also: in the cell which lists Gp, for Major mode, kal G7 is an equivalent alternative.

### (Core Progressions in KALCville Notation)

In KALCville notation, the most important progressions are expressed with striking simplicity both on the keyboard and in notation:
“The 2-5-1” is represented as: 2p-5-1p
“The 5-1” is represented as: 5-1p

This directly parallels Roman numeral notation (ii-V-I in Major, iiø-V-i in Minor), but without the need to distinguish chord types or modes. KALCville notation shares this simplicity with Nashville notation—indeed, the “ville” suffix in its name is drawn from Nashville for this reason. The result is a notation that reveals the structural unity between Major and Minor progressions at a glance. Like a single consistent Roman numeral system, it is fully deterministic and carries no ambiguity.

### (Significance for Learners)

The 2-5-1 progression forms the backbone of much of jazz. It is valuable for at least two reasons:
1. It is musically pleasing in itself and can be used independently of key changes.
2. It is an excellent formula for establishing a new key: a 2-5-1 in the upcoming key very reliably entrains the ear to the new key, and even the reduced form, the 5-1, is effective.

Accordingly, in a relatively short time, beginners can be positioned to:
1. Improvise within a key using the complete palette of diatonic seventh chords in both Major and Minor.
2. Navigate common key changes, both within and between modes, using two compact palettes of kal key changes.
3. After a kal key change, establish the new key by applying the 2-5-1—or in simplified form, the 5-1—in either mode.

All of this is possible without requiring prior theoretical study. It is strikingly easy to learn, in no small part because almost every chord involved is realized with the same minimal tetrad shape. The sole exception is kal E7, which differs only slightly from this shape by introducing a sharpened third.

The relative power to improvise granted to beginners by the claviating keyboard—supported by KALCville notation—has never before been possible. Its availability to novices is both unexpected and striking.

(why this Striking Ease in Jazz Arises)

This striking ease arises because:
1. The traditional keyboard is geometrically designed so that physical space is not mapped uniformly to pitch space. This asymmetry favors the diatonic notes in the “empty” key signature and makes them especially prominent and accessible.
2. The same non-uniformity creates the burden of Total Multikey Overhead when departing from those favored keys.
3. The claviating keyboard restores to every key the ergonomic quality that previously belonged only to the favored ones.

Note that isomorphic keyboards do not provide shape uniformity for psan chords. With the introduction of claviation, there thus arises one dimension in which the traditional keyboard gains an ergonomic advantage over isomorphic keyboards.

### B.4 Hybrid Kal Signatures—an Easier Learning Path for Improvising on Acoustic Piano

### Groundwork—Key Signature as a Mechanical Entity on the Claviating Keyboard

Recall that as used in this specification, a “key signature” can be regarded as an entity that lives on the physical keys of a keyboard. Key signatures in this sense define which notes are unaltered, enabling efficient representation of different tonalities, and they have corresponding notational forms. On the claviating keyboard, however, such key signatures disappear in normal use.
In the hybrid kal signature regime of practice, key signatures can again be said to “live” on the physical keys of the claviating keyboard. To avoid confusion, these are termed “mechanical key signatures.” In general they have no inherent connection to the musical key in concert pitch, because the staff is transposing in a general way.
This terminology is deliberate: in traditional music, tonal constructs are usually named in tone space rather than after physical features of instruments. The claviating keyboard, as a variably transposing instrument operating under the kal system and a smart-tuning policy, bridges this gap between tonal and physical space. Kal chords, for instance, are both abstract tonal structures and concrete physical entities on the claviating keyboard. Mechanical key signatures serve an analogous role: they represent key signatures as physical entities on the instrument. Unlike traditional key signatures, they are not inherently tied to specific musical keys, just as kal chords are not tied to a specific tonality. Because musicians are accustomed to “key signatures” being rigidly tied to particular keys, the qualifier “mechanical” is very helpful for avoiding confusion.

### (Target Mechanical Key Signatures in a Kal-Converting Utility)

The normal way to play the claviating keyboard is with the empty key signature. Indeed, avoiding non-empty key signatures is one of the principal purposes of claviation. Paradoxically, however, the claviating keyboard can be used to great effect with key signatures when the goal is to prepare for another keyboard—such as the acoustic piano—where key signatures are unavoidable—especially for adaptive players. This preparation is achieved through a learning technique called “hybrid kal signatures”. The technique shares its name with a hybrid variant of the kal signature that appears in the score when the staff is used to guide the technique. Adaptive players, however, generally apply the technique without relying on the staff. Nonetheless, presenting it in staff-guided form is useful, since it provides the most rigorous way of explaining its operation.

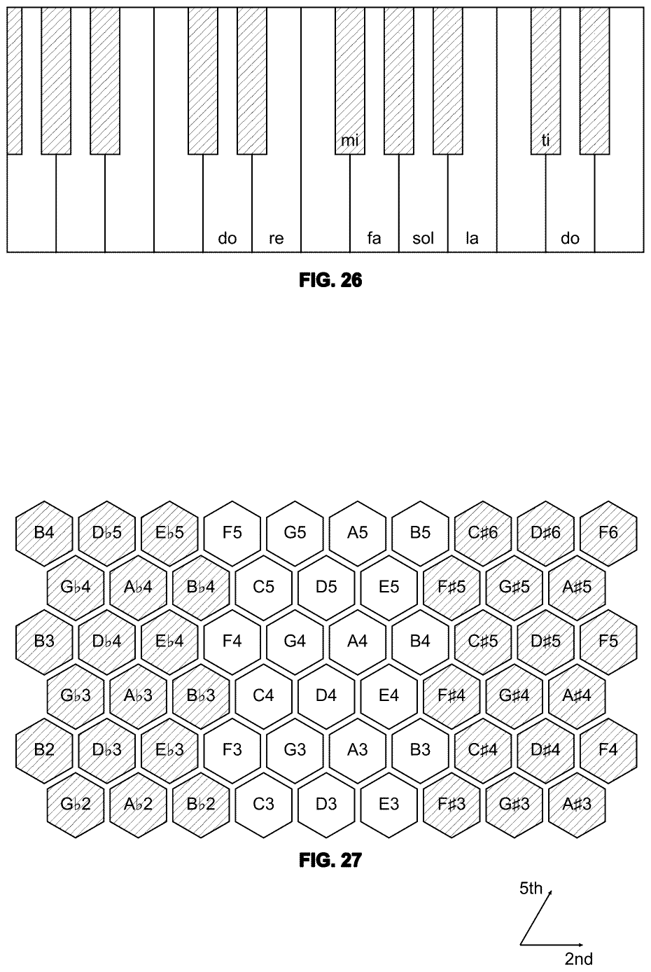

Recall that “smart-tuning” in this specification is used by default in the narrow sense: transposing so that the instrument plays as if in a key with the empty signature. In broader musical practice, however, smart-tuning means transposing the instrument to play as if in whatever key signature is easiest for the performer. This need not be the empty signature. Suppose, for example, a player has learned a piece in D Major but must perform it in G Major. Rather than smart-tune in the narrow sense (to C Major), they may smart-tune in the broader sense so as to play as if in the D-Major key signature they already know how to play the piece in. In that case, they are smart-tuning to the mechanical key signature of D Major. FIG. 26 illustrates the mechanical key signature of D Major. Their playing in that mechanical key signature says nothing about the actual key they are playing in.

Recall that a kal-converting utility is software that takes traditional scores in digital form and outputs them as kal scores. It can easily be generalized to support target non-empty mechanical key signatures. Interface-wise, the target mechanical signature simply becomes an input parameter, defaulting to empty. Implementation requires only two adjustments relative to the empty-signature case:
1. Modes' homes change. For example, in the mechanical key signature of G Major, the home of Major shifts to G, while the home of Minor shifts to E. The mode's home shifts from being the physical key starting from which the mode can be played purely on white keys, to that from which it can be played on purely unaltered notes—not necessarily on white keys, but honoring the key signature.
2. “Hybrid kal signatures” appear on the staff. Instead of a plain kal signature at the start of the piece, the output shows a hybrid kal signature (described below). Kal key-change marks remain identical in appearance, but the location on the staff generally changes depending on the target mechanical signature.

A “hybrid kal signature” consists of two parts placed side by side on the staff:
The mechanical key signature, shown in conventional notation (sharps or flats).
The corresponding kal signature, immediately to its right.

Sight-readers fluent with both conventional key signatures and claviation signatures can learn to execute hybrid kal signatures almost instantly. The rules for reading a hybrid kal score are nearly the same as for a regular kal score, except that the mechanical key signature indicated must be honored in the keypresses used for claviation—for both picking and dropping keys—in the same way as it is for regular notes.

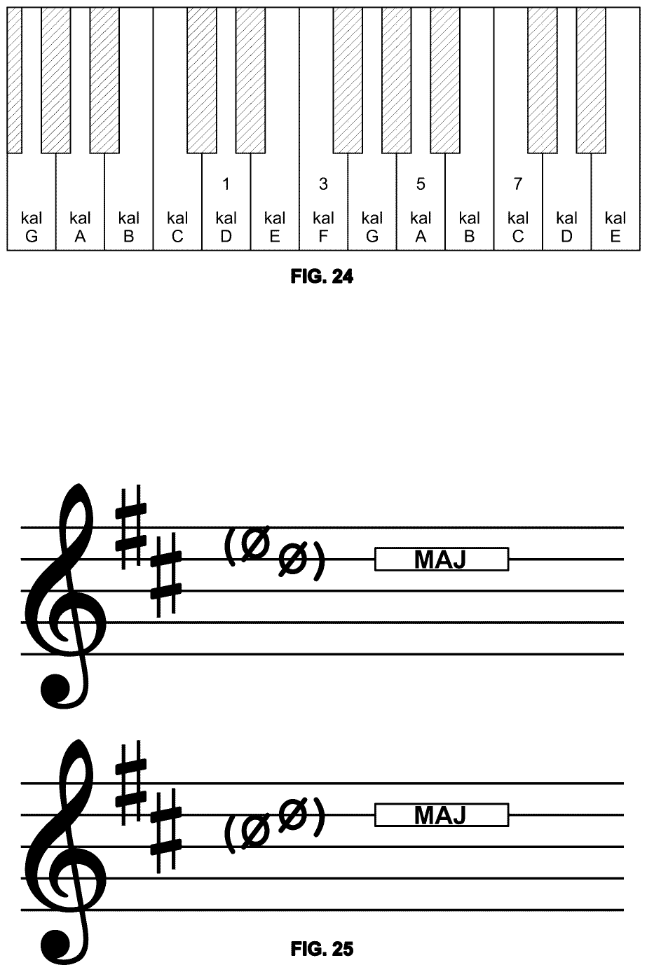

For illustration, FIG. 25 show two hybrid kal signatures on two staves one above the other, both with the mechanical key signature of D Major. The appropriate Major home line is marked for clarity with a rectangular label, which as before is a label overlaid on the diagram (‘MAJ’ for ‘Major’), and is not part of the score itself. In this case it rests on the staff line of physical D and labels it Major.

The hybrid kal signatures are
One (upper) for the key of E Major, on the left, verbalized as:
   Pick E5 down drop on Major's home [D]
One (lower) for the key of C # Major, on the right, verbalized as:
   Pick C #5 up drop on Major's home [D]

Note that in the lower staff the claviation mark indicating “Pick C #5” is not explicitly marked with a sharp, because this information is already conveyed by the key signature to its left. The key signature must be honored for claviation marks just as it is for notes. By contrast, if this kal signature were intended to smart-tune to C Major instead, the mark would be identical except that the picking mark on C5 must carry a natural sign, to override the sharp of the key signature.

### (Overview of the Technique of Hybrid Kal Signatures)

The technique of hybrid kal signatures provides a structured path for adaptive learners to use a claviating keyboard to overcome Total Multikey Overhead on an acoustic piano and gradually extend their fluency to all mechanical key signatures.

A kal-converting utility can, in principle, take the score of any piece, in any key, and render it as a hybrid kal score with any chosen target mechanical key signature. The performer can then play the piece as if it were written in that target signature, handling general key changes during play through ordinary kal key changes. This demonstrates rigorously that hybrid kal scores are always constructible, since the process follows deterministically from the method of generating kal scores.

However, adaptive players need not depend on such utilities or even on written scores. Once they learn the technique of hybrid kal signatures, they can apply it directly: projecting their existing kal knowledge into new mechanical key signatures, calling out the syllabified kal names, and treating each new signature as a fresh but related “instrument.” From there, progress is driven by practice and internalization rather than by theory.

The learning path proceeds in four stages:
1. Foundation. Achieve proficiency in improvisation on the claviating keyboard in its ordinary mode. At this stage, music is fully understood as “playing the kal notes”, a concept elaborated below.
2. Progressive internalization. Approach each new mechanical key signature in turn, projecting existing kal knowledge into its altered mapping. The claviating keyboard continues to handle key changes in real time.
3. “Cross-claviation”. Begin switching mechanical key signatures mid-play. This practice technique allows learners to insert new signature work directly into their existing repertoire without disrupting musical flow. Cross-claviation is further explained below.
4. “Unpacking claviations”. Ultimately, replace mid-piece claviations with reinterpretations of the corresponding mechanical key signatures. In this way, claviations are “unpacked” semantically rather than triggered mechanically. This prepares the player for fluent performance on non-claviating instruments. Unpacking claviations is further explained below.

A more natural progression often blends these stages: learners may experiment with unpacking while still in Stage 2, or begin cross-claviation before all signatures are mastered. Such mixing provides early access to improvisation on the acoustic piano, while full flexibility develops over time.

### (how Hybrid Kal Signatures Reduce Total Multikey Overhead)

The term “overhead” here includes not just time but also frustration, reduced enthusiasm, and other burdens that slow musical development. Even if twelve signatures must ultimately be internalized, the hybrid approach reduces overhead by restructuring the learning process. Three advantages stand out:
1. Staged progression and autonomy. One new signature is learned at a time, with each building directly on the last. This enables steady confidence and minimizes disruptive leaps.
2. Diatonic transparency. On the claviating keyboard, learners understand their playing as manipulating kal notes and chords directly. Later, they simply remap those syllables to new positions. This perceptual-creative enablement allows knowledge gained on the claviating keyboard to eventually project smoothly onto the acoustic piano. An underlying principle which can be explained in a way shown to be common sense is that ‘skill formation before disruption beats disruption during skill formation’, which is elaborated further below.
3. “Cross-claviation” efficiency and autonomy. Because passages can be replayed or extended immediately in another signature without altering their sound, “cross-signature polishing”, enabled by the technique of “cross-claviation”, becomes fluid and exploratory. With this technique, a player can address a weakness the moment it arises, immediately explore the corresponding mapping in key signatures they already know well, and reinforce the new mapping in context. This efficiency is coupled with autonomy: practice can be self-directed, flexible, and responsive to the learner's needs at any moment.

### (Groundwork—Kal Identity of Notes)

Groundwork—all Notes have a Definite Kal Identity, Given by Key Signature and Staff Position
In the context of a piece of music within a diatonic framework—which is always in play when there is a meaningful, non-arbitrary key signature—every note has a definite kal identity. We know this because it can be read from a kal score for that piece, and the creation of a kal score for a piece is deterministic.
It is worth emphasizing that in a piece in the key of G Major, whose key signature is one sharp, the note con G is kal C. This means that on a traditional staff, the positions on the staff do not have fixed kal notes.
The same is true in a hybrid kal score, while it is false on a regular kal score. But it is not difficult to show that the kal note at a given staff position is determined solely by the mechanical key signature. Therefore on a hybrid staff, with a mechanical key signature of G Major, a note on the position of concert G on the staff, is similarly kal C.

### (Progression Through Sharp and Flat Signatures)

After the very strong foundation stage, learners will typically proceed through signatures in order of increasing difficulty, but at each stage may choose to advance along either the sharp or flat sequence shown in tables below. Each table (sharp, flat) orders signatures by hardness—the number of altered kal notes. The empty signature is treated as a degenerate case of “zero sharps” or “zero flats.”

In every step downward, two changes occur relative to the nearest easier signature:
1. The kal notes shift position.
2. One additional kal note becomes sharped or flatted, as shown in the tables.

Fully syllabified naming is preferred because in this technique kal notes shift position on both keyboard and staff. In the ABC Region, syllables prevent confusion from alphabetic letters appearing in unusual places: the letters remain stable anchors, while the itinerant versions of the notes are tracked syllabically.

Thus each new signature is essentially the previous instrument with a single additional twist, making the overall progression systematic and incremental.

Note that the kal notes in the table are given in syllabified form.

| Sharp | kal notes |
|---|---|
| notational | played |
| key signature | through a |
| (labelled as | sharp on the |
| for Major key) | key signature |
| C Major | (none) |
| G Major | ti |
| D Major | ti, mi |
| A Major | ti, mi, la |
| E Major | ti, mi, la, re |
| B Major | ti, mi, la, re, |
| | sol |
| F [symbol] Major | ti, mi, la, re, |
| | sol |
| C [symbol] Major | ti, mi, la, re, |
| | sol, do |

| Flat | kal notes |
|---|---|
| notational | played played |
| key signature | through a flat |
| (labelled as | on the key |
| for Major key) | signature |
| C Major | (none) |
| F Major | fa |
| B [symbol] Major | fa, do |
| E [symbol] Major | fa, do, sol |
| A [symbol] Major | fa, do, sol, re |
| D [symbol] Major | fa, do, sol, re, |
| | la |
| G [symbol] Major | fa, do, sol, re, |
| | la, mi |
| C [symbol] Major | fa, do, sol, re, |
| | la, mi, ti |

### (Adaptive Practice in Hybrid Kal Signatures)

An adaptive player, especially in jazz, should internalize syllabified kal notes at every opportunity: naming notes, chords, modes, scale degrees, and key changes consistently in syllabified form. Daily practice includes singing, syllabification, and a set of drills that reinforce and test chord palettes, kal key-change palettes, and scales of interest.

When entering a new signature—for example, moving from G Major to D Major—the essential step is to run a scale in the new mapping while calling out the syllabified kal notes. From there, all drills and repertoire are migrated by simply replaying them with syllables anchored to their new positions. Kal key changes, being verbalized syllabically, carry over without additional work.

When they approach their first non-empty mechanical key signature, they treat it as if they are playing on a new instrument, one whose kal notes are arranged in an unfamiliar pattern. Suppose their first signature was G Major. For generality, let us now imagine they are moving to their second: D Major.

To advance, all they need is the ability to run a scale in the new mechanical key signature on the keyboard, while calling out the kal notes from memory. No staff knowledge or new theory is required.

Recall that FIG. 26 shows where the syllabified kal notes lie in the mechanical key signature of D Major. Consistent with the table of signatures, D Major differs from G Major in only two ways:
1. The kal notes are shifted in position.
2. One additional kal note—mi—is sharpened.

This is confirmed in the table segment:

| Sharp | kal notes |
|---|---|
| notational | played |
| key signature | through a |
| (labelled as | sharp on the |
| for Major key) | key signature |
| G Major | ti |
| D Major | ti, mi |

Note that the newly sharpened kal note (mi) does not appear in the same physical place as in the earlier signature—it is shifted as all kal notes are.

### (The Technique of “Cross-Claviation”)

Ordinarily, claviation is employed solely for smart-tuning: the performer triggers a claviation to set the instrument to play as if in a different musical key. “Cross-claviation” is distinct. It is used only within the technique of hybrid kal signatures, and it is not a form of smart-tuning. Instead of changing the musical key through smart-tuning, it changes the mechanical key signature under which the player is practicing-shifting from one signature to another without interrupting musical flow.

The procedure is straightforward:
Pick from the mode's home in the current mechanical signature (identified by syllabified name).
Drop onto the mode's home in the new mechanical signature (also identified syllabically).

The kal codes are immediately re-anchored to their new positions, and the passage continues without interruption. As with ordinary claviation, it is recommended to “note the scale” on the dropping key to confirm orientation.

Example. Suppose a player is practicing a piece in the key of X Major—where X is unspecified and not relevant to the illustration. They are playing it under the mechanical key signature of G Major (do-mode's home on physical G). Mid-phrase, they decide to shift into the mechanical key signature of D Major (do-mode's home on physical D) in order to get practice in that key signature. To execute this cross-claviation, they pick from physical G and drop onto physical D, then continue seamlessly, now interpreting the kal notes under the mechanical signature of D do-mode. The sound of the passage does not change—only the physical mapping does—and the player is still performing in X Major.

This has a decisive benefit. On the traditional keyboard, replaying a passage in another key is doubly disruptive: the muscle patterns change, and the sound changes. The second disruption—loss of auditory continuity—confuses the ear and breaks musical flow, so learners tend to avoid it. As a result, cross-key practice is patchy and slow to accumulate.

Cross-claviation removes the auditory disruption. Because the sound remains the same, “cross-signature polishing”—the immediate reapplication or extension of a passage in another signature—becomes natural. Any musical fragment can instantly serve as a practice drill by shifting it into a new mechanical key signature, eliminating setup costs and making practice self-directed, efficient, and continuous. The disruption is minimized because it is introduced under the learner's own control, allowing strength in the new signature to be built gradually and deliberately. Cross-claviation is not a performance technique, but as a practice method it eliminates overhead and accelerates internalization across the entire set of mechanical key signatures.

### (The Technique of “Unpacking a Claviation”)

At the final stage, claviation marks are no longer executed mechanically but unpacked semantically instead. The performer reinterprets the mark as the instruction to shift to the mechanical key signature implied by the claviation.

The conditions for its application are:
1. The performer is already in a mechanical key signature.
2. They know a kal key change to be executed
3. They “unpack the claviation” of the kal key change, and see if they can do it as a change of mechanical key signature, rather than a claviation.

In this way, the kal key change ceases to be a command to be forwarded by the player to the instrument and becomes a cue only to the performer to change key signature. The instrument remains unchanged; the player changes.
Example: A performer is playing in X Major under the mechanical key signature of D Major. They encounter a kal key change to kal G Major (which is sol do-mode when fully syllabified), whether read from a staff or chosen improvisationally. Instead of executing it, they unpack it first: reasoning that if sol (now on physical A) would normally be taken by the claviation to do-mode's current home (on physical D), then the same effect can be achieved by regarding physical A as do-mode's home. Recognizing this as the mechanical key signature of A Major, they continue seamlessly, playing on this new key signature guided by syllables—to be played in their new locations. Although the smart-tuning operation is skipped, it is still recommended that they perform the usual “noting the scale” step to confirm orientation—now playing a Major scale starting on A. In the earlier stages, the autmentation of ‘running the scale’, and singing it, is helpful for reinforcement. By unpacking in this way, the key change is carried out in the traditional manner—through a shift of mechanical key signature—so it can equally be executed on an acoustic piano.

Unpacking represents the culmination of the training sequence. It allows the performer to read kal key changes as cues for mental re-anchoring rather than physical retuning. Once all signatures are internalized, the player can improvise freely on non-claviating instruments, carrying over the same kal-based understanding that claviation first made accessible.

### (‘Skill Formation Before Disruption Beats Disruption During Formation’)

Learning improvisation on the claviating keyboard provides a strong foundation: “playing the kal notes” gives performers a stable understanding of the kal identity of notes and chords as they play. This foundation is reinforced by cognitive anchoring techniques, including singing syllables, which recruit linguistic pathways in the brain to strengthen retention.

When learners first move into a non-empty mechanical key signature, the shift is disruptive. Yet after the underlying concepts are established, the process is best understood as learning a related instrument with its own quirks. The brain treats this as translation of existing skills rather than construction from scratch.

The principle “skill formation before disruption beats disruption during formation” is intuitive. Imagine a television series that runs for twelve seasons with a consistent cast, but at the start of each new season the actors rotate once all into different roles, which then remain stable for that season. Each rotation is disruptive, yet viewers can quickly map their prior understanding of each character onto the actor who newly plays it. Contrast this with a series in which the actors rotate roles after every scene: disruption during the very process of forming understanding makes the story much far harder to follow. In the same way, forming a solid kal foundation before introducing mechanical key-signature changes ensures that disruption is both manageable and productive.

### (Summary)

Together, hybrid kal signatures, cross-claviation, and unpacking claviations form a single progressive discipline. Hybrid kal signatures provide the framework for projecting kal knowledge into new mappings; cross-claviation accelerates internalization through disruption-minimized practice; and unpacking transforms claviation itself into a skill transferable to acoustic piano when the player is ready. The result is a method that reduces Total Multikey Overhead while preparing performers for fluent improvisation across all signatures, whether on claviating or traditional instruments.

### B.5 Isomorphic Keyboard Benefits

Isomorphic keyboards feature keys arranged in a 2-dimensional grid, typically in a square or hexagonal lattice.

What is commonly called the ‘layout’ of the isomorphic keyboard can be seen as a combination of two things:
1. The “tonal layout,” which explains the mathematical relationship between the notes in a nominally infinite 2-dimensional grid of nominal keys. While the number of these possible layouts are theoretically infinite, only a small, finite subset is practical for players.
2. The “boardshape,” which is the set of points on this grid that represent physically-available keys on the actual physical board.

It serves us to give an example.

The only isomorphic layout to achieve mass production in an acoustic instrument is the Wicki-Hayden layout, which has been widely adopted in concertinas. The typical board shape, illustrated in FIG. 27, consists of alternating rows horizontal of 9 and 10 hexagonal keys, as shown in the above diagram. Each pair of rows represents one octave, and ascending an octave is achieved by moving directly upward by two rows. The above diagram therefore shows a board which supports three octaves.

The Wicki-Hayden tonal layout is defined by the interval vectors shown in the diagram: movement to the right advances by a major second (whole step), and the upward diagonal movement shown corresponds to a perfect fifth. These relationships are confirmed both by the directional arrows and by the labeled notes on the keys.

Octave numbers are written on all notes in the figure. The coloring of the keys in the diagram follows standard piano conventions: white-key notes are shown on ‘white’ (unhatched) keys, while black-key notes are rendered in gray (as hatching in the drawing)

Claviation was first developed with the recognition that this layout could offer even greater benefits—particularly if it could be made diatonically transparent. It was further realized that solving this problem would also solve the issue of edge effects automatically.

We now explain the problem of edge effects, which cause otherwise isomorphic layouts to fall short in practice.

The word isomorphism derives from the Greek roots iso-meaning “same” and—morph meaning “shape.” The advantage of isomorphism in a keyboard layout is that a given piece of music retains the same shape on the keyboard regardless of the musical key. However, this advantage can be compromised by edge effects. The easiest way to demonstrate this is by using a scale as a representative piece of music.

In command usage, scales which are modified (not purely diatonic) are given names such as A harmonic minor, but the KALC Framework prefers names such as A Minor harmonic which keeps the name of the key together (A Minor) and places the modifier after it; this is more easy to use with smart-tuning by claviation.

Consider the scale A Minor harmonic, and consider it being played without smart-tuning, starting on A3, its tonic. The sequence of notes is:
A3, B3, C4, D4, E4, F4, G #4, A4

This is the standard Minor scale altered only in that the seventh degree is raised from G to G #. When played on the Wicki-Hayden layout as the above diagram helps show, the G #4 appears in a somewhat unexpected location—below and far from F4—due to the quirks of the layout. However, this is not a flaw, merely a characteristic of this layout.

Now, because the layout is isomorphic, if one wanted to play this entire scale one whole note higher, and therefore play B Minor (harmonic) instead, shifting this fingering pattern one key to the right should produce the desired result because the keyboard is isomorphic:
B3, C #4, D4, E4, F #4, G4, A #4, B4

And, indeed, it does—A #4 appears in the expected position relative to the previous pattern, namely one step to the right. We can therefore duplicate this scale A Minor harmonic one whole tone higher, in an easy way, taking advantage of isomorphism.

We now attempt to do the same again: shift the pattern another key to the right to produce C # Minor harmonic:
C #4, D #4, E4, F #4, G #4, A4, B #4, C #5

However, B #4 is not available at the expected location, which would be immediately to the right of A #4. Its expected position is off the boardshape, beyond the physical boundary of the keyboard. Although B #4 may exist elsewhere on the instrument (and indeed it does, though under the enharmonically equivalent name C5), it does not appear in the desired relative position within the expected fingering shape. As a result, the isomorphic playability is broken.

This failure is not due to a flaw in the Wicki-Hayden tonal mapping itself. Rather, it is an edge effect—a situation where the replication of a valid and desired fingering pattern fails only because it extends beyond the physical limits—the ‘edge’—of the keyboard. While the pitch may still exist elsewhere, the desired spatial relationship is lost, and the fingering shape cannot be preserved.

One way to address this is to physically extend the keyboard, allowing for greater lateral range. However, this adds a disadvantage—it increases both the size and cost of the instrument.

Claviation, however, offers a more elegant solution—and adds diatonic transparency as well. Rather than requiring physical extension of the keyboard, claviation enables the performer to shift the musical key center while keeping their hands in the same physical location. A player using a compact keyboard can still play in all keys using the same fingering shapes, thereby eliminating the edge effect entirely. In effect, claviation restores the isomorphic affordance of the layout across the full range.

As the player smart-tunes to a new key, the active diatonic column remains centered, flanked by a sufficient buffer of non-diatonic (black) keys on either side. The result is a stable, visually and tactilely coherent playing surface. Other benefits of claviation discussed earlier also extend here—for example, dynamic just intonation becomes feasible within this layout, without additional interface complexity.

The specification was written with the traditional piano-style keyboard as the assumed model, and it identified two major advantages of smart-tuning:
1. The obvious benefit of uniform fingering across keys.
2. The lesser obvious benefit of diatonic transparency.

Yet it could be rewritten entirely using the Wicki-Hayden layout as the assumed keyboard—leading to an analogous but layout-specific set of benefits:
1. Resolution of the edge effect problem.
2. Addition of diatonic transparency.

Remarkably, very little else of the specification would need to change. The only structural alteration would be in the coordinate system used to describe the keyboard's pitch field: the current one-dimensional x-axis would become a two-dimensional vector system, consistent with the planar structure of the Wicki-Hayden layout, and Δx would be a vector. Diagrams containing keyboards would be adapted accordingly, replacing the traditional keyboard images with Wicki-Hayden equivalents—and psan chords and hybrid kal signatures would be omitted because they are no longer useful.

Otherwise remaining unaffected would be the entire KALC Framework including:
the naming conventions such as kal notes and kal chords, smart-tuning strategies, kal staff, kal key changes;
the verbalization techniques for executing and naming smart-tunings;
the pedagogical strategies.

These elements carry over seamlessly because claviation works on any musical keyboard, not a specific layout.

If using claviation on this keyboard layout, the edge effect problem described above is resolved simply by smart-tuning to C # Minor, following the method prescribed in Chapter 1. This smart-tuning can be expressed in the octave-folded perspective as:
‘Pick C # drop on Minor's home’

An example octave-distinguished realization would be:
‘Pick C #4 drop on Minor's home 4 (A4)’

As on the traditional layout, claviation on an isomorphic layout ensures that all music is played as if in the home musical key of its mode. In this case, that home musical key is A Minor. The fingering shape is preserved, and the scale remains spatially centered and diatonically transparent—completely eliminating the edge effect problem.

### (Diatonic Transparency)

An isomorphic keyboard instantly acquires the binary quality of diatonic transparency when used as a claviating keyboard. As on a traditional piano, the qualitative level of this transparency can be enhanced by kodály-ifying the keys.

In particular, with claviation the Wicki-Hayden layout offers a natural advantage: its structure enhances diatonic transparency, since the active diatonic group—the white kal notes—is already arranged as a compact, visually coherent vertical block running up the center of the board.

### B.6 Enabling Dynamic Just-Intonation

Equal-tempered tuning has always been a compromise. To the human ear, there is a mathematically ideal frequency relationship between the various kal notes in any given key. These relationships are well known, uncontroversial in principle, and are given by:
kal C: 1
kal D: 9/8
kal E: 5/4
kal F: 4/3
kal G: 3/2
kal A: 5/3
kal B: 15/8

An instrument tuned to these relative frequencies is said to be justly intoned, or justly tuned—that is, tuned in just intonation (JI).

Unfortunately, an instrument tuned this way to one key will sound increasingly out-of-tune when music is played in other keys. This is because the tuning depends on the harmonic relationships of a particular key, and those relationships do not transpose cleanly. In just intonation, semitones and whole tones are no longer uniform: some semitones are smaller than others, and the same is true for whole tones. As a result, while the intervals within a key may sound beautifully pure, modulating to a distant key can produce noticeably sour or unstable tuning. This limitation made just intonation impractical for instruments intended to play in multiple keys.

Equal temperament circumvents this problem by dividing the octave into 12 equal semitone steps—each slightly adjusted from its just counterpart. This uniformity allows music to be played in any key without retuning the instrument, but at a price: every interval is slightly compromised. No interval except the octave is perfectly in tune with its just-intoned ideal. As a result, equal temperament is always slightly out of tune in all keys—an engineered imperfection in exchange for key-flexibility.

Since the advent of electronic instruments, it has been both theoretically straightforward and practically feasible to dynamically retune an instrument—via firmware or software—for just intonation in any desired key. This has been demonstrated experimentally, often with musically satisfying results. Some listeners can clearly perceive the enhanced purity of intervals when just intonation is applied. Yet despite its feasibility and musical appeal, just intonation remains rare in commercial electronic keyboards.

A likely reason is closely related to why claviation represents a genuine breakthrough: prior to claviation, there was no standardized, intuitive way for a performer to explicitly express the intended key in real time. While it has been attempted to implement dynamic just intonation—automatically adjusting tuning based on inferred musical context—these rely on passive inference, algorithmically analyzing recent notes to detect key changes. Such systems can suffer from a critical limitation: lag. When a performer modulates to a new key, the system must first gather enough information to infer the new tonic before retuning can occur. As a result, the first several notes of the new key can be mistuned.

By contrast, a claviating keyboard allows the performer to explicitly signal both tonic and mode through the claviation gesture itself—thereby identifying the new active diatonic circlet in real time. This makes it possible for just intonation systems to eliminate tonal ambiguity and respond immediately to key changes, with no need for inference or delay.

Any implementation of claviation can thus be enhanced with a just intonation mode, guided directly by the performer's actions. This mode may be toggled manually—for example, via a dedicated switch—and automatically responds to each claviation by updating the tuning accordingly.

When this mode is activated, the pitch of each key on the keyboard is adjusted to maintain just intonation across the white keys. This retuning occurs both when the mode is first turned on and after each transposition triggered by claviation, and can be regarded as a second stage in the key-change process. Formally, this involves computing a mapping from kal notes (in octave-folded perspective) to cent offsets—positive or negative—relative to equal temperament. When the mode is off, these offsets are reset to zero for all keys.

Further refinements are possible—for example, algorithmically selecting a single specific note whose pitch remains strictly unchanged during retuning when a key change occurs mid-performance. However, such implementation details are not essential to the present disclosure. Whether these refinements are musically worthwhile, and what tradeoffs they may entail, are questions for empirical investigation. One possibility worth noting is to preserve exactly the pitch of the note selected during the claviation gesture—that is, the note that is picked and placed.

### Appendix, Part C: Supplementary Technical Material

### C.1 Types of Prior Art and their Limitations

To evaluate transposition interfaces, five functional requirements have been defined in Part 1. The following sections describe three types of prior art and consider how each aligns with those requirements. Each approach satisfies some requirements but not others. None of the examined approaches satisfies the full set of requirements in combination, which is the focus of the present disclosure

### C.1.1 Type 1 Prior Art—Absolute Single-Key Selection

“Type 1 Prior Art”, documented in the Roland Juno-6 and Juno-60 Owner's Manuals (1982) and described in greater detail in the Yamaha DX7 Operating Manual (1983), defines transposition by pressing a single playing key after entering transposition mode. The selected key establishes the transposition offset, which is then applied across the keyboard. Variants of this interface remain in use in several contemporary Roland instruments.

Like claviation, the player first engages a control to enter transposition mode, during which the keys are muted and used as input. It differs, however, in two respects:
Only one key is used to define the transposition, limiting the scope of smart-tuning input.
The transposition is absolute, not relative: each operation resets the transpose state (TS) with reference to a fixed key (typically C).

### (Operation)

To operate it:
Activate transposition mode using a dedicated button (muting one keypress).
Press a single key on the keybed (also muted).
TS is set to the semitone distance between that key and physical C3 (positive if above, negative if below).

### (Comparison to Claviation)

This system is equivalent to a highly restricted form of claviation:
It always behaves as though preceded by a transpose reset.
It accepts a picking key from the player, but fixes the dropping key as C3 (Major's home 3).

Accordingly, it supports ergonomic smart-tuning only to Major keys, and only from a reset state. It cannot support kal key changes.

Note: some models use C4 instead of C3 as the reference key.

### (Evaluation Relative to the Five Requirements)

Transposition generality: Satisfied.
Musical generality: Limited—only supports Major mode and only at the beginning of a piece; does not accommodate mid-performance key changes.
Efficiency: Partially acceptable—usable for Major mode start of play, but not for other modes or real-time use.
Relativity: Not satisfied—each action overwrites the prior transpose state.
General usability: Partially satisfied—suitable only for Major mode at piece start.

### C.1.2 Type 2 Prior Art: Incremental Button Transposition

“Type 2 Prior Art” is documented as early as the Roland D-50 (1987) Advanced Manual and the Korg M1 (1988) Owner's Manual. It has since become effectively universal in keyboards intended for general adult use. The interface employs two transposition buttons, typically labeled “−” (minus) and “+” (plus):
Pressing “−” decrements the transposition setting (TS) by one semitone.
Pressing “+” increments the TS by one semitone.
Repeated presses adjust the TS by larger intervals.

### (Evaluation Relative to the Five Requirements)

Transposition generality: Satisfied—any integer semitone shift can be reached.
Musical generality: Limited—usable in all keys, but impractical for mid-performance changes due to speed constraints.
Efficiency: Not satisfied—multiple presses required even for modest intervals; unsuitable for in-performance transpositions.
Relativity: Satisfied—cumulative changes are supported (each press applies a delta to the existing state).
General usability: Poor. Requires mental learning or calculation of semitone distances; unintuitive under time pressure, not suitable for key changes during play. This has all of the failings of the Multibutton Solution as discussed earlier in the main body of the specification, and an additional efficiency limitation.

### C.1.3 Type 3 Prior Art—Transpose Dials or Sliders with Markings for Musical Keys

“Type 3 Prior Art”, exemplified by the Technics SX-PX9, uses a hardware selector—typically a dial or slider—with a fixed number of positions, generally twelve, each corresponding to an absolute transposition setting (e.g., TS=−6 to +5, or 0 to 11). The positions are labeled with the target keys. On some instruments, particularly those with auto-accompaniment features, each position is dual-labeled with both a Major key and its relative Minor (for example, “F/D Minor”).

### (Evaluation Relative to the Five Requirements)

Transposition generality: Satisfied—all semitone offsets are available.
Musical generality: Limited—usable to support Major and Minor only;
additional modes would overcrowd the labels. Does not support key changes during a piece.
Efficiency: Not satisfied—suitable for setup but not performative; slider or rotary adjustment does not allow rapid in-performance changes.
Relativity: Not satisfied—sets an absolute transpose state, overwriting prior settings.
General usability: High in static contexts (e.g., before performance), but unsuitable for real-time use or general musical modes.

### (Conclusion to Prior Art Discussion)

In summary, the three main types of prior art shown each address portions of the defined requirements but leave significant gaps. None provides a solution that meets the requirements together in a unified way, thus enabling real-time smart-tuning. This positions them to afford piecemeal reduction of the Incidental Multikey Overhead, but not elimination of the Total Multikey Overhead. The present disclosure addresses that gap by offering an approach—claviation—that satisfies all five requirements simultaneously.

### C.2 The Transposition Window

During claviation, pressing the trigger mutes the next two keypresses, preventing new notes from being initiated while the action occurs. This creates a brief gap—referred to here as the “transposition window”. Importantly, this does not produce silence in the music, but it does limit when new notes can begin.

This limitation is minor. Claviation can be executed as quickly as a player can play a triplet or a three-note chord roll. A similar restriction exists on guitar: while adjusting a real-time capo, no strings can be played.

In practice, a window of up to one beat poses little problem, thanks to two natural features of music:
Melody: Key changes are almost never placed inside rapid melodic runs, since this does not tend to work musically, making an available gap in melody inevitable.
Accompaniment: A one-beat window may sometimes modestly limit the rhythm only of the accompaniament only, but adaptations are always available.

Thus, the transposition window:
Leaves the vast majority of repertoire playable exactly as written.
Requires only minor, accompaniment-level adaptations in rare cases.

This constraint is negligible compared to the inherent limitations of many other instruments, all of which remain musically viable. Adaptive playing or improvisation makes the effect imperceptible to the player.

A final thought experiment underscores how minor the limitation of the transposition window is: despite the upcoming availability of claviating keyboards, many learners will surely still internalize key signatures to gain fluency on acoustic piano. Yet almost none would do so merely to circumvent this window. This highlights how negligible the constraint is compared to the broad advantages of claviation.

### C.3 Some Enhancements

A viable and fully functional embodiment of the claviation interface was described in Chapter 1. While this base implementation supports all the core capabilities of smart-tuning, two optional enhancements are worth considering. Each requires only modest firmware changes and no additional hardware, yet both improve the performer's experience:
A claviation undo function to correct errors.
A faster method for executing kal signatures, removing the pause introduced by the standard long-press reset—purely for convenience, not necessity.

### (Claviation Undo)

“Claviation undo” allows the performer to reverse the most recent claviation action and restore the previous transpose state (TS). This is especially valuable if the wrong picking or dropping key was pressed and the performer may not even be certain of the resulting state.

The implementation follows a single, simple rule:
Trigger press and release alone (with no intervening keypress)=undo.
Trigger held until at least the picking key=normal claviation.

All other claviation rules remain unchanged. In this embodiment, the trigger behaves analogously to a computer modifier key (Shift, Alt, Ctrl): it must be held down to achieve its normal function, but when pressed and released in isolation it executes a control action of undo. The effect of the trigger is therefore context-dependent: alone it performs undo, and in combination with the picking key it performs transposition.

### (Usability and Teaching of Undo)

This is easy to teach and easy to internalize. Most users are already familiar with modifier key logic from everyday computing, such as with a Shift or Ctrl key on a keyboard. Undo is executed with minimal delay and no disruption to musical flow. It is especially helpful during learning, experimentation, or high-focus performance settings.

Note: There is no requirement that the trigger be held through the dropping key. It may or may not remain down after the picking key, depending on the player's choice. This flexibility remains unchanged in the presence of the undo feature.

### (Faster Execution of Kal Signatures)

As described in Part A, a kal signature consists of a transpose reset followed by a claviation. The standard method uses a long press of the trigger to reset TS to zero, followed by a pick-drop action to define the new key. This approach is simple, robust, and ideal for beginners.

Kal signatures are never executed during real-time performance—they are always set before playing—but they may be applied frequently during practice, rehearsal, or between pieces. In these contexts, performers or instructors may prefer a faster option that avoids the pause introduced by the long-press reset.

The faster method works as follows:
The performer holds the trigger through the entire pick-drop sequence and continues holding it slightly longer.
The firmware interprets this as a compound action—an “integrated reset-claviation”—functionally equivalent to a reset immediately followed by a claviation, i.e., execution of a full kal signature.
The required hold time is dynamically determined from the performer's actual pick-drop speed. Specifically, after the drop, the system expects a duration equal to a fixed percentage (for example, 90%) of twice the pick-drop gap (the interval between pick and drop).

For pedagogy, the timing may be reinforced through practice conventions:
A dummy repeat of the pick—drop can be gestured without actuating keys, effectively marking the additional hold interval.
Alternatively, a counting scheme may be used (e.g., 1-2 for pick and drop, then 3-4 as the dummy repeat).
For players who use verbalization, the key name can be spoken again during the hold (e.g., saying “D Major” synchronized with pick-drop, then repeating “D Major” while maintaining the trigger).

These habits give performers a concrete sense of how long is “long enough” to hold the trigger, ensuring consistent execution of the integrated reset-claviation.

### (Clarification of Use of Faster Method)

If implemented, this method functions as an alternative to the standard long-press reset method of executing a kal signature. It is not intended to disable or replace the standard long-press reset; rather, it provides a convenience option to streamline workflow where faster interaction is desirable.

### (Teaching Considerations for Faster Method)

Because the enhanced method is slightly more involved, it is best introduced only after students have mastered the standard approach. Instructors may present it once learners begin seeking quicker interaction—particularly in contexts involving frequent repetition or intermediate-level training.

### C.4 Regional Issues with Syllabified Kal Note Names

In Do-Re-Mi Regions, the solfège syllables already serve as fixed note names, traditionally written with capital letters. In this written specification, lowercase syllables are unambiguous, but in spoken language the overlap remains: “do” may mean a solfège pitch name or a kal note, depending on context. This prevents syllabification from serving simultaneously as (i) traditional solfège and (ii) an unambiguous kal perspective.

This difficulty has already been noted in attempts to introduce frameworks such as the Kodaly Method in Do-Re-Mi Regions. In Kodaly, solfège syllables act as tools for internalizing kal notes, but in those regions their fixed-note function collides with that role.

In practice, the KALC Framework consequence is that syllables cannot be used to distinguish kal key changes from kal signatures in Do-Re-Mi Regions. This is not a major problem: it simply means that an extra syllable has to be carried in such verbalizations. Ambiguity of kal vs. con perspective has existed in those regions for centuries whenever transposing instruments were involved.

The issue becomes serious only when using hybrid kal signatures—a technique relevant mainly to those pursuing fluency on the acoustic piano, especially for improvisation. In ABC Regions, the single-syllable kal names do not collide with staff positions or physical keys. Thus, in the mechanical key signature of G, while physical G technically holds kal C under the hybrid technique, players need not think of it that way; they simply treat it as “do,” without confusion—provided they are using full syllabification, as prescribed for this technique. Full syllabification allows them to operate entirely within the syllable set and avoid conflict with traditional names for staff positions. In Do-Re-Mi Regions, by contrast, physical G is normally conceived of as “sol,” so calling it kal “do” produces a mental collision.

A potential solution is to introduce a separate syllable set for unambiguous kal notes. One draft, termed “clavifa” in the KALC Framework, is:
da, ro, mu, ve, sa, lo, tu, da

Each syllable is distinct from its solfège counterpart while remaining easy to learn through its unique initial consonant and its close relation to the familiar form. However, the system remains experimental: the similarity to solfège may aid memory, yet it may also introduce cognitive collisions if it is not distinct enough. If this proves unsuitable, the only likely alternative is to adopt a fully distinct syllable system. Such a system would make the hybrid key signature technique just as viable in Do-Re-Mi Regions as it already is in ABC Regions. In summary, this regional syllable issue does not undermine claviation as a whole, but only imposes a special consideration for hybrid key signatures in Do-Re-Mi Regions.

### C.5 The 12 Enharmonically Distinct Key Signatures

The 12 enharmonically distinct key signatures (what are simply referred to in the body of the specification as the ‘12 key signatures’) are shown in the table below. They can be conveniently enumerated by their root notes in their defining Major key (though any mode, including Minor, could equally be used). In this enumeration the transposition setting (TS) value itself serves as the number of the key signature.

The table is most readily constructed by first filling its first two columns. The sequence begins with C Major—for the empty key signature—which is entry number 0, corresponding to TS=0. Advancing one semitone to the next row brings us to the pair C # Major I D♭ Major, reached by smart-tuning with TS=+1. Another semitone higher yields D Major at TS=+2 and so on, until these two columns are all filled.

Once these first two columns are filled, the remainder of the table can be completed by applying standard knowledge of musical notation.

The following table sets out the complete set of 12, showing:
i. the transposition setting (TS), which doubles as the number of the key signatures, counted from 0,
ii. the sharps or flats in their conventional notation, listed in the standard order descending from the top of the staff, and
iii. the musical keys they govern in all modes.

Where both sharps and flats are listed in a row (separated by a slash), this indicates that two notational key signatures correspond to the same enharmonically distinct key signature.

The 12 key signatures
(The 12 enharmonically distinct key signatures)

| | | Sharps or | |
|---|---|---|---|
| | Defining | flats in the | |
| Number | Major | signature | Musical keys it |
| (TS) | Key | ( [symbol] / [symbol] ) | plays (all modes) |
| 0 | C | — | C Major, A Minor, |
| | | | D Dorian, E Phrygian, |
| | | | F Lydian, G Mixo, |
| | | | B Locrian |
| 1 | C [symbol] /D [symbol] | F [symbol] , C [symbol] , G [symbol] , | C [symbol] /D [symbol] Major, |
| | | D [symbol] , A [symbol] /B [symbol] , | A [symbol] /B [symbol] Minor, |
| | | E [symbol] , A [symbol] , D [symbol] , | D [symbol] /E [symbol] Dorian, |
| | | G [symbol] | F Phrygian, F [symbol] /G [symbol] Lydian, |
| | | | G [symbol] /A [symbol] Mixo, |
| | | | C Locrian |
| 2 | D | F [symbol] , C [symbol] | D Major, B Minor, |
| | | | E Dorian, F [symbol] Phrygian, |
| | | | G Lydian, A Mixo, |
| | | | C [symbol] Locrian |
| 3 | E [symbol] | B [symbol] , E [symbol] , A [symbol] | E [symbol] Major, C Minor, |
| | | | F Dorian, G Phrygian, |
| | | | A [symbol] Lydian, B [symbol] Mixo, |
| | | | D Locrian |
| 4 | E | F [symbol] , C [symbol] , G [symbol] , | E Major, C [symbol] Minor, |
| | | D [symbol] , A [symbol] | F [symbol] Dorian, G [symbol] Phrygian, |
| | | | A Lydian, B Mixo, |
| | | | D [symbol] Locrian |
| 5 | F | B [symbol] | F Major, D Minor, |
| | | | G Dorian, A Phrygian, |
| | | | B [symbol] Lydian, C Mixo, |
| | | | E Locrian |
| 6 | F [symbol] /G [symbol] | F [symbol] , C [symbol] , G [symbol] , | F [symbol] /G [symbol] Major, |
| | | D [symbol] , A [symbol] , E [symbol] / | D [symbol] /E [symbol] Minor, |
| | | B [symbol] , E [symbol] , | G [symbol] /A [symbol] Dorian, |
| | | A [symbol] , D [symbol] , G [symbol] , | A [symbol] /B [symbol] Phrygian, B Lydian, |
| | | C [symbol] | C [symbol] /D [symbol] Mixo, |
| | | | F Locrian |
| 7 | G | F [symbol] | G Major, E Minor, |
| | | | A Dorian, B Phrygian, |
| | | | C Lydian, D Mixo, |
| | | | F [symbol] Locrian |
| 8 | A [symbol] | B [symbol] , E [symbol] , A [symbol] , | A [symbol] Major, F Minor, |
| | | D [symbol] | B [symbol] Dorian, C Phrygian, |
| | | | D [symbol] Lydian, E [symbol] Mixo, |
| | | | G Locrian |
| 9 | A | F [symbol] , C [symbol] , G [symbol] | A Major, F [symbol] Minor, |
| | | | B Dorian, C [symbol] Phrygian, |
| | | | D Lydian, E Mixo, |
| | | | G [symbol] Locrian |
| 10 | B [symbol] | B [symbol] , E [symbol] | B [symbol] Major, G Minor, |
| | | | C Dorian, D Phrygian, |
| | | | E [symbol] Lydian, F Mixo, |
| | | | A Locrian |
| 11 | B/C [symbol] | F [symbol] , C [symbol] , G [symbol] , | B/C [symbol] Major, G [symbol] /A [symbol] Minor, |
| | | D [symbol] , A [symbol] /B [symbol] , | C [symbol] /D [symbol] Dorian, |
| | | E [symbol] , A [symbol] , D [symbol] , | D [symbol] /E [symbol] Phrygian, |
| | | G [symbol] , C [symbol] | E/F [symbol] Lydian, F [symbol] /G [symbol] Mixo, |
| | | | A [symbol] /B [symbol] Locrian |

There are historical notational key signatures, no longer in common use, which are omitted from the above table. Any such signatures—if included—would fold into one of the 12 rows given. The 12 enharmonically distinct key signatures are a concept independent of notational convention.

1. A process for effecting a transposition change in an electronic musical keyboard instrument environment, the process comprising:
receiving an input signal representing a player triggering entry into a transposition mode in which two keypresses of the keybed are muted;
in the transposition mode, receiving an input signal representing a player pressing a first key of the keybed;
in the transposition mode, receiving an input signal representing a player pressing a second key of the keybed; and
effecting a transposition change, wherein the transposition change is characterized in that the note produced by the second key after the transposition change is the note produced by the first key before the transposition change.

2. An apparatus for effecting a transposition change in an electronic musical keyboard instrument environment, the apparatus comprising:
an input interface configured to receive a signal representing a player triggering entry into a transposition mode in which two keypresses of the keybed are muted;
a key detection subsystem configured, in the transposition mode, to receive an input signal representing a player pressing a first key of the keybed, and an input signal representing a player pressing a second key of the keybed; and
a transpose control subsystem configured to effect a transposition change, wherein the transposition change is characterized in that the note produced by the second key after the transposition change is the note produced by the first key before the transposition change.

3. The apparatus of claim 2, wherein the apparatus comprises an electronic keyboard having internal firmware that implements the transpose control subsystem.

4. The apparatus of claim 2, wherein the apparatus comprises an external MIDI module configured to receive MIDI input signals from an electronic keyboard, apply the transposition change, and output transposed MIDI signals.

5. A non-transitory computer-readable medium storing instructions that, when executed by one or more processors of an electronic musical keyboard instrument environment, enable the environment to:
receive a signal representing a player triggering entry into a transposition mode in which two keypresses of the keybed are muted;
in the transposition mode, receive an input signal representing a player pressing a first key of the keybed;
in the transposition mode, receive an input signal representing a player pressing a second key of the keybed; and
effect a transposition change, wherein the transposition change is characterized in that the note produced by the second key after the transposition change is the note that was produced by the first key before the transposition change.
